(19) United States
(12) Patent Application Publication
(10) Pub. No.: US 2021/0392890 A1
(43) Pub. Date: Dec. 23, 2021

(54) COMPOSITIONS COMPRISING PYRIDINE CARBOXYLATE HERBICIDES AND PLANT GROWTH REGULATORS

(71) Applicant: Corteva Agriscience LLC, Indianapolis, IN (US)

(72) Inventors: Jeremy Kister, Carmel, IN (US); Norbert M. Satchivi, Carmel, IN (US)

(73) Assignee: Corteva Agriscience LLC, Indianapolis, IN (US)

(21) Appl. No.: 17/289,768

(22) PCT Filed: Nov. 4, 2019
(86) PCT No.: PCT/US2019/059609

§ 371 Date: Apr. 29, 2021

Related U.S. Application Data
(60) Provisional application No. 62/756,696, filed on Nov. 7, 2018.

(51) Int. Cl. A01N 43/40; A01N 25/32; A01N 33/12; A01N 43/38; A01N 37/36; A01N 57/20; A01P 13/00

(52) U.S. Cl. CPC A01N 43/40; A01N 25/32; A01N 33/12; A01P 13/00; A01N 37/36; A01N 57/20; A01N 43/38

(57) ABSTRACT

Disclosed herein are compositions comprising (a) a pyridine carboxylate herbicide or an agriculturally acceptable N-oxide, salt, or ester thereof and (b) a plant growth regulator (PGR), an agriculturally acceptable salt or ester thereof, or mixtures thereof. Also disclosed herein are methods of controlling undesirable vegetation, comprising applying to vegetation or an area adjacent the vegetation or applying in soil or water to control the emergence or growth of vegetation (a) a pyridine carboxylate herbicide or an agriculturally acceptable N-oxide, salt, or ester thereof and (b) a plant growth regulator (PGR), an agriculturally acceptable salt or ester thereof, or mixtures thereof.

### CROSS REFERENCE TO RELATED APPLICATION

This application claims the benefit of priority of U.S. Provisional Application No. 62/756,696, filed Nov. 7, 2018, which is incorporated by reference herein in its entirety.

### FIELD

The present disclosure includes compositions comprising (a) a pyridine carboxylate herbicide or an agriculturally acceptable N-oxide, salt, or ester thereof, and (b) a plant growth regulator (PGR) or an agriculturally acceptable salt or ester thereof. The present disclosure also includes methods of controlling undesirable vegetation using the same.

### BACKGROUND

Many recurring problems in agriculture involve controlling the growth of undesirable vegetation that can, for instance, negatively affect the growth of desirable vegetation. To help control undesirable vegetation, researchers have produced a variety of chemicals and chemical formulations effective in controlling such unwanted growth. However, there exists a need for new herbicide compositions and methods to control the growth of undesirable vegetation in desired crops.

### SUMMARY

Disclosed herein are compositions that may be used as herbicides, for example, in crops. The compositions may contain (a) a pyridine carboxylate herbicide or agriculturally acceptable N-oxide, salt, or ester thereof and (b) a plant growth regulator (PGR), an agriculturally acceptable salt or ester thereof, or mixtures thereof. The weight ratio of (a) to (b) can be from 1:7500 to 15:1 (e.g., from 1:6000 to 13:1, from 1:4000 to 11:1, from 1:1250 to 9:1, from 1:1500 to 1:50, from 1:20 to 8:1, from 1:8 to 2:1, or from 1:5 to 1:1).

In some aspects, the composition comprises (a) a pyridine carboxylate herbicide defined by Formula (I):

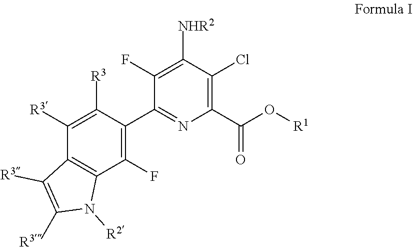

wherein:

R¹ is cyanomethyl or propargyl;

R² and R^{2′} are independently hydrogen, C₁-C₆ alkyl, formyl, alkoxycarbonyl, or acyl;

R³, R^{3′}, R^{3″}, and R^{3′″} are independently hydrogen, halogen, C₁-C₄ alkyl, C₁-C₄ haloalkyl, C₁-C₃ alkoxy, or C₁-C₃ haloalkoxy;

or an agriculturally acceptable N-oxide, salt, or ester thereof; and
(b) a plant growth regulator (PGR), an agriculturally acceptable salt or ester thereof, or mixtures thereof.

In some aspects, the composition comprises:

(a) the pyridine carboxylate herbicide compound cyanomethyl 4-amino-3-chloro-5-fluoro-6-(7-fluoro-1H-indol-6-yl)pyridine-2-carboxylate, referred to hereinafter as Compound A:

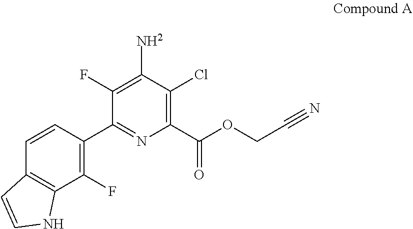 [SMILES: N#CCOC(=O)c1nc(-c2ccc3cc[nH]c3c2F)c(F)c(N)c1Cl]

or an agriculturally acceptable N-oxide, salt, or ester thereof; and
(b) a plant growth regulator (PGR), an agriculturally acceptable salt or ester thereof, or mixtures thereof.

In some aspects, the composition comprises:

(a) the pyridine carboxylate herbicide compound propargyl 4-amino-3-chloro-5-fluoro-6-(7-fluoro-1H-indol-6-yl)pyridine-2-carboxylate, referred to hereinafter as Compound B:

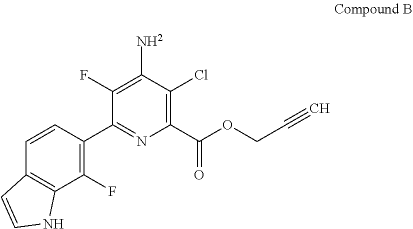 [SMILES: C#CCOC(=O)c1nc(-c2ccc3cc[nH]c3c2F)c(F)c(N)c1Cl]

or an agriculturally acceptable N-oxide, salt, or ester thereof; and
(b) a plant growth regulator (PGR), an agriculturally acceptable salt or ester thereof, or mixtures thereof.

In some aspects, the PGR (b) may be selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and mixtures thereof.

In some aspects, the composition can further comprise an agriculturally acceptable adjuvant or carrier, a herbicidal safener, an additional pesticide, or a combination thereof. In some aspects, the only active ingredients in the composition are (a) and (b). In some aspects, the composition can be provided as a herbicidal concentrate.

Also disclosed herein are methods of controlling undesirable vegetation, comprising applying to vegetation, to an area adjacent the vegetation, or to soil or water to control the emergence or growth of vegetation, a composition comprising: (a) a pyridine carboxylate herbicide or an agriculturally acceptable N-oxide, salt, or ester thereof; and (b) a plant growth regulator (PGR), an agriculturally acceptable salt or ester thereof, or mixtures thereof. In some aspects, (a) and (b) are applied simultaneously. In some aspects, (a) and (b) are applied sequentially. In some aspects, (a) and (b) are applied pre-emergence of the undesirable vegetation. In some aspects, (a) and (b) are applied post-emergence of the undesirable vegetation. In some aspects, the undesirable vegetation is in cereals. In some aspects, the undesirable vegetation is in maize, wheat, barley, rice, sorghum, millet, or oats. In some aspects, the undesirable vegetation is in broadleaf crops. In some aspects, the undesirable vegetation is in canola, flax, sunflower, soy, or cotton.

In some aspects, the pyridine carboxylate herbicide (a) can be applied in an amount of from 0.5 gram acid equivalent per hectare (g ae/ha) to 300 g ae/ha (e.g., from 30 g ae/ha to 40 g ae/ha). In some cases, the PGR (b) can be applied in an amount of from 300 g ai/ha to 7500 g ai/ha (e.g., from 650-2500 g ai/ha, from 375-6500 g ai/ha, from 1500-5000 g ai/ha, from 450-3200 g ai/ha, or from 900-7000 g ai/ha). In some cases, (a) and (b) can be applied in a weight ratio of from 1:7500 to 15:1 (e.g., from 1:6000 to 13:1, from 1:4000 to 11:1, from 1:1250 to 9:1, from 1:1500 to 1:50, from 1:20 to 8:1, from 1:8 to 2:1, or from 1:5 to 1:1).

The description below sets forth details of one or more aspect of the present disclosure. Other features, objects, and advantages will be apparent from the description and from the claims.

### DETAILED DESCRIPTION

The present disclosure includes compositions comprising: (a) a pyridine carboxylate herbicide or an agriculturally acceptable N-oxide, salt, or ester thereof and (b) a plant growth regulator (PGR), an agriculturally acceptable salt or ester thereof, or mixtures thereof. The present disclosure also includes methods for controlling undesirable vegetation. In some aspects, the undesirable vegetation is in cereals. In some aspects, the undesirable vegetation is in maize, wheat, barley, rice, sorghum, millet, or oats. In some aspects, the undesirable vegetation is in broadleaf crops. In some aspects, the undesirable vegetation is in canola, flax, sunflower, soy, or cotton.

### I. Definitions

Terms used herein will have their customary meaning in the art unless specified otherwise. The singular forms “a” and “the” include plural references unless stated otherwise. To the extent that the term “or” is employed (e.g., A or B) it is intended to mean “A or B or both.” If this disclosure intends to indicate “only A or B but not both” then the term “only A or B but not both” will be employed. Thus, use of the term “or” herein is the inclusive and not the exclusive use.

The chemical moieties mentioned when defining variable positions within the general formulae described herein (e.g., the term “alkyl”) are collective terms for the individual substituents encompassed by the chemical moiety. The prefix Cₙ-Cₘ preceding a group or moiety indicates, in each case, the possible number of carbon atoms in the group or moiety that follows.

As used herein, the terms “herbicide” and “herbicidal active ingredient” may be understood to include an active ingredient that kills, controls, or otherwise adversely modifies the growth of vegetation, particularly undesirable vegetation such as weed species, when applied in an appropriate amount.

As used herein, the term “herbicidal effect” may be understood to include an adversely modifying effect of an active ingredient on vegetation, including, for example, a deviation from natural growth or development, killing, regulation, desiccation, growth inhibition, growth reduction, and retardation. The term “herbicidal activity” refers generally to herbicidal effects of an active ingredient. As used herein, the term “prevents” or similar terms such as “preventing” may be understood by a person of ordinary skill to include any combination that shows herbicidal effect or reduces the competitive capability of the weed with respect to a crop.

As used herein, “applying” a herbicide or herbicidal composition refers to delivering it directly to the targeted vegetation or to the locus thereof or to the area where control of undesirable vegetation is desired. Methods of application include, but are not limited to, pre-emergently contacting soil or water, post-emergently contacting the undesirable vegetation, or contacting the area adjacent to the undesirable vegetation.

As used herein, the term “vegetation” can include, for instance, dormant seeds, germinating seeds, emerging seedlings, plants propagating from vegetative propagules, immature vegetation, and established vegetation.

As used herein, the term “crop” refers to desired vegetation, for instance, plants that are grown to provide food, shelter, pasture, erosion control, etc. Example crops include cereals, legumes, vegetables, orchard and timber trees, grapevines, etc. Preferably, herbicides or herbicidal compositions have zero or minimal herbicidal effect on crops.

As used herein, the term “undesirable vegetation” refers to vegetation that is not wanted in a given area, for instance, weed species. Herbicides or herbicidal compositions are used to control undesirable vegetation. Preferably, herbicides or herbicidal compositions have a large or complete herbicidal effect on undesirable vegetation.

As used herein, “active ingredient” or “ai” may be understood to include a chemical compound or composition that has an effect on vegetation, for example, a herbicidal effect or a safening effect on the vegetation.

As used herein, “acid equivalent” or “ae” may be understood to include the amount of the acid form of an active ingredient that is calculated from the amount of a salt or ester form of that active ingredient. For example, if the acid form of an active ingredient “Z” has a molecular weight of 100 Dalton, and the salt form of Z has a molecular weight of 130 Dalton, an application of 130 g ai/ha of the Z salt would be equal to applying 100 g ae/ha of the acid form of Z:

130 g ai/ha Z salt*(100 Da Z acid/130 Da Z salt)=100 g ae/ha Z acid.

As used herein, unless otherwise specified, the term “acyl” may be understood to include a group of formula —C(O)R, where “C(O)” is short-hand notation for C═O. In the acyl group, the R may be alkyl (e.g., C₁-C₆ alkyl), haloalkyl (e.g., C₁-C₆ haloalkyl), alkenyl (e.g., C₂-C₆ alkenyl), haloalkenyl (e.g., C₂-C₆ haloalkenyl), alkynyl (e.g., C₂-C₆ alkynyl), aryl or heteroaryl, or arylalkyl (e.g., C₇-C₁₀ arylalkyl).

As used herein, the term “alkyl” may be understood to include straight-chained, branched, or cyclic saturated hydrocarbon moieties. Unless otherwise specified, C₁-C₂₀ (e.g., C₁-C₁₂, C₁-C₁₀, C₁-C₈, C₁-C₆, or C₁-C₄) alkyl groups are intended. Examples of alkyl groups include methyl, ethyl, propyl, cyclopropyl, 1-methyl-ethyl, butyl, cyclobutyl, 1-methyl-propyl, 2-methyl-propyl, 1,1-dimethyl-ethyl, pentyl, cyclopentyl, 1-methyl-butyl, 2-methyl-butyl, 3-methyl-butyl, 2,2-dimethyl-propyl, 1-ethyl-propyl, hexyl, cyclohexyl, 1,1-dimethyl-propyl, 1,2-dimethyl-propyl, 1-methyl-pentyl, 2-methyl-pentyl, 3-methyl-pentyl, 4-methyl-pentyl, 1,1-dimethyl-butyl, 1,2-dimethyl-butyl, 1,3-dimethyl-butyl, 2,2-dimethyl-butyl, 2,3-dimethyl-butyl, 3,3-dimethyl-butyl, 1-ethyl-butyl, 2-ethyl-butyl, 1,1,2-trimethyl-propyl, 1,2,2-trimethyl-propyl, 1-ethyl-1-methyl-propyl, and 1-ethyl-2-methyl-propyl. Alkyl substituents may also be substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “haloalkyl” may be understood to include alkyl groups wherein the hydrogen atoms may partially or entirely be substituted with halogen atoms. Unless otherwise specified, C₁-C₂₀ (e.g., C₁-C₁₂, C₁-C₁₀, C₁-C₈, C₁-C₆, or C₁-C₄) alkyl groups are intended. Examples include chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, and 1,1,1-trifluoroprop-2-yl. Haloalkyl substituents may also be substituted with one or more chemical moieties. Examples of suitable substituents include, for example, hydroxy, nitro, cyano, formyl, C₁-C₆ alkoxy, C₁-C₆ haloalkoxy, C₁-C₆ acyl, C₁-C₆ alkylthio, C₁-C₆ haloalkylthio, C₁-C₆ alkylsulfinyl, C₁-C₆ haloalkylsulfinyl, C₁-C₆ alkylsulfonyl, C₁-C₆ haloalkylsulfonyl, C₁-C₆ alkoxycarbonyl, C₁-C₆ haloalkoxycarbonyl, C₁-C₆ carbamoyl, C₁-C₆ halocarbamoyl, hydroxycarbonyl, C₁-C₆ alkylcarbonyl, C₁-C₆ haloalkylcarbonyl, aminocarbonyl, C₁-C₆ alkylaminocarbonyl, haloalkylaminocarbonyl, C₁-C₆ dialkylaminocarbonyl, and C₁-C₆ dihaloalkylaminocarbonyl, provided that the substituents are sterically compatible and the rules of chemical bonding and strain energy are satisfied. Preferred substituents include cyano and C₁-C₆ alkoxy.

As used herein, the term “alkoxy” may be understood to include a group of the formula R—O—, where R is unsubstituted or substituted alkyl as defined above. Unless otherwise specified, alkoxy groups wherein R is a C₁-C₂₀ (e.g., C₁-C₁₂, C₁-C₁₀, C₁-C₈, C₁-C₆, or C₁-C₄) alkyl group are intended. Examples include methoxy, ethoxy, propoxy, 1-methyl-ethoxy, butoxy, 1-methyl-propoxy, 2-methyl-propoxy, 1,1-dimethyl-ethoxy, pentoxy, 1-methyl-butyloxy, 2-methyl-butoxy, 3-methyl-butoxy, 2,2-dimethyl-propoxy, 1-ethyl-propoxy, hexoxy, 1,1-dimethyl-propoxy, 1,2-dimethyl-propoxy, 1-methyl-pentoxy, 2-methyl-pentoxy, 3-methyl-pentoxy, 4-methyl-penoxy, 1,1-dimethyl-butoxy, 1,2-dimethyl-butoxy, 1,3-dimethyl-butoxy, 2,2-dimethyl-butoxy, 2,3-dimethyl-butoxy, 3,3-dimethyl-butoxy, 1-ethyl-butoxy, 2-ethylbutoxy, 1,1,2-trimethyl-propoxy, 1,2,2-trimethyl-propoxy, 1-ethyl-1-methyl-propoxy, and 1-ethyl-2-methyl-propoxy.

As used herein, the term “alkoxycarbonyl” may be understood to include a group of the formula —C(O)OR, where R is an unsubstituted or substituted alkyl as defined above. Unless otherwise specified, alkoxycarbonyl groups wherein R is a C₁-C₂₀ (e.g., C₁-C₁₂, C₁-C₁₀, C₁-C₈, C₁-C₆, or C₁-C₄) alkyl group are intended. Examples include methoxycarbonyl, ethoxycarbonyl, propoxycarbonyl, 1-methyl-ethoxycarbonyl, butoxycarbonyl, 1-methyl-propoxycarbonyl, 2-methyl-propoxycarbonyl, 1,1-dimethyl-ethoxycarbonyl, pentoxycarbonyl, 1-methyl-butoxycarbonyl, 2-methyl-butoxycarbonyl, 3-methyl-butoxycarbonyl, 2,2-dimethyl-propoxycarbonyl, 1-ethyl-propoxycarbonyl, hexoxycarbonyl, 1,1-dimethyl-propoxycarbonyl, 1,2-dimethyl-propoxycarbonyl, 1-methyl-pentoxycarbonyl, 2-methyl-pentoxycarbonyl, 3-methyl-pentoxycarbonyl, 4-methyl-penoxycarbonyl, 1,1-dimethyl-butoxycarbonyl, 1,2-dimethyl-butoxycarbonyl, 1,3-dimethyl-butoxycarbonyl, 2,2-dimethyl-butoxycarbonyl, 2,3-dimethyl-butoxycarbonyl, 3,3-dimethyl-butoxycarbonyl, 1-ethyl-butoxycarbonyl, 2-ethylbutoxycarbonyl, 1,1,2-trimethyl-propoxycarbonyl, 1,2,2-trimethyl-propoxycarbonyl, 1-ethyl-1-methyl-propoxycarbonyl, and 1-ethyl-2-methyl-propoxycarbonyl.

As used herein, the term “haloalkoxy” may be understood to include a group of the formula R—O—, where R is unsubstituted or substituted haloalkyl as defined above. Unless otherwise specified, haloalkoxy groups wherein R is a C₁-C₂₀ (e.g., C₁-C₁₂, C₁-C₁₀, C₁-C₈, C₁-C₆, or C₁-C₄) alkyl group are intended. Examples include chloromethoxy, bromomethoxy, dichloromethoxy, trichloromethoxy, fluoromethoxy, difluoromethoxy, trifluoromethoxy, chlorofluoromethoxy, dichlorofluoromethoxy, chlorodifluoromethoxy, 1-chloroethoxy, 1-bromoethoxy, 1-fluoroethoxy, 2-fluoroethoxy, 2,2-difluoroethoxy, 2,2,2-trifluoroethoxy, 2-chloro-2-fluoroethoxy, 2-chloro-2,2-difluoroethoxy, 2,2-dichloro-2-fluoroethoxy, 2,2,2-trichloroethoxy, pentafluoroethoxy, and 1,1,1-trifluoroprop-2-oxy.

As used herein, the term “aryl,” as well as derivative terms such as aryloxy, may be understood to include groups that include a monovalent aromatic carbocyclic group of from 6 to 14 carbon atoms. Aryl groups can include a single ring or multiple condensed rings. In some aspects, aryl groups include C₆-C₁₀ aryl groups. Examples of aryl groups include, but are not limited to, phenyl, biphenyl, naphthyl, tetrahydronaphthyl, phenylcyclopropyl, and indanyl. In some aspects, the aryl group can be a phenyl, indanyl or naphthyl group.

As used herein, the term “heteroaryl,” as well as derivative terms such as “heteroaryloxy,” may be understood to include a 5- or 6-membered aromatic ring containing one or more heteroatoms, for example, N, O or S. Heteroaryl rings may be fused to other aromatic systems. The aryl or heteroaryl substituents may also be substituted with one or more chemical moieties. Examples of suitable substituents include, for example, hydroxy, nitro, cyano, formyl, C₁-C₆ alkyl, C₂-C₆ alkenyl, C₂-C₆ alkynyl, C₁-C₆ alkoxy, C₁-C₆ haloalkyl, C₁-C₆ haloalkoxy, C₁-C₆ acyl, C₁-C₆ alkylthio, C₁-C₆ alkylsulfinyl, C₁-C₆ alkylsulfonyl, C₁-C₆ alkoxycarbonyl, C₁-C₆ carbamoyl, hydroxycarbonyl, C₁-C₆ alkylcarbonyl, aminocarbonyl, C₁-C₆ alkylaminocarbonyl, C₁-C₆ dialkylaminocarbonyl, provided that the substituents are sterically compatible and the rules of chemical bonding and strain energy are satisfied. Preferred substituents include halogen, C₁-C₄ alkyl and C₁-C₄ haloalkyl.

As used herein, the term “halogen,” including derivative terms such as “halo,” refers to fluorine, chlorine, bromine and iodine.

As used herein, agriculturally acceptable salts and esters may be understood to include salts and esters that exhibit herbicidal activity, or that are or can be converted in plants, water, or soil to the referenced herbicide. Exemplary agriculturally acceptable esters are those that are or can be hydrolyzed, oxidized, metabolized, or otherwise converted, e.g., in plants, water, or soil, to the corresponding carboxylic acid which, depending on the pH, may be in the dissociated or undissociated form.

Compounds described herein can include N-oxides. Pyridine N-oxides can be obtained by oxidation of the corresponding pyridines. Suitable oxidation methods are described, for example, in Houben-Weyl, Methoden der organischen Chemie [Methods in organic chemistry], expanded and subsequent volumes to the 4th edition, volume E 7b, p. 565 f.

### II. Pyridine Carboxylate Herbicides

Compositions and methods of the present disclosure include a composition comprising

(a) a pyridine carboxylate herbicide defined by Formula (I):

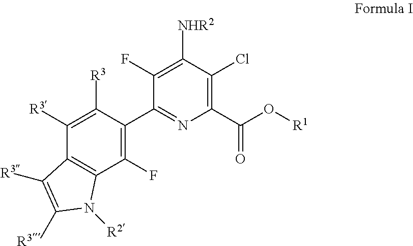

wherein:
R¹ is cyanomethyl or propargyl;
R² and R^{2′} are independently hydrogen, C₁-C₆ alkyl, formyl, alkoxycarbonyl, or acyl;
R³, R^{3′}, R^{3′}, and R^{3′″} are independently hydrogen, halogen, C₁-C₄ alkyl, C₁-C₄ haloalkyl, C₁-C₃ alkoxy, or C₁-C₃ haloalkoxy;
   or an agriculturally acceptable N-oxide, salt, or ester thereof; and
   (b) a plant growth regulator (PGR), an agriculturally acceptable salt or ester thereof, or mixtures thereof.

In some aspects, compositions and methods of the present disclosure include the composition comprising (a) the pyridine carboxylate herbicide cyanomethyl 4-amino-3-chloro-5-fluoro-6-(7-fluoro-1H-indol-6-yl)pyridine-2-carboxylate, Compound A:

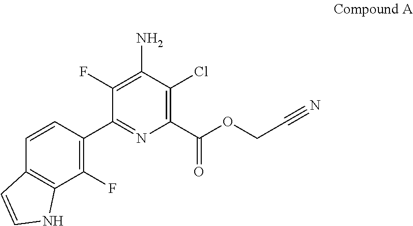 [SMILES: N#CCOC(=O)c1nc(-c2ccc3cc[nH]c3c2F)c(F)c(N)c1Cl]

or an agriculturally acceptable N-oxide, salt, or ester thereof, and (b) a plant growth regulator (PGR), an agriculturally acceptable salt or ester thereof, or mixtures thereof.

In some aspects, compositions and methods of the present disclosure include the composition comprising (a) the pyridine carboxylate herbicide propargyl 4-amino-3-chloro-5-fluoro-6-(7-fluoro-1H-indol-6-yl)pyridine-2-carboxylate, Compound B:

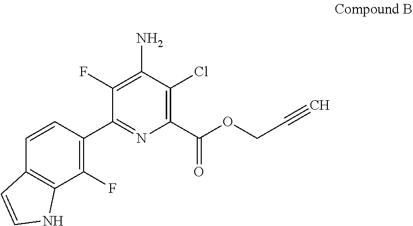 [SMILES: C#CCOC(=O)c1nc(-c2ccc3cc[nH]c3c2F)c(F)c(N)c1Cl]

or an agriculturally acceptable N-oxide, salt, or ester thereof, and (b) a plant growth regulator (PGR), an agriculturally acceptable salt or ester thereof, or mixtures thereof.

Pyridine carboxylate herbicides defined by Formula (I), as well as methods of making these pyridine carboxylate herbicides, are disclosed in application PCT/US2018/031004, filed May 4, 2018, the entire disclosure of which is hereby expressly incorporated by reference.

In some aspects, the pyridine carboxylate herbicide can be provided as an agriculturally acceptable salt. Exemplary agriculturally acceptable salts of the pyridine carboxylate herbicides include, but are not limited to: sodium salts; potassium salts; ammonium salts or substituted ammonium salts, in particular mono-, di- and tri-C₁-C₈-alkylammonium salts such as methyl ammonium, dimethylammonium and isopropylammonium; mono-, di- and tri-hydroxy-C₂-C₈-alkylammonium salts such as hydroxyethylammonium, di(hydroxyethyl)ammonium, tri(hydroxyethyl)ammonium, hydroxypropyl-ammonium, di(hydroxypropyl)ammonium and tri(hydroxypropyl)ammonium salts; olamine salts; diglycolamine salts; choline salts; and quaternary ammonium salts such as those represented by the formula R⁹R¹⁰R¹¹R¹²N⁺ and wherein R⁹, R¹⁰, R¹¹ and R¹² (e.g., R⁹-R¹²) each independently can represent hydrogen, C₁-C₁₀ alkyl, C₂-C₈ alkenyl, C₂-C₈ alkynyl, C₁-C₈ alkoxy, C₁-C₈ alkylthio, or aryl groups, provided that R⁹-R¹² are sterically compatible.

In some aspects, the pyridine carboxylate herbicide can be provided as an agriculturally acceptable ester. Exemplary agriculturally acceptable esters of the pyridine carboxylate herbicides include, but are not limited to: methyl, ethyl, propyl, 1-methyl-ethyl, butyl, 1-methyl-propyl, 2-methyl-propyl, pentyl, 1-methyl-butyl, 2-methyl-butyl, 3-methyl-butyl, 1-ethyl-propyl, hexyl, 1-methyl-hexyl (mexyl), 2-ethylhexyl, heptyl, 1-methyl-heptyl (meptyl), octyl, isooctyl (isoctyl), butoxyethyl (butotyl), and benzyl.

The pyridine carboxylate herbicide, or an agriculturally acceptable N-oxide, salt, or ester thereof, can be applied to vegetation or an area adjacent the vegetation or applied to soil or water to prevent the emergence or growth of vegetation in an amount sufficient to induce a herbicidal effect. In some aspects, the pyridine carboxylate herbicide, or an agriculturally acceptable N-oxide, salt, or ester thereof, is applied to vegetation or an area adjacent the vegetation or applied to soil or water to prevent the emergence or growth of vegetation in an amount of 0.1 grams acid equivalent per hectare (g ae/ha) or greater, such as 0.2 g ae/ha or greater, 0.3 g ae/ha or greater, 0.4 g ae/ha or greater, 0.5 g ae/ha or greater, 0.6 g ae/ha or greater, 0.7 g ae/ha or greater, 0.8 g ae/ha or greater, 0.9 g ae/ha or greater, 1 g ae/ha or greater, 1.1 g ae/ha or greater, 1.2 g ae/ha or greater, 1.3 g ae/ha or greater, 1.4 g ae/ha or greater, 1.5 g ae/ha or greater, 1.6 g ae/ha or greater, 1.7 g ae/ha or greater, 1.8 g ae/ha or greater, 1.9 g ae/ha or greater, 2 g ae/ha or greater, 2.25 g ae/ha or greater, 2.5 g ae/ha or greater, 2.75 g ae/ha or greater, 3 g ae/ha or greater, 4 g ae/ha or greater, 5 g ae/ha or greater, 6 g ae/ha or greater, 7 g ae/ha or greater, 8 g ae/ha or greater, 9 g ae/ha or greater, 10 g ae/ha or greater, 11 g ae/ha or greater, 12 g ae/ha or greater, 13 g ae/ha or greater, 14 g ae/ha or greater, 15 g ae/ha or greater, 16 g ae/ha or greater, 17 g ae/ha or greater, 18 g ae/ha or greater, 19 g ae/ha or greater, 20 g ae/ha or greater, 22 g ae/ha or greater, 24 g ae/ha or greater, 25 g ae/ha or greater, 26 g ae/ha or greater, 28 g ae/ha or greater, 30 g ae/ha or greater, 32 g ae/ha or greater, 34 g ae/ha or greater, 35 g ae/ha or greater, 36 g ae/ha or greater, 38 g ae/ha or greater, 40 g ae/ha or greater, 42.5 g ae/ha or greater, 45 g ae/ha or greater, 47.5 g ae/ha or greater, 50 g ae/ha or greater, 52.5 g ae/ha or greater, 55 g ae/ha or greater, 57.5 g ae/ha or greater, 60 g ae/ha or greater, 65 g ae/ha or greater, 70 g ae/ha or greater, 75 g ae/ha or greater, 80 g ae/ha or greater, 85 g ae/ha or greater, 90 g ae/ha or greater, 95 g ae/ha or greater, 100 g ae/ha or greater, 110 g ae/ha or greater, 120 g ae/ha or greater, 130 g ae/ha or greater, 140 g ae/ha or greater, 150 g ae/ha or greater, 160 g ae/ha or greater, 170 g ae/ha or greater, 180 g ae/ha or greater, 190 g ae/ha or greater, 200 g ae/ha or greater, 210 g ae/ha or greater, 220 g ae/ha or greater, 230 g ae/ha or greater, 240 g ae/ha or greater, 250 g ae/ha or greater, 260 g ae/ha or greater, 270 g ae/ha or greater, 280 g ae/ha or greater, or 290 g ae/ha or greater; in an amount of 300 g ae/ha or less, such as 290 g ae/ha or less, 280 g ae/ha or less, 270 g ae/ha or less, 260 g ae/ha or less, 250 g ae/ha or less, 240 g ae/ha or less, 230 g ae/ha or less, 220 g ae/ha or less, 210 g ae/ha or less, 200 g ae/ha or less, 190 g ae/ha or less, 180 g ae/ha or less, 170 g ae/ha or less, 160 g ae/ha or less, 150 g ae/ha or less, 140 g ae/ha or less, 130 g ae/ha or less, 120 g ae/ha or less, 110 g ae/ha or less, 100 g ae/ha or less, 95 g ae/ha or less, 90 g ae/ha or less, 85 g ae/ha or less, 80 g ae/ha or less, 75 g ae/ha or less, 70 g ae/ha or less, 65 g ae/ha or less, 60 g ae/ha or less, 57.5 g ae/ha or less, 55 g ae/ha or less, 52.5 g ae/ha or less, 50 g ae/ha or less, 47.5 g ae/ha or less, 45 g ae/ha or less, 42.5 g ae/ha or less, 40 g ae/ha or less, 38 g ae/ha or less, 36 g ae/ha or less, 35 g ae/ha or less, 34 g ae/ha or less, 32 g ae/ha or less, 30 g ae/ha or less, 28 g ae/ha or less, 26 g ae/ha or less, 25 g ae/ha or less, 24 g ae/ha or less, 22 g ae/ha or less, 20 g ae/ha or less, 19 g ae/ha or less, 18 g ae/ha or less, 17 g ae/ha or less, 16 g ae/ha or less, 15 g ae/ha or less, 14 g ae/ha or less, 13 g ae/ha or less, 12 g ae/ha or less, 11 g ae/ha or less, 10 g ae/ha or less, 9 g ae/ha or less, 8 g ae/ha or less, 7 g ae/ha or less, 6 g ae/ha or less, 5 g ae/ha or less, 4 g ae/ha or less, 3 g ae/ha or less, 2.75 g ae/ha or less, 2.5 g ae/ha or less, 2.25 g ae/ha or less, 2 g ae/ha or less, 1.9 g ae/ha or less, 1.8 g ae/ha or less, 1.7 g ae/ha or less, 1.6 g ae/ha or less, 1.5 g ae/ha or less, 1.4 g ae/ha or less, 1.3 g ae/ha or less, 1.2 g ae/ha or less, 1.1 g ae/ha or less, 1 g ae/ha or less, 0.9 g ae/ha or less, 0.8 g ae/ha or less, 0.7 g ae/ha or less, 0.6 g ae/ha or less, 0.5 g ae/ha or less, 0.4 g ae/ha or less, 0.3 g ae/ha or less, or 0.2 g ae/ha or less; or in an amount within any range defined between any pair of the preceding values, such as 0.1-300 g ae/ha, 1-150 g ae/ha, 10-200 g ae/ha, 25 g ae/ha-75 g ae/ha, or 40-100 g ae/ha.

### III. Plant Growth Regulators

In addition to the pyridine carboxylate herbicide or agriculturally acceptable N-oxide, salt or ester thereof, the compositions can include a plant growth regulator (PGR), an agriculturally acceptable salt or ester thereof, or mixtures thereof. PGRs, also called plant hormones, act as chemical messengers for intercellular communication. PGRs can be classified into a number of modes of action that may influence, for example, the growth, division, elongation, or differentiation of plant cells. Examples of PGRs include 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, and uniconazole.

In some aspects, the composition can include a PGR selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and mixtures thereof.

PGRs can be applied to vegetation or an area adjacent the vegetation or applied to soil or water to prevent the emergence or growth of vegetation in an amount sufficient to induce a herbicidal effect. In some aspects, the PGR is applied to vegetation or an area adjacent the vegetation or applied to soil or water to prevent the emergence or growth of vegetation in an amount of 20 g ai/ha or more, such as 0.020 g ai/ha or more, such as 0.025 g ai/ha or more, 0.03 g ai/ha or more, 0.04 g ai/ha or more, 0.05 g ai/ha or more, 0.06 g ai/ha or more, 0.07 g ai/ha or more, 0.08 g ai/ha or more, 0.09 g ai/ha or more, 0.1 g ai/ha or more, 0.11 g ai/ha or more, 0.125 g ai/ha or more, 0.15 g ai/ha or more, 0.175 g ai/ha or more, 0.20 g ai/ha or more, 0.25 g ai/ha or more, 0.3 g ai/ha or more, 0.4 g ai/ha or more, 0.5 g ai/ha or more, 0.6 g ai/ha or more, 0.7 g ai/ha or more, 0.8 g ai/ha or more, 0.9 g ai/ha or more, 1 g ai/ha or more, 1.1 g ai/ha or more, 1.25 g ai/ha or more, 1.5 g ai/ha or more, 1.75 g ai/ha or more, 2 g ai/ha or more, 2.25 g ai/ha or more, 2.5 g ai/ha or more, 2.75 g ai/ha or more, 3 g ai/ha or more, 3.25 g ai/ha or more, 3.5 g ai/ha or more, 3.75 g ai/ha or more, 4 g ai/ha or more, 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, 9.5 g ai/ha, or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, 5750 g ai/ha or more, 6000 g ai/ha or more, 6250 g ai/ha or more, 6500 g ai/ha or more, 6750 g ai/ha or more, 7000 g ai/ha or more, 7250 g ai/ha or more, 7500 g ai/ha or more, 7750 g ai/ha or more, 8000 g ai/ha or more, 8250 g ai/ha or more, 8500 g ai/ha or more, 8750 g ai/ha or more, 9000 g ai/ha or more, 9250 g ai/ha or more, 9500 g ai/ha or more, 9750 g ai/ha or more, 10 kg ai/ha or more, 10.5 kg ai/ha or more, 11 kg ai/ha or more, 11.5 kg ai/ha or more, 12k g ai/ha or more, 12.5 kg ai/ha or more, 13 kg ai/ha or more, 13.5 kg ai/ha or more, 14 kg ai/ha or more, 14.5 kg ai/ha or more, 15 kg ai/ha or more, 15.5 kg ai/ha or more, 16 kg ai/ha or more, 16.5 kg ai/ha or more, 16.75 kg ai/ha or more, 17 kg ai/ha or more, or 17.5 kg ai/ha or more; in an amount of 17.5 kg ai/ha or less, such as 17 kg ai/ha or less, 16.5 kg ai/ha or less, 16 kg ai/ha or less, 15.5 kg ai/ha or less, 15 kg ai/ha or less, 14.5k g ai/ha or less, 14 kg ai/ha or less, 13.5 kg ai/ha or less, 13 kg ai/ha or less, 12.5 kg ai/ha or less, 12 kg ai/ha or less, 11.5 kg ai/ha or less, 11 kg ai/ha or less, 10.5 kg ai/ha, 10 kg ai/ha or less, 9750 g ai/ha or less, 9500 g ai/ha or less, 9250 g ai/ha or less, 9000 g ai/ha or less, 8750 g ai/ha or less, 8500 g ai/ha or less, 8250 g ai/ha or less, 8000 g ai/ha or less, 7750 g ai/ha or less, 7500 g ai/ha or less, 7250 g ai/ha or less, 7000 g ai/ha or less, 6750 g ai/ha or less, 6500 g ai/ha or less, 6250 g ai/ha or less, 6000 g ai/ha or less, 5750 g ai/ha or less, 5500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9.5 g ai/ha or less, 9 g ai/ha or less, 8.5 g ai/ha or less, 8 g ai/ha or less, 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, 4.25 g ai/ha or less, 4 g ai/ha or less, 3.75 g ai/ha or less, 3.5 g ai/ha or less, 3.25 g ai/ha or less, 3 g ai/ha or less, 2.75 g ai/ha or less, 2.5 g ai/ha or less, 2.25 g ai/ha or less, 2 g ai/ha or less, 1.75 g ai/ha or less, 1.5 g ai/ha or less, 1.25 g ai/ha or less, 1.1 g ai/ha or less, 1 g ai/ha or less, 0.9 g ai/ha or less, 0.8 g ai/ha or less, 0.7 g ai/ha or less, 0.6 g ai/ha or less, 0.5 g ai/ha or less, 0.4 g ai/ha or less, 0.3 g ai/ha or less, 0.2 g ai/ha or less, 0.175 g ai/ha or less, 0.15 g ai/ha or less, 0.125 g ai/ha or less, 0.11 g ai/ha or less, 0.1 g ai/ha or less, 0.09 g ai/ha or less, 0.08 g ai/ha or less, 0.07 g ai/ha or less, 0.06 g ai/ha or less, 0.05 g ai/ha or less, 0.04 g ai/ha or less, 0.03 g ai/ha or less, or 0.025 g ai/ha or less; or in an amount ranging from any of the minimum values described above to any of the maximum values described above, such as 0.020 g-17.5 kg ai/ha, 950-6500 g ai/ha, 0.7-8.5 g ai/ha, 460-3750 g ai/ha, 600-2500 g ai/ha, 50-5000 g ai/ha, 110-450 g ai/ha, 11.5-16 kg ai/ha, 1900-4000 g ai/ha, 1-4 g ai/ha, 750-2200 g ai/ha, 380-5250 g ai/ha, 0.2-17.25 g ai/ha, 500-1400 g ai/ha, 3.25-950 g ai/ha, 440-2900 g ai/ha, or 0.025 g-17 kg ai/ha.

1,4-Dimethylnaphthalene

Compositions and methods of the present disclosure can include 1,4-dimethylnaphthalene or an agriculturally acceptable salt or ester thereof 1,4-Dimethylnaphthalene, shown below, is an aromatic hydrocarbon that provides inhibition of sprouting in potatoes after packaging, during shipping and in storage or in seed potatoes, at a spray rate of 5-20 mg/kg of potatoes. 1,4-Dimethylnaphthalene, as well as methods of preparing 1,4-dimethylnaphthalene, are known in the art. Its plant growth regulation activity is described, for example, in The Pesticide Manual, Eighteenth Edition, 2016.

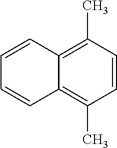

1-Methylcyclopropene

Compositions and methods of the present disclosure can include 1-methylcyclopropene or an agriculturally acceptable salt or ester thereof. 1-Methylcyclopropene, shown below, is a cyclic hydrocarbon that extends the life of cut and potted flowering plants and of harvested fruit and vegetables. It is formulated as a powder and released as a gas when the product is added to water. 1-Methylcyclopropene, as well as methods of preparing 1-methylcyclopropene, are known in the art. Its plant growth regulation activity is described, for example, in The Pesticide Manual, Eighteenth Edition, 2016.

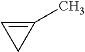

1-Methylcyclopropene can be applied to vegetation or an area adjacent the vegetation or applied to soil or water to prevent the emergence or growth of vegetation in an amount sufficient to induce a herbicidal effect. In some aspects, 1-methylcyclopropene is applied to vegetation or an area adjacent the vegetation or applied to soil or water to prevent the emergence or growth of vegetation in an amount of 5 g ai/ha or more, such as 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, 9.5 g ai/ha, or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, or 47.5 g ai/ha or more; in an amount of such as 50 g ai/ha or less, such as 47.5 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9.5 g ai/ha or less, 9 g ai/ha or less, 8.5 g ai/ha or less, 8 g ai/ha or less 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less; or in an amount ranging from any of the minimum values described above to any of the maximum values described above, such as 15-50 g ai/ha, 9.5-30 g ai/ha, 5-25 g ai/ha, 20-45 g ai/ha, 5.25-9.5 g ai/ha, or 7.5-47.5 g ai/ha.

1-Naphthylacetic Acid

Compositions and methods of the present disclosure can include 1-naphthylacetic acid or an agriculturally acceptable salt or ester thereof. 1-Naphthylacetic acid, shown below, is a naphthylacetic acid that: stimulates root formation in cuttings of woody and herbaceous plants and vines at 0.1-0.6 g/plant; prevents premature flower and fruit drop in apples, pears, grapes, guavas, mangoes, water melons, pawpaws, citrus, aubergines, cucumbers, cotton, soybeans, etc.; increases fruit setting; provides thinning of fruit in apples, pears, olives, citrus and other fruit; and induces flowering in pineapples. 1-Naphthylacetic acid, as well as methods of preparing 1-naphthylacetic acid, are known in the art. Exemplary salts of 1-Naphthylacetic acid include ammonium 1-Naphthylacetic acetate, sodium 1-Naphthylacetic acetate, and potassium 1-Naphthylacetic acetate, while esters include ethyl 1-Naphthylacetic acetate. Its plant growth regulation activity is described, for example, in The Pesticide Manual, Eighteenth Edition, 2016.

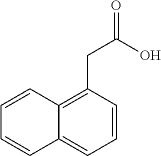 [SMILES: O=C(O)Cc1cccc2ccccc12]

1-Naphthylacetic acid can be applied to vegetation or an area adjacent the vegetation or applied to soil or water to prevent the emergence or growth of vegetation in an amount sufficient to induce a herbicidal effect. In some aspects, 1-naphthylacetic acid is applied to vegetation or an area adjacent the vegetation or applied to soil or water to prevent the emergence or growth of vegetation in an amount of 100 g ai/ha or more, such as 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, or 390 g ai/ha or more; in an amount of 400 g ai/ha or less, such as 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less; or in an amount ranging from any of the minimum values described above to any of the maximum values described above, such as 100-400 g ai/ha, 130-275 g ai/ha, 260-370 g ai/ha, 200-250 g ai/ha, 190-380 g ai/ha, 110-320 g ai/ha, 310-400 g ai/ha, 140-220 g ai/ha, 260-360 g ai/ha, or 110-390 g ai/ha.

2,6-Diisopropylnaphthalene

Compositions and methods of the present disclosure can include 2,6-diisopropylnaphthalene or an agriculturally acceptable salt or ester thereof. 2,6-Diisopropylnaphthalene, shown below, is an aromatic hydrocarbon that inhibits sprouting in potatoes, at a spray rate of 2.5-25 mg/kg of potatoes. 2,6-Diisopropylnaphthalene, as well as methods of preparing 2,6-diisopropylnaphthalene, are known in the art. Its plant growth regulation activity is described, for example, in The Pesticide Manual, Eighteenth Edition, 2016.

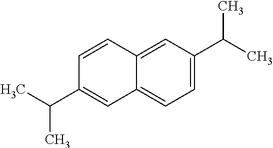 [SMILES: CC(C)c1ccc2cc(C(C)C)ccc2c1]

2-Naphthyloxyacetic Acid

Compositions and methods of the present disclosure can include 2-naphthyloxyacetic acid or an agriculturally acceptable salt or ester thereof. 2-Naphthyloxyacetic acid, shown below, is a phenoxycarboxylic acid that increases fruit setting in tomatoes, strawberries, blackberries, peppers, aubergines, grapes and pineapples. 2-Naphthyloxyacetic acid, as well as methods of preparing 2-naphthyloxyacetic acid, are known in the art. Its plant growth regulation activity is described, for example, in The Pesticide Manual, Eighteenth Edition, 2016.

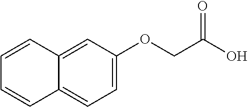 [SMILES: O=C(O)COc1ccc2ccccc2c1]

4-Chlorophenoxyacetic Acid (4-CPA)

Compositions and methods of the present disclosure can include 4-chlorophenoxyacetic acid (4-CPA) or an agriculturally acceptable salt or ester thereof 4-CPA, shown below, is a phenoxycarboxylic acid that improves fruit setting in tomatoes, by application to the flowers, at 1.5-3 g/hl of spray solution; inhibition of sprout formation in mung beans; thinning of fruit in peaches. 4-CPA, as well as methods of preparing 4-CPA, are known in the art. Its plant growth regulation activity is described, for example, in The Pesticide Manual, Eighteenth Edition, 2016.

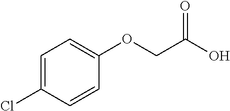 [SMILES: O=C(O)COc1ccc(Cl)cc1]

6-Benzylaminopurine

Compositions and methods of the present disclosure can include 6-benzylaminopurine or an agriculturally acceptable salt or ester thereof 6-Benzylaminopurine, shown below, is a aminopurine that stimulates lateral bud emergence in apples, pears and oranges, formation of basal shoots in roses and orchids, flowering in cyclamens and cacti, fruit set in grapes, oranges and melons, fruit thinning, flower bud formation and regular bearing in tree fruit, inhibition of senescence in rice seedlings, enhancement of lateral bud break and shoot growth in white pine trees, uniform bolting and increased seed production in spinach, all by foliar application, soaking, or painting, at 75 g/ha in apples. 6-Benzylaminopurine, as well as methods of preparing 6-benzylaminopurine, are known in the art. Its plant growth regulation activity is described, for example, in The Pesticide Manual, Eighteenth Edition, 2016.

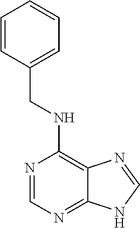 [SMILES: c1ccc(CNc2ncnc3[nH]cnc23)cc1]

6-Benzylaminopurine can be applied to vegetation or an area adjacent the vegetation or applied to soil or water to prevent the emergence or growth of vegetation in an amount sufficient to induce a herbicidal effect. In some aspects, 6-benzylaminopurine is applied to vegetation or an area adjacent the vegetation or applied to soil or water to prevent the emergence or growth of vegetation in an amount of 10 g ai/ha or more, such as 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, or 490 g ai/ha or more; in an amount of 500 g ai/ha or less, such as 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, or 15 g ai/ha or less; or in an amount ranging from any of the minimum values described above to any of the maximum values described above, such as 10-500 g ai/ha, 95-340 g ai/ha, 400-475 g ai/ha, 60-250 g ai/ha, 75-375 g ai/ha, 110-460 g ai/ha, 180-430 g ai/ha, 15-220 g ai/ha, 35-350 g ai/ha, 160-410 g ai/ha, 40-230 g ai/ha, or 15-490 g ai/ha.

Abscisic Acid

Compositions and methods of the present disclosure can include abscisic acid or an agriculturally acceptable salt or ester thereof. Abscisic acid, shown below, is a plant hormone that reduces drought stress and controls wilting in ornamental plants; decreases water requirements during shipping of ornamental plants; accelerates and enhances the color development of grapes, using a spray solution at 7.5-50 g/hl concentration. Abscisic acid, as well as methods of preparing abscisic acid, are known in the art. Its plant growth regulation activity is described, for example, in The Pesticide Manual, Eighteenth Edition, 2016.

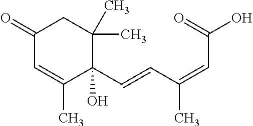 [SMILES: CC1=CC(=O)CC(C)(C)[C@@]1(O)/C=C/C(C)=C\C(=O)O]

Abscisic acid can be applied to vegetation or an area adjacent the vegetation or applied to soil or water to prevent the emergence or growth of vegetation in an amount sufficient to induce a herbicidal effect. In some aspects, abscisic acid is applied to vegetation or an area adjacent the vegetation or applied to soil or water to prevent the emergence or growth of vegetation in an amount of 75 g ai/ha or more, such as 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, or 950 g ai/ha or more; in an amount of 1000 g ai/ha or less, such as 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, or 80 g ai/ha or less; or in an amount ranging from any of the minimum values described above to any of the maximum values described above, such as 75-1000 g ai/ha, 95-650 g ai/ha, 460-850 g ai/ha, 220-575 g ai/ha, 450-500 g ai/ha, 110-325 g ai/ha, 330-490 g ai/ha, 750-950 g ai/ha, 380-700 g ai/ha, 500-1000 g ai/ha, 240-600 g ai/ha, or 80-950 g ai/ha.

Ancymidol

Compositions and methods of the present disclosure can include ancymidol or an agriculturally acceptable salt or ester thereof. Ancymidol, shown below, is a pyrimidine carbinol used to reduce internode elongation to produce more compact greenhouse plants, by application to either foliage or soil, at 0.6-6.6 g/hl for bedding plants, 0.3-3.5 g/hl for bedding plant plugs, 2-5 g/hl for flowering and foliage plants, 2.5-5 g/hl for bulbs. Ancymidol, as well as methods of preparing ancymidol, are known in the art. Its plant growth regulation activity is described, for example, in The Pesticide Manual, Eighteenth Edition, 2016.

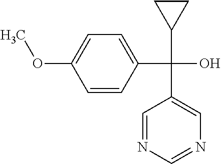 [SMILES: COc1ccc(C(O)(c2cncnc2)C2CC2)cc1]

Aviglycine

Compositions and methods of the present disclosure can include aviglycine or an agriculturally acceptable salt or ester thereof. Aviglycine, shown below, is an amino acid used to reduce fruit drop, reduce delay of fruit maturity, reduce delay or extension of harvest, improve harvest management, maintain fruit quality (e.g. fruit firmness), enhance size and color as a result of delayed harvest, reduce incidence and/or severity of watercore and superficial scald, enhance storage potential in apples, pears, stone fruit and walnuts and increase nut set in walnut cultivars affected by pistillate flower abortion. Aviglycine, as well as methods of preparing aviglycine, are known in the art. Its plant growth regulation activity is described, for example, in The Pesticide Manual, Eighteenth Edition, 2016.

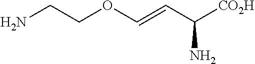 [SMILES: NCCO/C=C/[C@H](N)C(=O)O]

Aviglycine can be applied to vegetation or an area adjacent the vegetation or applied to soil or water to prevent the emergence or growth of vegetation in an amount sufficient to induce a herbicidal effect. In some aspects, aviglycine is applied to vegetation or an area adjacent the vegetation or applied to soil or water to prevent the emergence or growth of vegetation in an amount of 200 g ai/ha or more, such as 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, or 725 g ai/ha or more; in an amount of 750 g ai/ha or less, such as 725 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, or 210 g ai/ha or less; or in an amount ranging from any of the minimum values described above to any of the maximum values described above, such as 200-750 g ai/ha, 275-525 g ai/ha, 460-550 g ai/ha, 300-700 g ai/ha, 210-450 g ai/ha, 400-600 g ai/ha, 330-725 g ai/ha, 380-550 g ai/ha, 425-575 g ai/ha, 440-750 g ai/ha, or 210-725 g ai/ha.

Butralin

Compositions and methods of the present disclosure can include butralin or an agriculturally acceptable salt or ester thereof. Butralin, shown below, is a dinitroaniline used for pre-emergence control of annual broad-leaved and grass weeds in cotton, soybeans, rice, barley, beans, alliums, vines, ornamentals, fruit and nut trees, at 1120-3400 g/ha; control of suckers in tobacco, at 125 mg/plant. Butralin, as well as methods of preparing butralin, are known in the art. Its plant growth regulation activity is described, for example, in The Pesticide Manual, Eighteenth Edition, 2016.

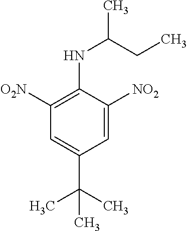 [SMILES: CCC(C)Nc1c([N+](=O)[O-])cc(C(C)(C)C)cc1[N+](=O)[O-]]

Butralin can be applied to vegetation or an area adjacent the vegetation or applied to soil or water to prevent the emergence or growth of vegetation in an amount sufficient to induce a herbicidal effect. In some aspects, butralin is applied to vegetation or an area adjacent the vegetation or applied to soil or water to prevent the emergence or growth of vegetation in an amount of 1100 g ai/ha or more, such as 1120 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3300 g ai/ha or more or 3400 g ai/ha or more; in an amount of 3500 g ai/ha or less, such as 3400 g ai/ha or less, 3300 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1450 g ai/ha or less, 1400 g ai/ha or less, 1350 g ai/ha or less, 1300 g ai/ha or less, 1250 g ai/ha or less, 1200 g ai/ha or less, 1150 g ai/ha or less, or 1120 g ai/ha or less; or in an amount ranging from any of the minimum values described above to any of the maximum values described above, such as 1100-3500 g ai/ha, 1450-2900 g ai/ha, 1300-3200 g ai/ha, 1600-2500 g ai/ha, 1250-3000 g ai/ha, 1800-2400 g ai/ha, 1900-3400 g ai/ha, 1350-2700 g ai/ha, 1120-3100 g ai/ha, 1500-3500 g ai/ha, 2200-2900 g ai/ha, or 1120-3400 g ai/ha.

Chlorflurenol

Compositions and methods of the present disclosure can include chlorflurenol or an agriculturally acceptable salt or ester thereof. Chlorflurenol, shown below, is a polycyclic aromatic carboxylic acid used as a growth retardant, at 2000-4000 g/ha, and for weed suppression, at 500-1500 g/ha as a soil application, in amenity grass, roadsides, railways, ditch banks, etc. Chlorflurenol also increases yield and improve size grading in pickling cucumbers, and induces vegetative planting material in pineapples. Chlorflurenol, as well as methods of preparing chlorflurenol, are known in the art. Its plant growth regulation activity is described, for example, in The Pesticide Manual, Eighteenth Edition, 2016.

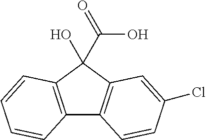 [SMILES: O=C(O)C1(O)c2ccccc2-c2ccc(Cl)cc21]

Chlorflurenol can be applied to vegetation or an area adjacent the vegetation or applied to soil or water to prevent the emergence or growth of vegetation in an amount sufficient to induce a herbicidal effect. In some aspects, chlorflurenol is applied to vegetation or an area adjacent the vegetation or applied to soil or water to prevent the emergence or growth of vegetation in an amount of 500 g ai/ha or more, such as 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3250 g ai/ha or more, 3500 g ai/ha or more, or 3750 g ai/ha or more; in an amount of 4000 g ai/ha or less, such as 3750 g ai/ha or less, 3500 g ai/ha or less, 3250 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, or 525 g ai/ha or less; or in an amount ranging from any of the minimum values described above to any of the maximum values described above, such as 500-4000 g ai/ha, 950-2500 g ai/ha, 675-3250 g ai/ha, 800-2100 g ai/ha, 550-2000 g ai/ha, 1100-2700 g ai/ha, 1900-2600 g ai/ha, 750-1200 g ai/ha, 3000-3250 g ai/ha, 600-1400 g ai/ha, 850-2300 g ai/ha, or 525-3750 g ai/ha.

Chlormequat Chloride

Compositions and methods of the present disclosure can include chlormequat chloride. Chlormequat chloride, shown below, is a quaternary ammonium salt used to: increase resistance to lodging and increase yields in wheat, rye, oats and triticale, at 800-1600 g/ha; promote lateral branching and flowering in azaleas, fuchsias, begonias, poinsettias, geraniums, pelargoniums and other ornamental plants; promote flower formation and improve fruit setting in pears, almonds, vines, olives and tomatoes; and prevent premature fruit drop in pears, apricots and plums. Chlormequat chloride, as well as methods of preparing chlormequat chloride, are known in the art. Its plant growth regulation activity is described, for example, in The Pesticide Manual, Eighteenth Edition, 2016.

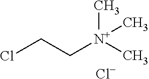

Chlormequat chloride can be applied to vegetation or an area adjacent the vegetation or applied to soil or water to prevent the emergence or growth of vegetation in an amount sufficient to induce a herbicidal effect. In some aspects, chlormequat chloride is applied to vegetation or an area adjacent the vegetation or applied to soil or water to prevent the emergence or growth of vegetation in an amount of 500 g ai/ha or more, such as 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, or 1550 g ai/ha or more; in an amount of 1600 g ai/ha or less, such as 1550 g ai/ha or less, 1500 g ai/ha or less, 1400 g ai/ha or less, 1300 g ai/ha or less, 1200 g ai/ha or less, 1100 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, or 525 g ai/ha or less; or in an amount ranging from any of the minimum values described above to any of the maximum values described above, such as 500-1600 g ai/ha, 750-1500 g ai/ha, 675-1100 g ai/ha, 600-1300 g ai/ha, 650-1000 g ai/ha, 1100-1400 g ai/ha, 900-1200 g ai/ha, 700-1550 g ai/ha, 500-800 g ai/ha, 800-1200 g ai/ha, or 525-1550 g ai/ha.

Chlorpropham

Compositions and methods of the present disclosure can include chlorpropham or an agriculturally acceptable salt or ester thereof. Chlorpropham, shown below, is a quaternary ammonium salt used to inhibit sprouting in stored potatoes, at 8-64 g/t and control suckers in tobacco. Chlorpropham is also used for pre-emergence control of annual grass and some broad-leaved weeds in onions, leeks, garlic, shallots, alfalfa, clover, sugar beets, spinach, lettuce, endive, chicory, herbs, peas, beans, carrots, celery, black salsify, fennel, soybeans, cotton, rice, safflowers, sunflowers, cranberries, cane berries, ornamentals, ornamental trees and shrubs, perennial grass seed crops, etc., at up to 240 g/ha. Chlorpropham, as well as methods of preparing chlorpropham, are known in the art. Its plant growth regulation activity is described, for example, in The Pesticide Manual, Eighteenth Edition, 2016.

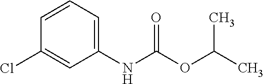

Chlorpropham can be applied to vegetation or an area adjacent the vegetation or applied to soil or water to prevent the emergence or growth of vegetation in an amount sufficient to induce a herbicidal effect. In some aspects, chlorpropham is applied to vegetation or an area adjacent the vegetation or applied to soil or water to prevent the emergence or growth of vegetation in an amount of 15 g ai/ha or more, such as 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, or 245 g ai/ha or more; in an amount of 250 g ai/ha or less, such as 245 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, or 20 g ai/ha or less; or in an amount ranging from any of the minimum values described above to any of the maximum values described above, such as 15-250 g ai/ha, 30-65 g ai/ha, 40-175 g ai/ha, 65-250 g ai/ha, 50-150 g ai/ha, 110-190 g ai/ha, 120-230 g ai/ha, 75-220 g ai/ha, 80-230 g ai/ha, 100-140 g ai/ha, 95-160 g ai/ha, or 20-245 g ai/ha.

Clofencet

Compositions and methods of the present disclosure can include clofencet or an agriculturally acceptable salt or ester thereof. Clofencet, shown below, is a pyridazinecarboxylic acid used as a chemical hybridizing agent for wheat, at 3000-5000 g/h as the potassium salt. Clofencet, as well as methods of preparing clofencet, are known in the art. Its plant growth regulation activity is described, for example, in The Pesticide Manual, Eighteenth Edition, 2016.

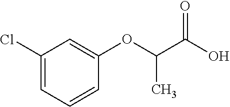

Cloprop

Compositions and methods of the present disclosure can include cloprop or an agriculturally acceptable salt or ester thereof. Cloprop, shown below, is a phenoxycarboxylic acid used to reduce crown growth in pineapples, in order to increase the fruit size and weight and to delay maturation, and also for thinning of fruit in certain plum varieties. Cloprop, as well as methods of preparing cloprop, are known in the art. Its plant growth regulation activity is described, for example, in The Pesticide Manual, Eighteenth Edition, 2016.

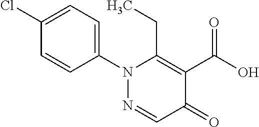 [SMILES: CCc1c(C(=O)O)c(=O)cnn1-c1ccc(Cl)cc1]

Cloprop can be applied to vegetation or an area adjacent the vegetation or applied to soil or water to prevent the emergence or growth of vegetation in an amount sufficient to induce a herbicidal effect. In some aspects, cloprop is applied to vegetation or an area adjacent the vegetation or applied to soil or water to prevent the emergence or growth of vegetation in an amount of 100 g ai/ha or more, such as 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, or 390 g ai/ha or more; in an amount of 400 g ai/ha or less, such as 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, or 110 g ai/ha or less; or in an amount ranging from any of the minimum values described above to any of the maximum values described above, such as 100-400 g ai/ha, 310-380 g ai/ha, 160-375 g ai/ha, 120-250 g ai/ha, 175-350 g ai/ha, 140-240 g ai/ha, 190-370 g ai/ha, 200-220 g ai/ha, 340-400 g ai/ha, 130-375 g ai/ha, 240-380 g ai/ha, or 110-390 g ai/ha.

Cloxyfonac

Compositions and methods of the present disclosure can include cloxyfonac or an agriculturally acceptable salt or ester thereof. Cloxyfonac, shown below, is a phenoxycarboxylic acid used for fruit setting in tomatoes and aubergines at flowering, producing fruit of uniform size. Cloxyfonac, as well as methods of preparing cloxyfonac, are known in the art. Its plant growth regulation activity is described, for example, in The Pesticide Manual, Eighteenth Edition, 2016.

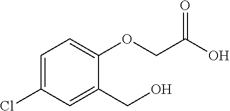 [SMILES: O=C(O)COc1ccc(Cl)cc1CO]

Cyanamide

Compositions and methods of the present disclosure can include cyanamide or an agriculturally acceptable salt or ester thereof. Cyanamide, shown below, is an inorganic compound used for early post-emergence control of broad-leaved weeds in alliums (onions, leeks, chives, shallots and garlic) and bulb flowers. Cyanamide is also used for promotion of bud break and increase of flowering in kiwifruit and apples, and removal of side shoots and inhibition of sprouting in hops and vines. Cyanamide, as well as methods of preparing cyanamide, are known in the art. Its plant growth regulation activity is described, for example, in The Pesticide Manual, Eighteenth Edition, 2016.

H₂N—C≡N

Cyanamide can be applied to vegetation or an area adjacent the vegetation or applied to soil or water to prevent the emergence or growth of vegetation in an amount sufficient to induce a herbicidal effect. In some aspects, cyanamide is applied to vegetation or an area adjacent the vegetation or applied to soil or water to prevent the emergence or growth of vegetation in an amount of 1 kg ai/ha or more, such as 1.1 kg ai/ha or more, 1.25 kg ai/ha or more, 1.5 kg ai/ha or more, 1.75 kg ai/ha or more, 2 kg ai/ha or more, 2.25 kg ai/ha or more, 2.5 kg ai/ha or more, 2.75 kg ai/ha or more, 3 kg ai/ha or more, 3.25 kg ai/ha or more, 3.5 kg ai/ha or more, 3.75 kg ai/ha or more, 4 kg ai/ha or more, 4.25 kg ai/ha or more, 4.5 kg ai/ha or more, or 4.75 kg ai/ha or more; in an amount of 5 kg ai/ha or less, such as 4.75 kg ai/ha or less, 4.5 kg ai/ha or less, 4.25 kg ai/ha or less, 4 kg ai/ha or less, 3.75 kg ai/ha or less, 3.5 kg ai/ha or less, 3.25 kg ai/ha or less, 3 kg ai/ha or less, 2.75 kg ai/ha or less, 2.5 kg ai/ha or less, 2.25 kg ai/ha or less, 2 kg ai/ha or less, 1.75 kg ai/ha or less, 1.5 kg ai/ha or less, 1.25 kg ai/ha or less, or 1.1 kg ai/ha or less; or in an amount ranging from any of the minimum values described above to any of the maximum values described above, such as 1-5 kg ai/ha, 1.25-4 kg ai/ha, 1.1-3.25 kg ai/ha, 2.5-3.75 kg ai/ha, 2-4.25 kg ai/ha, 3.25-4 kg ai/ha, 3-4.5 kg ai/ha, or 1.1-4.75 kg ai/ha.

Cyclanilide

Compositions and methods of the present disclosure can include cyclanilide or an agriculturally acceptable salt or ester thereof. Cyclanilide, shown below, is cyclopropane carboxylic acid used for promotion of boll opening, defoliation and inhibition of terminal foliar regrowth in cotton. Cyclanilide, as well as methods of preparing cyclanilide, are known in the art. Its plant growth regulation activity is described, for example, in The Pesticide Manual, Eighteenth Edition, 2016.

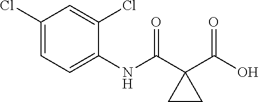 [SMILES: O=C(O)C1(C(=O)Nc2ccc(Cl)cc2Cl)CC1]

Cyclanilide can be applied to vegetation or an area adjacent the vegetation or applied to soil or water to prevent the emergence or growth of vegetation in an amount sufficient to induce a herbicidal effect. In some aspects, cyclanilide is applied to vegetation or an area adjacent the vegetation or applied to soil or water to prevent the emergence or growth of vegetation in an amount of 3 g ai/ha or more, such as 3.25 g ai/ha or more, 3.5 g ai/ha or more, 3.75 g ai/ha or more, 4 g ai/ha or more, 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, 9.5 g ai/ha, or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, or 140 g ai/ha or more; in an amount of 150 g ai/ha or less, such as 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9.5 g ai/ha or less, 9 g ai/ha or less, 8.5 g ai/ha or less, 8 g ai/ha or less 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, 4.25 g ai/ha or less, 4 g ai/ha or less, 3.75 g ai/ha or less, 3.5 g ai/ha or less, or 3.25 g ai/ha or less; or in an amount ranging from any of the minimum values described above to any of the maximum values described above, such as 3-150 g ai/ha, 9.5-65 g ai/ha, 40-130 g ai/ha, 6-25 g ai/ha, 50-120 g ai/ha, 110-150 g ai/ha, 15-40 g ai/ha, 75-125 g ai/ha, 30-85 g ai/ha, 100-140 g ai/ha, 4.5-20 g ai/ha, or 3.25-140 g ai/ha.

Cytokinins

Compositions and methods of the present disclosure can include the cytokinins, such as 6-isopentenylaminopurine, zeatin, and kinetin, or agriculturally acceptable salts or esters thereof. These cytokinins, shown below, are purines that enhance germination, flowering, fruit and seed set, induction of callus initiation, reduction of apical dominance, breaking lateral bud dormancy and retarding of aging in vegetables, peas, beans, tree fruit, vines, ornamentals, flowers, containerized plants, lawn and turf. Cytokinins, as well as methods of preparing cytokinins, are known in the art. Their plant growth regulation activity is described, for example, in The Pesticide Manual, Eighteenth Edition, 2016.

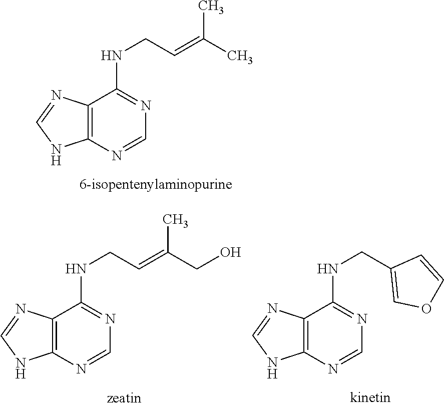 [SMILES: CC(C)=CCNc1ncnc2[nH]cnc12 ; C/C(=C\CNc1ncnc2[nH]cnc12)CO ; c1nc(NCc2ccoc2)c2nc[nH]c2n1]

Cytokinins can be applied to vegetation or an area adjacent the vegetation or applied to soil or water to prevent the emergence or growth of vegetation in an amount sufficient to induce a herbicidal effect. In some aspects, cytokinins are applied to vegetation or an area adjacent the vegetation or applied to soil or water to prevent the emergence or growth of vegetation in an amount of 0.02 g ai/ha or more, such as 0.025 g ai/ha or more, 0.03 g ai/ha or more, 0.04 g ai/ha or more, 0.05 g ai/ha or more, 0.06 g ai/ha or more, 0.07 g ai/ha or more, 0.08 g ai/ha or more, 0.09 g ai/ha or more, 0.1 g ai/ha or more, 0.11 g ai/ha or more, 0.125 g ai/ha or more, 0.15 g ai/ha or more, 0.175 g ai/ha or more, 0.20 g ai/ha or more, 0.25 g ai/ha or more, 0.3 g ai/ha or more, 0.4 g ai/ha or more, 0.5 g ai/ha or more, 0.6 g ai/ha or more, 0.7 g ai/ha or more, 0.8 g ai/ha or more, 0.9 g ai/ha or more, 1 g ai/ha or more, 1.1 g ai/ha or more, 1.25 g ai/ha or more, 1.5 g ai/ha or more, 1.75 g ai/ha or more, 2 g ai/ha or more, 2.25 g ai/ha or more, 2.5 g ai/ha or more, 2.75 g ai/ha or more, 3 g ai/ha or more, 3.25 g ai/ha or more, 3.5 g ai/ha or more, 3.75 g ai/ha or more, 4 g ai/ha or more, 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, or 7.25 g ai/ha or more; in an amount of 7.5 g ai/ha or less, such as 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, 4.25 g ai/ha or less, 4 g ai/ha or less, 3.75 g ai/ha or less, 3.5 g ai/ha or less, 3.25 g ai/ha or less, 3 g ai/ha or less, 2.75 g ai/ha or less, 2.5 g ai/ha or less, 2.25 g ai/ha or less, 2 g ai/ha or less, 1.75 g ai/ha or less, 1.5 g ai/ha or less, 1.25 g ai/ha or less, 1 g ai/ha or less, 0.9 g ai/ha or less, 0.8 g ai/ha or less, 0.7 g ai/ha or less, 0.6 g ai/ha or less, 0.5 g ai/ha or less, 0.4 g ai/ha or less, 0.3 g ai/ha or less, 0.2 g ai/ha or less, 0.175 g ai/ha or less, 0.15 g ai/ha or less, 0.125 g ai/ha or less, 0.11 g ai/ha or less, 0.1 g ai/ha or less, 0.09 g ai/ha or less, 0.08 g ai/ha or less, 0.07 g ai/ha or less, 0.06 g ai/ha or less, 0.05 g ai/ha or less, 0.04 g ai/ha or less, 0.03 g ai/ha or less, or 0.025 g ai/ha or less; or in an amount ranging from any of the minimum values described above to any of the maximum values described above, such as 0.02-7.0 g ai/ha, 0.25-4 g ai/ha, 0.09-6.25 g ai/ha, 0.5-2.25 g ai/ha, 0.06-0.9 g ai/ha, 0.7-4.75 g ai/ha, 1.5-4.5 g ai/ha, 0.1-2 g ai/ha, 1-6 g ai/ha, 0.15-3.75 g ai/ha, 2-5.5 g ai/ha, 3.25-6.5 g ai/ha, 0.3-2.5 g ai/ha, or 0.025-7.25 g ai/ha.

Daminozide

Compositions and methods of the present disclosure can include daminozide or an agriculturally acceptable salt or ester thereof. Daminozide, shown below, is succinamic acid used for inhibition of intermodal elongation, to produce more compact plants, in chrysanthemums, azaleas, hydrangeas, poinsettias and other ornamentals, at 106-425 g/ha. Daminozide, as well as methods of preparing daminozide, are known in the art. Its plant growth regulation activity is described, for example, in The Pesticide Manual, Eighteenth Edition, 2016.

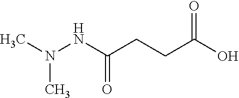

Daminozide can be applied to vegetation or an area adjacent the vegetation or applied to soil or water to prevent the emergence or growth of vegetation in an amount sufficient to induce a herbicidal effect. In some aspects, daminozide is applied to vegetation or an area adjacent the vegetation or applied to soil or water to prevent the emergence or growth of vegetation in an amount of 100 g ai/ha or more, such as 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, or 490 g ai/ha or more; in an amount of 500 g ai/ha or less, such as 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, or 110 g ai/ha or less; or in an amount ranging from any of the minimum values described above to any of the maximum values described above, such as 100-500 g ai/ha, 350-470 g ai/ha, 160-375 g ai/ha, 180-250 g ai/ha, 150-380 g ai/ha, 110-270 g ai/ha, 190-420 g ai/ha, 140-240 g ai/ha, 380-425 g ai/ha, 210-400 g ai/ha, 440-490 g ai/ha, or 110-480 g ai/ha.

Decan-1-Ol

Compositions and methods of the present disclosure can include decan-1-ol or an agriculturally acceptable salt or ester thereof. Decan-1-ol, shown below, is a fatty alcohol used for control of sucker growth in tobacco, at 11000-17000 g/ha. Decan-1-ol, as well as methods of preparing decan-1-ol, are known in the art. Its plant growth regulation activity is described, for example, in The Pesticide Manual, Eighteenth Edition, 2016.

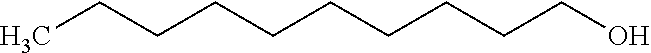

Decan-1-ol can be applied to vegetation or an area adjacent the vegetation or applied to soil or water to prevent the emergence or growth of vegetation in an amount sufficient to induce a herbicidal effect. In some aspects, decan-1-ol is applied to vegetation or an area adjacent the vegetation or applied to soil or water to prevent the emergence or growth of vegetation in an amount of 10 kg ai/ha or more, such as 10.5 kg ai/ha or more, 11 kg ai/ha or more, 11.5 kg ai/ha or more, 12 kg ai/ha or more, 12.5 kg ai/ha or more, 13 kg ai/ha or more, 13.5 kg ai/ha or more, 14 kg ai/ha or more, 14.5 kg ai/ha or more, 15 kg ai/ha or more, 15.5 kg ai/ha or more, 16 kg ai/ha or more, 16.5 kg ai/ha or more, or 16.75 kg ai/ha or more; in an amount of 17 kg ai/ha or less, such as 16.75 kg ai/ha or less, 16.5 kg ai/ha or less, 16 kg ai/ha or less, 15.5 kg ai/ha or less, 15 kg ai/ha or less, 14.5 kg ai/ha or less, 14 kg ai/ha or less, 13.5 kg ai/ha or less, 13 kg ai/ha or less, 12.5 kg ai/ha or less, 12 kg ai/ha or less, 11.5 kg ai/ha or less, 11 kg ai/ha or less, or 10.5 kg ai/ha; or in an amount ranging from any of the minimum values described above to any of the maximum values described above, such as 10-17 kg ai/ha, 11.5-16.5 kg ai/ha, 15.5-17 kg ai/ha, 11-12.5 kg ai/ha, 14-16 kg ai/ha, 11-14.5 kg ai/ha, 12-15 kg ai/ha, 13-13.5 kg ai/ha, 11.5-13 kg ai/ha, or 10.5-16.75 kg ai/ha.

Dikegulac

Compositions and methods of the present disclosure can include dikegulac or an agriculturally acceptable salt or ester thereof. Dikegulac, shown below, is a plant growth regulator used for reducing apical dominance and promotion of side-branching and flower-bud formation in azaleas, fuchsias and other ornamental plants, and to temporarily retard longitudinal growth in hedges and ornamental shrubs; also for growth retardant in trees by trunk injection. Dikegulac, as well as methods of preparing dikegulac, are known in the art. Its plant growth regulation activity is described, for example, in The Pesticide Manual, Eighteenth Edition, 2016.

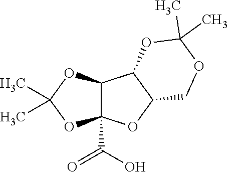

Dimethipin

Compositions and methods of the present disclosure can include dimethipin or an agriculturally acceptable salt or ester thereof. Dimethipin, shown below, is a dithiine used for: defoliation of cotton, nursery stock, rubber trees and vines, at 260-720 g/ha; destruction of potato haulm, at 480-720 g/ha; and reduction of seed moisture content at harvest in maize, rice, oilseed rape, flax and sunflowers, at 240-720 g/ha. Dimethipin, as well as methods of preparing dimethipin, are known in the art. Its plant growth regulation activity is described, for example, in The Pesticide Manual, Eighteenth Edition, 2016.

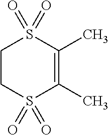

Dimexano

Compositions and methods of the present disclosure can include dimexano or an agriculturally acceptable salt or ester thereof. Dimexano, shown below, is a thiocarbamate used for: pre-emergence control of broad-leaved weeds in drilled crops, at 9000 g/ha; pre-harvest desiccant for onions and peas, at 28000 g/ha; and control of growth and splitting of carrots. Dimexano, as well as methods of preparing dimexano, are known in the art. Its plant growth regulation activity is described, for example, in The Pesticide Manual, Eighteenth Edition, 2016.

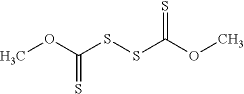

Endothall

Compositions and methods of the present disclosure can include endothall or an agriculturally acceptable salt or ester thereof. Endothall, shown below, is a bicyclocarboxylic acid used for: pre- and post-emergence control of annual grass and broad-leaved weeds in sugar beets, fodder beets, beetroot, spinach and turf, at 2000-6000 g/ha; control of algae and aquatic weeds at 1-5 ppm; desiccant for alfalfa, clover and hops; defoliant in cotton; and destruction of potato haulms. Endothall, as well as methods of preparing endothall, are known in the art. Its plant growth regulation activity is described, for example, in The Pesticide Manual, Eighteenth Edition, 2016.

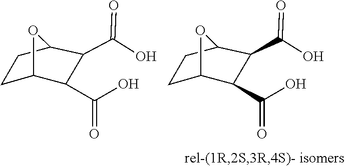

Endothall can be applied to vegetation or an area adjacent the vegetation or applied to soil or water to prevent the emergence or growth of vegetation in an amount sufficient to induce a herbicidal effect. In some aspects, endothall is applied to vegetation or an area adjacent the vegetation or applied to soil or water to prevent the emergence or growth of vegetation in an amount of 600 g ai/ha or more, such as 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3250 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, or 5750 g ai/ha or more; in an amount of 6000 g ai/ha or less, such as 5750 g ai/ha or less, 5500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3250 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1200 g ai/ha or less, 1100 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, or 625 g ai/ha or less; or in an amount ranging from any of the minimum values described above to any of the maximum values described above, such as 600-6000 g ai/ha, 950-4500 g ai/ha, 850-3750 g ai/ha, 800-2500 g ai/ha, 3250-5000 g ai/ha, 1100-4750 g ai/ha, 1900-4000 g ai/ha, 2700-5250 g ai/ha, 1800-3250 g ai/ha, 2500-4500 g ai/ha, or 625-5750 g ai/ha.

Ethephon

Compositions and methods of the present disclosure can include ethephon or an agriculturally acceptable salt or ester thereof. Ethephon, shown below, is a phosphonate used for; promotion of pre-harvest ripening in apples, currants, blackberries, blueberries, cranberries, morello cherries, citrus, figs, tomatoes, sugar beet and fodder beet seed crops, coffee and peppers; acceleration of post-harvest ripening in bananas, mangoes and citrus; loosening of fruit in currants, gooseberries, cherries and apples; increase flower bud development in apples; prevention of lodging in cereals, maize and flax; induction of flowering in Bromeliads; stimulation of lateral branching in azaleas, geraniums and roses; shortening of stem length in forced daffodils; induction of flowering and regulation of ripening in pineapples; accelerate of boll opening in cotton; modification of sex expression in cucumbers and squash; increase fruit setting and yield in cucumbers; improvement of sturdiness in onion seed crops; hasten yellowing in mature tobacco leaves; stimulation of latex flow in rubber trees and resin flow in pine trees: and stimulation of early uniform hull split in walnuts, at 2180 g/ha in cotton, 720 g/ha in cereals and 1440 g/ha in fruit. Ethephon, as well as methods of preparing ethephon, are known in the art. Its plant growth regulation activity is described, for example, in The Pesticide Manual, Eighteenth Edition, 2016.

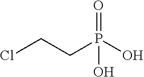

Ethephon can be applied to vegetation or an area adjacent the vegetation or applied to soil or water to prevent the emergence or growth of vegetation in an amount sufficient to induce a herbicidal effect. In some aspects, ethephon is applied to vegetation or an area adjacent the vegetation or applied to soil or water to prevent the emergence or growth of vegetation in an amount of 125 g ai/ha or more, such as 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, or 2400 g ai/ha or more; in an amount of 2500 g ai/ha or less, such as 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, or 130 g ai/ha or less; or in an amount ranging from any of the minimum values described above to any of the maximum values described above, such as 125-2500 g ai/ha, 950-2000 g ai/ha, 1200-2200 g ai/ha, 350-1500 g ai/ha, 1150-2100 g ai/ha, 700-1400 g ai/ha, 260-1100 g ai/ha, 1050-1800 g ai/ha, 1600-2500 g ai/ha, 175-400 g ai/ha, 900-1900 g ai/ha, or 150-2400 g ai/ha.

Fenoprop

Compositions and methods of the present disclosure can include fenoprop or an agriculturally acceptable salt or ester thereof. Fenoprop, shown below, is a phenoxycarboxylic acid used for postemergence brush control, at 2000-4000 g/hl spray solution; control of aquatic weeds; control of broad-leaved weeds in maize and sugar cane; and reduction of pre-harvest apple drop, at 1400 g ae/hl of amine salt spray solution 7-14 d prior to harvest. Fenoprop, as well as methods of preparing fenoprop, are known in the art. Its plant growth regulation activity is described, for example, in The Pesticide Manual, Eighteenth Edition, 2016.

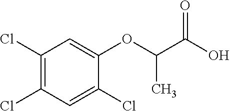

Flumetralin

Compositions and methods of the present disclosure can include flumetralin or an agriculturally acceptable salt or ester thereof. Flumetralin, shown below, is a dinitroaniline used for control of sucker growth in tobacco. Flumetralin, as well as methods of preparing flumetralin, are known in the art. Its plant growth regulation activity is described, for example, in The Pesticide Manual, Eighteenth Edition, 2016.

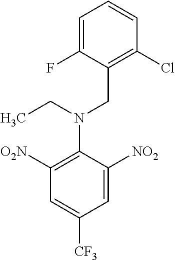 [SMILES: CCN(Cc1c(F)cccc1Cl)c1c([N+](=O)[O-])cc(C(F)(F)F)cc1[N+](=O)[O-]]

Flumetralin can be applied to vegetation or an area adjacent the vegetation or applied to soil or water to prevent the emergence or growth of vegetation in an amount sufficient to induce a herbicidal effect. In some aspects, flumetralin is applied to vegetation or an area adjacent the vegetation or applied to soil or water to prevent the emergence or growth of vegetation in an amount of 650 g ai/ha or more, such as 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, or 1300 g ai/ha or more; in an amount of 1350 g ai/ha or less, such as 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, or 675 g ai/ha or less; or in an amount ranging from any of the minimum values described above to any of the maximum values described above, such as 650-1350 g ai/ha, 850-1100 g ai/ha, 1200-1300 g ai/ha, 700-1050 g ai/ha, 750-1000 g ai/ha, 1100-1150 g ai/ha, 900-1250 g ai/ha, 650-1200 g ai/ha, 800-1000 g ai/ha, 1050-1300 g ai/ha, 700-1200 g ai/ha, or 675-1300 g ai/ha.

Flurenol

Compositions and methods of the present disclosure can include flurenol or an agriculturally acceptable salt or ester thereof. Flurenol, shown below, is a carboxylic acid used for post-emergence control of broad-leaved weeds in cereals, including wheat, barley, rye, oats, and rice. Flurenol, as well as methods of preparing flurenol, are known in the art. Its plant growth regulation activity is described, for example, in The Pesticide Manual, Eighteenth Edition, 2016.

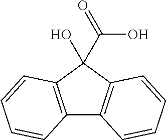 [SMILES: O=C(O)C1(O)c2ccccc2-c2ccccc21]

Flurenol can be applied to vegetation or an area adjacent the vegetation or applied to soil or water to prevent the emergence or growth of vegetation in an amount sufficient to induce a herbicidal effect. In some aspects, flurenol is applied to vegetation or an area adjacent the vegetation or applied to soil or water to prevent the emergence or growth of vegetation in an amount of 200 g ai/ha or more, such 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, or 950 g ai/ha or more; in an amount of 1000 g ai/ha or less, such as 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, or 210 g ai/ha or less; or in an amount ranging from any of the minimum values described above to any of the maximum values described above, such as 200-1000 g ai/ha, 250-650 g ai/ha, 460-750 g ai/ha, 600-900 g ai/ha, 380-500 g ai/ha, 210-450 g ai/ha, 390-480 g ai/ha, 750-950 g ai/ha, 325-525 g ai/ha, 500-750 g ai/ha, 440-800 g ai/ha, or 210-950 g ai/ha.

Flurprimidol

Compositions and methods of the present disclosure can include flurprimidol or an agriculturally acceptable salt or ester thereof. Flurprimidol, shown below, is a pyrimidine carbinol used to decrease the rate of growth of plants, including perennial turf grasses, ornamental cover species, herbaceous and woody ornamentals and deciduous and coniferous trees, at 140-1100 g/ha in turf grasses, 560-1100 g/ha in flowering and foliage plants, 1100-3400 g/ha in woody ornamentals. Flurprimidol, as well as methods of preparing flurprimidol, are known in the art. Its plant growth regulation activity is described, for example, in The Pesticide Manual, Eighteenth Edition, 2016.

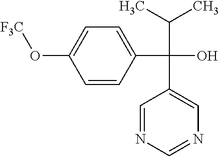 [SMILES: CC(C)C(O)(c1ccc(OC(F)(F)F)cc1)c1cncnc1]

Flurprimidol can be applied to vegetation or an area adjacent the vegetation or applied to soil or water to prevent the emergence or growth of vegetation in an amount sufficient to induce a herbicidal effect. In some aspects, flurprimidol is applied to vegetation or an area adjacent the vegetation or applied to soil or water to prevent the emergence or growth of vegetation in an amount of 125 g ai/ha or more, such as 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, or 3400 g ai/ha or more; in an amount of 3500 g ai/ha or less, such as 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, or 130 g ai/ha or less; or in an amount ranging from any of the minimum values described above to any of the maximum values described above, such as 125-3500 g ai/ha, 950-2500 g ai/ha, 460-1700 g ai/ha, 1600-2500 g ai/ha, 550-1800 g ai/ha, 210-470 g ai/ha, 1300-3300 g ai/ha, 340-2200 g ai/ha, 650-3250 g ai/ha, 1000-1400 g ai/ha, 440-2900 g ai/ha, or 130-3400 g ai/ha.

Forchlorfenuron

Compositions and methods of the present disclosure can include forchlorfenuron or an agriculturally acceptable salt or ester thereof. Forchlorfenuron, shown below, is a phenyl urea used for: increasing the size of kiwifruit, table grapes and peaches; promotion of fruit set in melons, pumpkins and cucumbers; promotion of branching in apples; increasing yields in potatoes, rice and wheat. Forchlorfenuron, as well as methods of preparing forchlorfenuron, are known in the art. Its plant growth regulation activity is described, for example, in The Pesticide Manual, Eighteenth Edition, 2016.

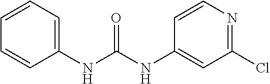 [SMILES: O=C(Nc1ccccc1)Nc1ccnc(Cl)c1]

Forchlorfenuron can be applied to vegetation or an area adjacent the vegetation or applied to soil or water to prevent the emergence or growth of vegetation in an amount sufficient to induce a herbicidal effect. In some aspects, forchlorfenuron is applied to vegetation or an area adjacent the vegetation or applied to soil or water to prevent the emergence or growth of vegetation in an amount of 4 g ai/ha or more, such as 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, 9.5 g ai/ha, or more, 10 g ai/ha or more, 12.5 g ai/ha or more, 15 g ai/ha or more, 17.5 g ai/ha or more, 20 g ai/ha or more, 22.5 g ai/ha or more, 25 g ai/ha or more, or 27.5 g ai/ha or more; in an amount of 30 g ai/ha or less, such as 27.5 g ai/ha or less, 25 g ai/ha or less, 22.5 g ai/ha or less, 20 g ai/ha or less, 17.5 g ai/ha or less, 15 g ai/ha or less, 12.5 g ai/ha or less, 10 g ai/ha or less, 9.5 g ai/ha or less, 9 g ai/ha or less, 8.5 g ai/ha or less, 8 g ai/ha or less, 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, or 4.25 g ai/ha or less; or in an amount ranging from any of the minimum values described above to any of the maximum values described above, such as 4-30 g ai/ha, 5.25-7.5 g ai/ha, 12-27.5 g ai/ha, 8.5-20 g ai/ha, 6.25-9.5 g ai/ha, 17.5-27.5 g ai/ha, 8-25 g ai/ha, 10-20 g ai/ha, 4.25-7.5 g ai/ha, 9.5-15 g ai/ha, 7-15 g ai/ha, 4-8.5 g ai/ha, or 4.25-27.5 g ai/ha.

Gibberellins

Compositions and methods of the present disclosure can include gibberellins, including gibberellic acid, gibberellin A4, and gibberellin A7, or an agriculturally acceptable salt or ester thereof. Gibberellins, shown below, are natural plant compounds used to: improve fruit setting in clementines and pears; loosen and elongate clusters and increase berry size in grapes; control fruit maturity by delaying development of the yellow color in lemons; reduce rind stain and retard rind ageing in navel oranges; promote uniform seedling growth in rice; promote elongation in winter celery; induce uniform bolting and increase seed production in lettuce; stimulate sprouting in seed potatoes; hasten maturation in artichokes; increase yields in forced rhubarb; increase malting quality in barley; produce brighter-colored, firmer fruit and increase fruit size in sweet cherries; increase yields and aid harvesting in hops; reduce internal browning and increase yields in Italian prunes; increase fruit set and yields in tangelos and tangerines; improve fruit setting in blueberries; promote flowering and increase yield in strawberries, all at up to 200 g/ha. Gibberellins, as well as methods of preparing gibberellins, are known in the art. Their plant growth regulation activity is described, for example, in The Pesticide Manual, Eighteenth Edition, 2016.

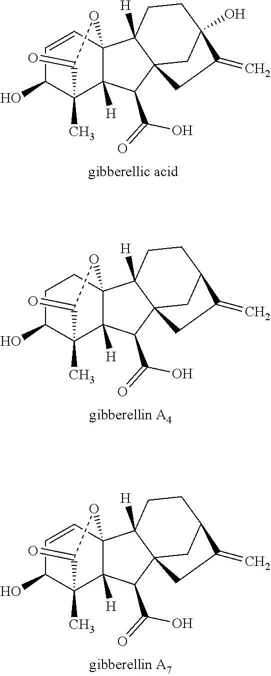

Gibberellins can be applied to vegetation or an area adjacent the vegetation or applied to soil or water to prevent the emergence or growth of vegetation in an amount sufficient to induce a herbicidal effect. In some aspects, gibberellins are applied to vegetation or an area adjacent the vegetation or applied to soil or water to prevent the emergence or growth of vegetation in an amount of 1 g ai/ha or more, such as 1.1 g ai/ha or more, 1.25 g ai/ha or more, 1.5 g ai/ha or more, 1.75 g ai/ha or more, 2 g ai/ha or more, 2.25 g ai/ha or more, 2.5 g ai/ha or more, 2.75 g ai/ha or more, 3 g ai/ha or more, 3.25 g ai/ha or more, 3.5 g ai/ha or more, 3.75 g ai/ha or more, 4 g ai/ha or more, 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, 9.5 g ai/ha, or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, or 340 g ai/ha or more; in an amount of 350 g ai/ha or less, such as 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9.5 g ai/ha or less, 9 g ai/ha or less, 8.5 g ai/ha or less, 8 g ai/ha or less, 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, 4.25 g ai/ha or less, 4 g ai/ha or less, 3.75 g ai/ha or less, 3.5 g ai/ha or less, 3.25 g ai/ha or less, 3 g ai/ha or less, 2.75 g ai/ha or less, 2.5 g ai/ha or less, 2.25 g ai/ha or less, 2 g ai/ha or less, 1.75 g ai/ha or less, 1.5 g ai/ha or less, 1.25 g ai/ha or less, or 1.1 g ai/ha or less; or in an amount ranging from any of the minimum values described above to any of the maximum values described above, such as 1-350 g ai/ha, 9.5-70 g ai/ha, 4.5-150 g ai/ha, 60-220 g ai/ha, 5-130 g ai/ha, 10-250 g ai/ha, 25-140 g ai/ha, 75-300 g ai/ha, 8-55 g ai/ha, 30-160 g ai/ha, 110-290 g ai/ha, or 1.1-340 g ai/ha.

Heptamaloxyloglucan

Compositions and methods of the present disclosure can include heptamaloxyloglucan or an agriculturally acceptable salt or ester thereof. Heptamaloxyloglucan, shown below, is a polysaccharide used as a plant elicitor for protection of grapes from spring frost damage. Heptamaloxyloglucan, as well as methods of preparing heptamaloxyloglucan, are known in the art. Its plant growth regulation activity is described, for example, in The Pesticide Manual, Eighteenth Edition, 2016.

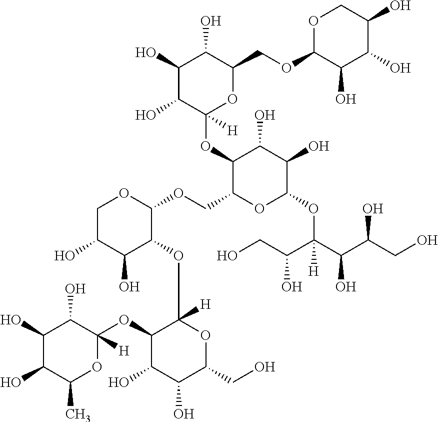 [SMILES: C[C@@H]1O[C@@H](O[C@H]2[C@H](O[C@H]3[C@@H](OC[C@H]4O[C@@H](O[C@@H]([C@H](O)[C@@H](O)CO)[C@H](O)CO)[C@H](O)[C@@H](O)[C@@H]4O[C@@H]4O[C@H](CO[C@H]5OC[C@@H](O)[C@H](O)[C@H]5O)[C@@H](O)[C@H](O)[C@H]4O)OC[C@@H](O)[C@@H]3O)O[C@H](CO)[C@H](O)[C@@H]2O)[C@@H](O)[C@H](O)[C@@H]1O]

Indol-3-Butyric Acid (IBA) and Indol-3-Ylacetic Acid (IAA)

Compositions and methods of the present disclosure can include indol-3-butyric acid (IBA), indol-3-ylacetic acid (IAA) or an agriculturally acceptable salt or ester thereof. IBA and IAA, shown below, are plant hormones used to stimulate rooting of cuttings of herbaceous and woody ornamentals. IBA and IAA, as well as methods of preparing IBA and IAA, are known in the art. Their plant growth regulation activity is described, for example, in The Pesticide Manual, Eighteenth Edition, 2016.

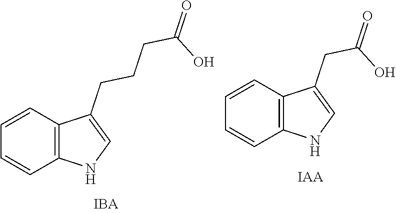

IBA or IAA can be applied to vegetation or an area adjacent the vegetation or applied to soil or water to prevent the emergence or growth of vegetation in an amount sufficient to induce a herbicidal effect. In some aspects, IBA or IAA are applied to vegetation or an area adjacent the vegetation or applied to soil or water to prevent the emergence or growth of vegetation in an amount of 50 g ai/ha or more, such as 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 105 g ai/ha or more, 110 g ai/ha or more, 115 g ai/ha or more, 120 g ai/ha or more, 125 g ai/ha or more, 130 g ai/ha or more, 135 g ai/ha or more, 140 g ai/ha or more, or 145 g ai/ha or more; in an amount of 150 g ai/ha or less, 145 g ai/ha or less, 140 g ai/ha or less, 135 g ai/ha or less, 130 g ai/ha or less, 125 g ai/ha or less, 120 g ai/ha or less, 115 g ai/ha or less, 110 g ai/ha or less, 105 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, or 55 g ai/ha or less; or in an amount ranging from any of the minimum values described above to any of the maximum values described above, such as 50-150 g ai/ha, 95-130 g ai/ha, 60-140 g ai/ha, 70-125 g ai/ha, 100-150 g ai/ha, 55-115 g ai/ha, 75-100 g ai/ha, 85-120 g ai/ha, 90-125 g ai/ha, or 55-145 g ai/ha.

Isoprothiolane

Compositions and methods of the present disclosure can include isoprothiolane or an agriculturally acceptable salt or ester thereof. Isoprothiolane, shown below, is a dithiolane used to accelerate rooting, promote root elongation, and control non-parasitic damping-off in rice. Isoprothiolane, as well as methods of preparing isoprothiolane, are known in the art. Its plant growth regulation activity is described, for example, in The Pesticide Manual, Eighteenth Edition, 2016.

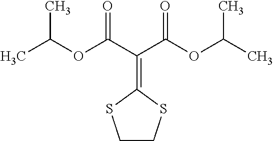 [SMILES: CC(C)OC(=O)C(C(=O)OC(C)C)=C1SCCS1]

Maleic Hydrazide

Compositions and methods of the present disclosure can include maleic hydrazide or an agriculturally acceptable salt or ester thereof. Maleic hydrazide, shown below, is a pyridazine used for: suppression of grass growth in lawns, roadside verges, embankments and amenity areas and of growth of shrubs and trees; inhibition of sprouting in potatoes, onions, beets, swedes, parsnips and carrots in storage; prevention of sucker development in tobacco; induction of dormancy in citrus, at 1200-5400 g/ha. Maleic hydrazide, as well as methods of preparing maleic hydrazide, are known in the art. Its plant growth regulation activity is described, for example, in The Pesticide Manual, Eighteenth Edition, 2016.

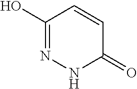

Maleic hydrazide can be applied to vegetation or an area adjacent the vegetation or applied to soil or water to prevent the emergence or growth of vegetation in an amount sufficient to induce a herbicidal effect. In some aspects, maleic hydrazide is applied to vegetation or an area adjacent the vegetation or applied to soil or water to prevent the emergence or growth of vegetation in an amount of 1000 g ai/ha or more, such as 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more; in an amount of 5500 g ai/ha or less, such as 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, or 1050 g ai/ha or less; or in an amount ranging from any of the minimum values described above to any of the maximum values described above, such as 1000-5500 g ai/ha, 1250-4500 g ai/ha, 4500-5250 g ai/ha, 1600-2500 g ai/ha, 1150-3100 g ai/ha, 1350-1700 g ai/ha, 1900-3000 g ai/ha, 2400-4250 g ai/ha, 3200-5000 g ai/ha, 1400-4000 g ai/ha, 1800-2800 g ai/ha, or 1050-5250 g ai/ha.

Mefluidide

Compositions and methods of the present disclosure can include mefluidide or an agriculturally acceptable salt or ester thereof. Mefluidide, shown below, is a sulfonanilide used for: inhibition of growth and suppression of seed production of perennial grasses in turf, lawns, grassland, industrial areas, amenity areas, roadside verges and embankments; inhibition of growth of ornamental trees and shrubs; enhancement of the sucrose content of sugar cane, at 300 to 1100 g/ha; and control of growth and seed production of weeds, particularly Sorghum halepense and volunteer cereals, in soybeans and other crops. Mefluidide, as well as methods of preparing mefluidide, are known in the art. Its plant growth regulation activity is described, for example, in The Pesticide Manual, Eighteenth Edition, 2016.

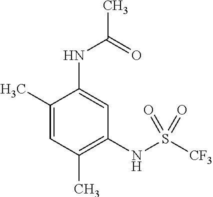 [SMILES: CC(=O)Nc1cc(NS(=O)(=O)C(F)(F)F)c(C)cc1C]

Mefluidide can be applied to vegetation or an area adjacent the vegetation or applied to soil or water to prevent the emergence or growth of vegetation in an amount sufficient to induce a herbicidal effect. In some aspects, mefluidide is applied to vegetation or an area adjacent the vegetation or applied to soil or water to prevent the emergence or growth of vegetation in an amount of 200 g ai/ha or more, such as 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, or 1200 g ai/ha or more; in an amount of 1250 g ai/ha or less, such as 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, or 210 g ai/ha or less; or in an amount ranging from any of the minimum values described above to any of the maximum values described above, such as 200-1250 g ai/ha, 250-650 g ai/ha, 460-950 g ai/ha, 300-700 g ai/ha, 370-800 g ai/ha, 210-575 g ai/ha, 290-400 g ai/ha, 750-1050 g ai/ha, 230-525 g ai/ha, 425-1100 g ai/ha, 340-850 g ai/ha, or 210-1200 g ai/ha.

Mepiquat

Compositions and methods of the present disclosure can include the mepiquat ion or an agriculturally acceptable salt thereof. Mepiquat, shown below as the chloride or pentaborate salt, is a quaternary ammonium ion used for: reduction of vegetative growth and promotion of boll maturation in cotton, at up to 75 g/ha; inhibition of sprouting in onions, garlic and leeks; prevention of lodging, by shortening the stem and strengthening the stem wall, in cereals, grass seed crops and flax, at up to 762.5 g/ha. Mepiquat, as well as methods of preparing mepiquat, are known in the art. Its plant growth regulation activity is described, for example, in The Pesticide Manual, Eighteenth Edition, 2016.

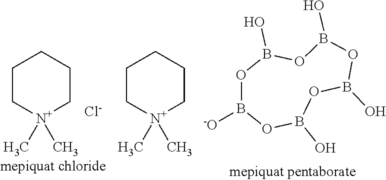

Mepiquat can be applied to vegetation or an area adjacent the vegetation or applied to soil or water to prevent the emergence or growth of vegetation in an amount sufficient to induce a herbicidal effect. In some aspects, mepiquat is applied to vegetation or an area adjacent the vegetation or applied to soil or water to prevent the emergence or growth of vegetation in an amount of 5 g ai/ha or more, such as 6 g ai/ha or more, 7 g ai/ha or more, 7.5 g ai/ha or more, 8 g ai/ha or more, 9 g ai/ha or more, 10 g ai/ha or more, 15 g ai/ha or more, 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, or 750 g ai/ha or more; in an amount of 800 g ai/ha or less, such as 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, 20 g ai/ha or less, 15 g ai/ha or less, 10 g ai/ha or less, 9 g ai/ha or less, 8 g ai/ha or less, 7.5 g ai/ha or less, 7 g ai/ha or less, or 6 g ai/ha or less; or in an amount ranging from any of the minimum values described above to any of the maximum values described above, such as 5-800 g ai/ha, 9-65 g ai/ha, 40-375 g ai/ha, 120-250 g ai/ha, 50-550 g ai/ha, 110-450 g ai/ha, 230-400 g ai/ha, 700-800 g ai/ha, 380-525 g ai/ha, 25-140 g ai/ha, 340-675 g ai/ha, or 6-750 g ai/ha.

N-Acetylthiazolidine-4-Carboxylic Acid

Compositions and methods of the present disclosure can include N-acetylthiazolidine-4-carboxylic acid or an agriculturally acceptable salt or ester thereof. N-Acetylthiazolidine-4-carboxylic acid, shown below, is a carboxylic acid used to increase size of fruit, berries and kernels, increase yield, increase vitamins and improve skin color, using a spray solution at 20-75 ppm concentration. N-Acetylthiazolidine-4-carboxylic acid, as well as methods of preparing N-acetylthiazolidine-4-carboxylic acid, are known in the art. Its plant growth regulation activity is described, for example, in The Pesticide Manual, Eighteenth Edition, 2016.

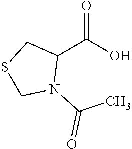

Naphthaleneacetamide

Compositions and methods of the present disclosure can include naphthaleneacetamide or an agriculturally acceptable salt or ester thereof. Naphthaleneacetamide, shown below, is an aromatic amide used to: stimulate root production at 0.1-0.6 g/plant; thin fruit in apples and pears; and prevent premature fruit fall in apples and cherries. Naphthaleneacetamide, as well as methods of preparing naphthaleneacetamide, are known in the art. Its plant growth regulation activity is described, for example, in The Pesticide Manual, Eighteenth Edition, 2016.

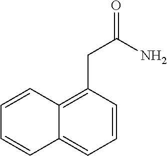 [SMILES: NC(=O)Cc1cccc2ccccc12]

Nitrophenolates

Compositions and methods of the present disclosure can include the nitrophenolate mixture (sodium 5-nitroguaiacolate, sodium o-nitrophenolate, and sodium p-nitrophenolate) or an agriculturally acceptable salt or ester thereof. Nitrophenolates, shown below, are a mixture of phenolate salts used to increase nutrient uptake in cotton, cereals, cucumbers, grapes, melons, paprika, rice, soybeans, sugar beets and vegetables, at 3-6 g/ha. Nitrophenolates, as well as methods of preparing nitrophenolates, are known in the art. Its plant growth regulation activity is described, for example, in The Pesticide Manual, Eighteenth Edition, 2016.

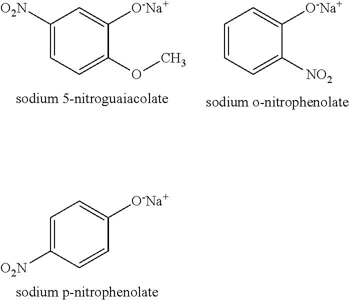

Nitrophenolates can be applied to vegetation or an area adjacent the vegetation or applied to soil or water to prevent the emergence or growth of vegetation in an amount sufficient to induce a herbicidal effect. In some aspects, nitrophenolates are applied to vegetation or an area adjacent the vegetation or applied to soil or water to prevent the emergence or growth of vegetation in an amount of 1 g ai/ha or more, such as 1.1 g ai/ha or more, 1.25 g ai/ha or more, 1.5 g ai/ha or more, 1.75 g ai/ha or more, 2 g ai/ha or more, 2.25 g ai/ha or more, 2.5 g ai/ha or more, 2.75 g ai/ha or more, 3 g ai/ha or more, 3.25 g ai/ha or more, 3.5 g ai/ha or more, 3.75 g ai/ha or more, 4 g ai/ha or more, 4.25 g ai/ha or more, 4.5 g ai/ha or more, 4.75 g ai/ha or more, 5 g ai/ha or more, 5.25 g ai/ha or more, 5.5 g ai/ha or more, 5.75 g ai/ha or more, 6 g ai/ha or more, 6.25 g ai/ha or more, 6.5 g ai/ha or more, 6.75 g ai/ha or more, 7 g ai/ha or more, 7.25 g ai/ha or more, 7.5 g ai/ha or more, 8 g ai/ha or more, 8.5 g ai/ha or more, 9 g ai/ha or more, or 9.5 g ai/ha, or more; in an amount of 10 g ai/ha or less, 9.5 g ai/ha or less, 9 g ai/ha or less, 8.5 g ai/ha or less, 8 g ai/ha or less, 7.5 g ai/ha or less, 7.25 g ai/ha or less, 7 g ai/ha or less, 6.75 g ai/ha or less, 6.5 g ai/ha or less, 6.25 g ai/ha or less, 6 g ai/ha or less, 5.75 g ai/ha or less, 5.5 g ai/ha or less, 5.25 g ai/ha or less, 5 g ai/ha or less, 4.75 g ai/ha or less, 4.5 g ai/ha or less, 4.25 g ai/ha or less, 4 g ai/ha or less, 3.75 g ai/ha or less, 3.5 g ai/ha or less, 3.25 g ai/ha or less, 3 g ai/ha or less, 2.75 g ai/ha or less, 2.5 g ai/ha or less, 2.25 g ai/ha or less, 2 g ai/ha or less, 1.75 g ai/ha or less, 1.5 g ai/ha or less, 1.25 g ai/ha or less, or 1.1 g ai/ha or less; or in an amount ranging from any of the minimum values described above to any of the maximum values described above, such as 1-10 g ai/ha, 2.25-7 g ai/ha, 4.5-6.5 g ai/ha, 1.75-6 g ai/ha, 3-9 g ai/ha, 5.25-8.5 g ai/ha, 1.5-4.5 g ai/ha, 1-4 g ai/ha, 1.75-7.25 g ai/ha, 1.5-5.75 g ai/ha, 2-3.75 g ai/ha, 2.25-10 g ai/ha, 3-8.5 g ai/ha, or 1.1-9.5 g ai/ha.

Paclobutrazol

Compositions and methods of the present disclosure can include paclobutrazol or an agriculturally acceptable salt or ester thereof. Paclobutrazol, shown below, is triazole used for: inhibition of vegetative growth and enhancement of fruit set in tree fruit; inhibition of growth in pot-grown ornamentals and flowers, e.g. chrysanthemums, begonias, freesias, poinsettias and bulbs, as a spray at a concentration of 1-200 ppm; prevent lodging and increase yield in rice; growth retardation in turf and reduction of height and prevention of lodging in grass seed crops and oilseed rape. Paclobutrazol, as well as methods of preparing paclobutrazol, are known in the art. Its plant growth regulation activity is described, for example, in The Pesticide Manual, Eighteenth Edition, 2016.

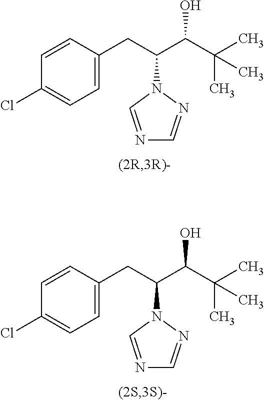 [SMILES: CC(C)(C)[C@@H](O)[C@@H](Cc1ccc(Cl)cc1)n1cncn1 ; CC(C)(C)[C@H](O)[C@H](Cc1ccc(Cl)cc1)n1cncn1]

Paclobutrazol can be applied to vegetation or an area adjacent the vegetation or applied to soil or water to prevent the emergence or growth of vegetation in an amount sufficient to induce a herbicidal effect. In some aspects, paclobutrazol is applied to vegetation or an area adjacent the vegetation or applied to soil or water to prevent the emergence or growth of vegetation in an amount of 40 g ai/ha or more, such as 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, 675 g ai/ha or more, 700 g ai/ha or more, 750 g ai/ha or more, 800 g ai/ha or more, 850 g ai/ha or more, 900 g ai/ha or more, or 950 g ai/ha or more; in an amount of 1000 g ai/ha or less, such as 950 g ai/ha or less, 900 g ai/ha or less, 850 g ai/ha or less, 800 g ai/ha or less, 750 g ai/ha or less, 700 g ai/ha or less, 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, or 45 g ai/ha or less; or in an amount ranging from any of the minimum values described above to any of the maximum values described above, such as 40-1000 g ai/ha, 95-650 g ai/ha, 460-750 g ai/ha, 80-250 g ai/ha, 50-850 g ai/ha, 110-450 g ai/ha, 230-400 g ai/ha, 750-1000 g ai/ha, 380-525 g ai/ha, 320-600 g ai/ha, 65-290 g ai/ha, or 45-950 g ai/ha.

Pelargonic Acid

Compositions and methods of the present disclosure can include pelargonic acid or an agriculturally acceptable salt or ester thereof. Pelargonic acid, shown below, is fatty acid used for: thinning of blossoms in apples and pears; control of annual weeds in potatoes and peanuts; total weed control in non-crop areas; control of mosses in lawns and other domestic areas. Pelargonic acid, as well as methods of preparing pelargonic acid, are known in the art. Its plant growth regulation activity is described, for example, in The Pesticide Manual, Eighteenth Edition, 2016.

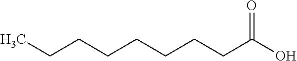

Pelargonic acid can be applied to vegetation or an area adjacent the vegetation or applied to soil or water to prevent the emergence or growth of vegetation in an amount sufficient to induce a herbicidal effect. In some aspects, pelargonic acid is applied to vegetation or an area adjacent the vegetation or applied to soil or water to prevent the emergence or growth of vegetation in an amount of 750 g ai/ha or more, such as 800 g ai/ha or more, 850 g ai/ha or more, 900 g ai/ha or more, 950 g ai/ha or more, 1000 g ai/ha or more, 1050 g ai/ha or more, 1100 g ai/ha or more, 1150 g ai/ha or more, 1200 g ai/ha or more, 1250 g ai/ha or more, 1300 g ai/ha or more, 1350 g ai/ha or more, 1400 g ai/ha or more, 1450 g ai/ha or more, 1500 g ai/ha or more, 1600 g ai/ha or more, 1700 g ai/ha or more, 1800 g ai/ha or more, 1900 g ai/ha or more, 2000 g ai/ha or more, 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, 5750 g ai/ha or more, 6000 g ai/ha or more, 6250 g ai/ha or more, 6500 g ai/ha or more, 6750 g ai/ha or more, 7000 g ai/ha or more, 7250 g ai/ha or more, 7500 g ai/ha or more, 7750 g ai/ha or more, 8000 g ai/ha or more, 8250 g ai/ha or more, 8500 g ai/ha or more, 8750 g ai/ha or more, 9000 g ai/ha or more, 9250 g ai/ha or more, 9500 g ai/ha or more, 9750 g ai/ha or more, 10 kg ai/ha or more, 10.5 kg ai/ha or more, 11 kg ai/ha or more, 11.5 kg ai/ha or more, 12k g ai/ha or more, 12.5 kg ai/ha or more, 13 kg ai/ha or more, 13.5 kg ai/ha or more, 14 kg ai/ha or more, or 14.5 kg ai/ha or more; in an amount of 15 kg ai/ha or less, such as 14.5k g ai/ha or less, 14 kg ai/ha or less, 13.5 kg ai/ha or less, 13 kg ai/ha or less, 12.5 kg ai/ha or less, 12 kg ai/ha or less, 11.5 kg ai/ha or less, 11 kg ai/ha or less, 10.5 kg ai/ha, 10 kg ai/ha or less, 9750 g ai/ha or less, 9500 g ai/ha or less, 9250 g ai/ha or less, 9000 g ai/ha or less, 8750 g ai/ha or less, 8500 g ai/ha or less, 8250 g ai/ha or less, 8000 g ai/ha or less, 7750 g ai/ha or less, 7500 g ai/ha or less, 7250 g ai/ha or less, 7000 g ai/ha or less, 6750 g ai/ha or less, 6500 g ai/ha or less, 6250 g ai/ha or less, 6000 g ai/ha or less, 5750 g ai/ha or less, 5500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, 2100 g ai/ha or less, 2000 g ai/ha or less, 1900 g ai/ha or less, 1800 g ai/ha or less, 1700 g ai/ha or less, 1600 g ai/ha or less, 1500 g ai/ha or less, 1400 g ai/ha or less, 1350 g ai/ha or less, 1300 g ai/ha or less, 1250 g ai/ha or less, 1200 g ai/ha or less, 1150 g ai/ha or less, 1100 g ai/ha or less, 1050 g ai/ha or less, 1000 g ai/ha or less, 950 g ai/ha or less, 900 g ai/ha or less, 850 g ai/ha or less, or 800 g ai/ha or less; or in an amount ranging from any of the minimum values described above to any of the maximum values described above, such as 750 g-15 kg ai/ha, 950-6500 g ai/ha, 4000-9750 g ai/ha, 10-14 kg ai/ha, 3500 g-12.5 kg ai/ha, 11-12.5 kg ai/ha, 9500 g-15 kg ai/ha, 4750-8750 g ai/ha, 6500-9250 g ai/ha, 5000 g-14 kg ai/ha, 10.5-13.5 kg ai/ha, or 800 g-14.5 kg ai/ha.

Prohexadione

Compositions and methods of the present disclosure can include prohexadione or an agriculturally acceptable salt or ester thereof, particularly the calcium salt. Prohexadione, shown below, is fatty acid used for: control of lodging in small-grain cereals, at 75-100 g/ha; growth retardant in turf, at 200-400 g/ha, peanuts, at 100-300 g/ha, and flowers, at 50-100 g/ha; inhibition of new twig elongation in tree fruit, at 200-400 g/ha. Prohexadione, as well as methods of preparing prohexadione, are known in the art. Its plant growth regulation activity is described, for example, in The Pesticide Manual, Eighteenth Edition, 2016.

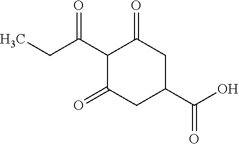

Prohexadione can be applied to vegetation or an area adjacent the vegetation or applied to soil or water to prevent the emergence or growth of vegetation in an amount sufficient to induce a herbicidal effect. In some aspects, prohexadione is applied to vegetation or an area adjacent the vegetation or applied to soil or water to prevent the emergence or growth of vegetation in an amount of 15 g ai/ha or more, such as 20 g ai/ha or more, 25 g ai/ha or more, 30 g ai/ha or more, 35 g ai/ha or more, 40 g ai/ha or more, 45 g ai/ha or more, 50 g ai/ha or more, 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, 575 g ai/ha or more, 600 g ai/ha or more, 625 g ai/ha or more, 650 g ai/ha or more, or 675 g ai/ha or more; in an amount of 700 g ai/ha or less, such as 675 g ai/ha or less, 650 g ai/ha or less, 625 g ai/ha or less, 600 g ai/ha or less, 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, 55 g ai/ha or less, 50 g ai/ha or less, 45 g ai/ha or less, 40 g ai/ha or less, 35 g ai/ha or less, 30 g ai/ha or less, 25 g ai/ha or less, or 20 g ai/ha or less; or in an amount ranging from any of the minimum values described above to any of the maximum values described above, such as 15-700 g ai/ha, 45-650 g ai/ha, 30-375 g ai/ha, 160-250 g ai/ha, 220-550 g ai/ha, 110-450 g ai/ha, 290-490 g ai/ha, 70-430 g ai/ha, 300-525 g ai/ha, 500-650 g ai/ha, 340-575 g ai/ha, or 20-675 g ai/ha.

Prohydrojasmon

Compositions and methods of the present disclosure can include prohydrojasmon or an agriculturally acceptable salt or ester thereof. Prohydrojasmon, shown below, is a synthetic plant hormone used for: prevention of rind puffing in Satsuma mandarin oranges and promotion of red color development in apples. Prohydrojasmon, as well as methods of preparing prohydrojasmon, are known in the art. Its plant growth regulation activity is described, for example, in The Pesticide Manual, Eighteenth Edition, 2016.

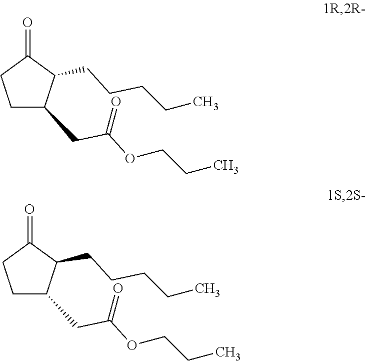 [SMILES: CCCCC[C@H]1C(=O)CC[C@@H]1CC(=O)OCCC ; CCCCC[C@@H]1C(=O)CC[C@H]1CC(=O)OCCC]

Propham

Compositions and methods of the present disclosure can include propham or an agriculturally acceptable salt or ester thereof. Propham, shown below, is a carbamate used for control of annual grass and some broad-leaved weeds in alfalfa, clover, sugar beets, spinach, lettuce, peas, beans, flax, safflowers, beetroot, fodder beets, lettuce, chard, lentils and perennial grass seed crops, at 2300-5000 g/ha, and as a sprouting inhibitor in potatoes. Propham, as well as methods of preparing propham, are known in the art. Its plant growth regulation activity is described, for example, in The Pesticide Manual, Eighteenth Edition, 2016.

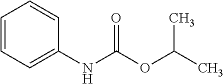

Propham can be applied to vegetation or an area adjacent the vegetation or applied to soil or water to prevent the emergence or growth of vegetation in an amount sufficient to induce a herbicidal effect. In some aspects, propham is applied to vegetation or an area adjacent the vegetation or applied to soil or water to prevent the emergence or growth of vegetation in an amount of 2000 g ai/ha or more, such as 2100 g ai/ha or more, 2200 g ai/ha or more, 2300 g ai/ha or more, 2400 g ai/ha or more, 2500 g ai/ha or more, 2600 g ai/ha or more, 2700 g ai/ha or more, 2800 g ai/ha or more, 2900 g ai/ha or more, 3000 g ai/ha or more, 3100 g ai/ha or more, 3200 g ai/ha or more, 3250 g ai/ha or more, 3300 g ai/ha or more, 3400 g ai/ha or more, 3500 g ai/ha or more, 3750 g ai/ha or more, 4000 g ai/ha or more, 4250 g ai/ha or more, 4500 g ai/ha or more, 4750 g ai/ha or more, 5000 g ai/ha or more, 5250 g ai/ha or more, 5500 g ai/ha or more, 5750 g ai/ha or more, 6000 g ai/ha or more, 6250 g ai/ha or more, 6500 g ai/ha or more, or 6750 g ai/ha or more; in an amount of 7000 g ai/ha or less, such as 6750 g ai/ha or less, 6500 g ai/ha or less, 6250 g ai/ha or less, 6000 g ai/ha or less, 5750 g ai/ha or less, 5500 g ai/ha or less, 5250 g ai/ha or less, 5000 g ai/ha or less, 4750 g ai/ha or less, 4500 g ai/ha or less, 4250 g ai/ha or less, 4000 g ai/ha or less, 3750 g ai/ha or less, 3500 g ai/ha or less, 3400 g ai/ha or less, 3300 g ai/ha or less, 3250 g ai/ha or less, 3200 g ai/ha or less, 3100 g ai/ha or less, 3000 g ai/ha or less, 2900 g ai/ha or less, 2800 g ai/ha or less, 2700 g ai/ha or less, 2600 g ai/ha or less, 2500 g ai/ha or less, 2400 g ai/ha or less, 2300 g ai/ha or less, 2200 g ai/ha or less, or 2100 g ai/ha or less; or in an amount ranging from any of the minimum values described above to any of the maximum values described above, such as 2000-7000 g ai/ha, 4750-6500 g ai/ha, 2300-3750 g ai/ha, 4000-6000 g ai/ha, 2700-5000 g ai/ha, 3100-4750 g ai/ha, 2500-4000 g ai/ha, 5750-7000 g ai/ha, 3300-5250 g ai/ha, 2000-4500 g ai/ha, 2900-5500 g ai/ha, or 2100-6750 g ai/ha.

Sintofen

Compositions and methods of the present disclosure can include sintofen or an agriculturally acceptable salt or ester thereof. Sintofen, shown below, is a carboxylic acid used for sterilizing spring and winter wheat for use in hybridization, at 800 g/ha. Sintofen, as well as methods of preparing sintofen, are known in the art. Its plant growth regulation activity is described, for example, in The Pesticide Manual, Eighteenth Edition, 2016.

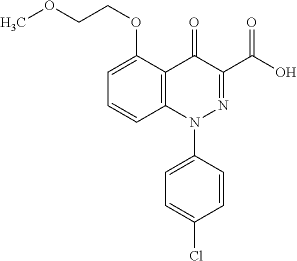 [SMILES: COCCOc1cccc2c1c(=O)c(C(=O)O)nn2-c1ccc(Cl)cc1]

Thidiazuron

Compositions and methods of the present disclosure can include thidiazuron or an agriculturally acceptable salt or ester thereof. Thidiazuron, shown below, is a carboxylic acid used for defoliation of cotton, at 210 g/ha. Thidiazuron, as well as methods of preparing thidiazuron, are known in the art. Its plant growth regulation activity is described, for example, in The Pesticide Manual, Eighteenth Edition, 2016.

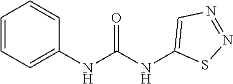 [SMILES: O=C(Nc1ccccc1)Nc1cnns1]

Thidiazuron can be applied to vegetation or an area adjacent the vegetation or applied to soil or water to prevent the emergence or growth of vegetation in an amount sufficient to induce a herbicidal effect. In some aspects, thidiazuron is applied to vegetation or an area adjacent the vegetation or applied to soil or water to prevent the emergence or growth of vegetation in an amount of 50 g ai/ha or more, such as 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, or 340 g ai/ha or more; in an amount of 350 g ai/ha or less, such as 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, or 55 g ai/ha or less; or in an amount ranging from any of the minimum values described above to any of the maximum values described above, such as 50-350 g ai/ha, 125-330 g ai/ha, 60-300 g ai/ha, 70-250 g ai/ha, 250-340 g ai/ha, 130-190 g ai/ha, 90-240 g ai/ha, 75-220 g ai/ha, 80-325 g ai/ha, 160-200 g ai/ha, 50-240 g ai/ha, or 55-340 g ai/ha.

Triacontanol

Compositions and methods of the present disclosure can include triacontanol or an agriculturally acceptable salt or ester thereof. Triacontanol, shown below, is a fatty alcohol used to increase the yields in cotton, potato, chilis, tomatoes, rice, grains and peanuts, and to increase the dry matter content, plant height, root spread and uniform, early maturity in crops. Triacontanol, as well as methods of preparing triacontanol, are known in the art. Its plant growth regulation activity is described, for example, in The Pesticide Manual, Eighteenth Edition, 2016.

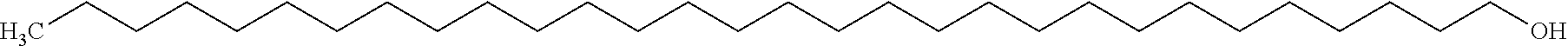 [SMILES: CCCCCCCCCCCCCCCCCCCCCCCCCCCCCCO]

Trinexapac

Compositions and methods of the present disclosure can include trinexapac or an agriculturally acceptable salt or ester thereof. Trinexapac, shown below, is a cyclohexanedione used to: prevent lodging in cereals and winter oilseed rape, at 100-300 g/ha; retard growth in turf, at 150-500 g/ha; and promote maturation in sugar cane, at 100-250 g/ha. Trinexapac, as well as methods of preparing trinexapac, are known in the art. Its plant growth regulation activity is described, for example, in The Pesticide Manual, Eighteenth Edition, 2016.

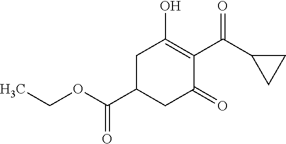 [SMILES: CCOC(=O)C1CC(=O)C(C(=O)C2CC2)=C(O)C1]

Trinexapac can be applied to vegetation or an area adjacent the vegetation or applied to soil or water to prevent the emergence or growth of vegetation in an amount sufficient to induce a herbicidal effect. In some aspects, trinexapac is applied to vegetation or an area adjacent the vegetation or applied to soil or water to prevent the emergence or growth of vegetation in an amount of 50 g ai/ha or more, such as 55 g ai/ha or more, 60 g ai/ha or more, 65 g ai/ha or more, 70 g ai/ha or more, 75 g ai/ha or more, 80 g ai/ha or more, 85 g ai/ha or more, 90 g ai/ha or more, 95 g ai/ha or more, 100 g ai/ha or more, 110 g ai/ha or more, 120 g ai/ha or more, 125 g ai/ha or more, 130 g ai/ha or more, 140 g ai/ha or more, 150 g ai/ha or more, 160 g ai/ha or more, 170 g ai/ha or more, 175 g ai/ha or more, 180 g ai/ha or more, 190 g ai/ha or more, 200 g ai/ha or more, 210 g ai/ha or more, 220 g ai/ha or more, 225 g ai/ha or more, 230 g ai/ha or more, 240 g ai/ha or more, 250 g ai/ha or more, 260 g ai/ha or more, 270 g ai/ha or more, 275 g ai/ha or more, 280 g ai/ha or more, 290 g ai/ha or more, 300 g ai/ha or more, 310 g ai/ha or more, 320 g ai/ha or more, 325 g ai/ha or more, 330 g ai/ha or more, 340 g ai/ha or more, 350 g ai/ha or more, 360 g ai/ha or more, 370 g ai/ha or more, 375 g ai/ha or more, 380 g ai/ha or more, 390 g ai/ha or more, 400 g ai/ha or more, 410 g ai/ha or more, 420 g ai/ha or more, 425 g ai/ha or more, 430 g ai/ha or more, 440 g ai/ha or more, 450 g ai/ha or more, 460 g ai/ha or more, 470 g ai/ha or more, 475 g ai/ha or more, 480 g ai/ha or more, 490 g ai/ha or more, 500 g ai/ha or more, 525 g ai/ha or more, 550 g ai/ha or more, or 575 g ai/ha or more; in an amount of 600 g ai/ha or less, such as 575 g ai/ha or less, 550 g ai/ha or less, 525 g ai/ha or less, 500 g ai/ha or less, 490 g ai/ha or less, 480 g ai/ha or less, 475 g ai/ha or less, 470 g ai/ha or less, 460 g ai/ha or less, 450 g ai/ha or less, 440 g ai/ha or less, 430 g ai/ha or less, 425 g ai/ha or less, 420 g ai/ha or less, 410 g ai/ha or less, 400 g ai/ha or less, 390 g ai/ha or less, 380 g ai/ha or less, 375 g ai/ha or less, 370 g ai/ha or less, 360 g ai/ha or less, 350 g ai/ha or less, 340 g ai/ha or less, 330 g ai/ha or less, 325 g ai/ha or less, 320 g ai/ha or less, 310 g ai/ha or less, 300 g ai/ha or less, 290 g ai/ha or less, 280 g ai/ha or less, 275 g ai/ha or less, 270 g ai/ha or less, 260 g ai/ha or less, 250 g ai/ha or less, 240 g ai/ha or less, 230 g ai/ha or less, 225 g ai/ha or less, 220 g ai/ha or less, 210 g ai/ha or less, 200 g ai/ha or less, 190 g ai/ha or less, 180 g ai/ha or less, 175 g ai/ha or less, 170 g ai/ha or less, 160 g ai/ha or less, 150 g ai/ha or less, 140 g ai/ha or less, 130 g ai/ha or less, 125 g ai/ha or less, 120 g ai/ha or less, 110 g ai/ha or less, 100 g ai/ha or less, 95 g ai/ha or less, 90 g ai/ha or less, 85 g ai/ha or less, 80 g ai/ha or less, 75 g ai/ha or less, 70 g ai/ha or less, 65 g ai/ha or less, 60 g ai/ha or less, or 55 g ai/ha or less; or in an amount ranging from any of the minimum values described above to any of the maximum values described above, such as 50-600 g ai/ha, 75-500 g ai/ha, 160-375 g ai/ha, 240-500 g ai/ha, 150-370 g ai/ha, 120-450 g ai/ha, 190-400 g ai/ha, 60-220 g ai/ha, 380-525 g ai/ha, 225-420 g ai/ha, 400-550 g ai/ha, or 55-575 g ai/ha.

Uniconazole

Compositions and methods of the present disclosure can include uniconazole or an agriculturally acceptable salt or ester thereof. Uniconazole, shown below, is a triazole used to: reduce lodging in rice; reduce vegetative growth and increase flowering in ornamentals, at a spray concentration of 0.5-50 ppm; and reduce vegetative growth in trees. Uniconazole-P is an optically active form of uniconazole. Uniconazole, as well as methods of preparing uniconazole, are known in the art. Its plant growth regulation activity is described, for example, in The Pesticide Manual, Eighteenth Edition, 2016.

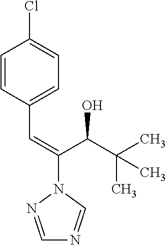 [SMILES: CC(C)(C)[C@H](O)/C(=C\c1ccc(Cl)cc1)n1cncn1]

### IV. Compositions

A composition comprising (a) a pyridine carboxylate herbicide or an agriculturally acceptable N-oxide, salt, or ester thereof may be mixed with or applied in combination with (b) a plant growth regulator (PGR), an agriculturally acceptable salt or ester thereof, or mixtures thereof.

In some aspects, (a) and (b) are used in an amount sufficient to induce an unexpectedly enhanced herbicidal effect (e.g., increased damage or injury to undesirable vegetation) while still showing good crop compatibility (e.g., no increased damage to crops or minimal increased damage or injury to crops) when compared to the individual application of the herbicidal compounds (a) or (b). In some aspects, the damage or injury to undesirable vegetation caused by the compositions and methods disclosed herein is evaluated using a scale from 0% to 100%, when compared with the untreated control vegetation, wherein 0% indicates no damage to the undesirable vegetation and 100% indicates complete destruction of the undesirable vegetation.

In some aspects, the joint action of (a) the pyridine carboxylate herbicide or an agriculturally acceptable N-oxide, salt, or ester thereof and (b) the PGR, an agriculturally acceptable salt or ester thereof, or mixtures thereof results in unexpectedly enhanced herbicidal effect against undesirable vegetation, even at application rates below those typically used for the herbicide to have a herbicidal effect on its own. In some aspects, the compositions and methods disclosed herein can, based on the individual components, be used at lower application rates to achieve a herbicidal effect comparable to the effect produced by the individual components at normal application rates.

In some aspects, the weight ratio of (a) the pyridine carboxylate herbicide or an agriculturally acceptable N-oxide, salt, or ester thereof (in g ae/ha) to (b) the PGR, an agriculturally acceptable salt or ester thereof, or mixtures thereof (in g ai/ha) is 1:7500 or more, such as 1:7000 or more, 1:6000 or more, 1:5000 or more, 1:4000 or more, 1:3000 or more, 1:2500 or more, 1:2000 or more, 1:1500 or more, 1:1000 or more, 1:900 or more, 1:800 or more, 1:700 or more, 1:600 or more, 1:500 or more, 1:400 or more, 1:300 or more, 1:250 or more, 1:200 or more, 1:150 or more, 1:100 or more, 1:90 or more, 1:80 or more, 1:75 or more, 1:70 or more, 1:60 or more, 1:50 or more, 1:40 or more, 1:35 or more, 1:30 or more, 1:28 or more, 1:26 or more, 1:25 or more, 1:24 or more, 1:22 or more, 1:21 or more, 1:20 or more, 1:18 or more, 1:16 or more, 1:15 or more, 1:14 or more, 1:12 or more, 1:10 or more, 1:9 or more, 1:8 or more, 1:7 or more, 1:6 or more, 1:5 or more, 1:4 or more, 1:3 or more, 1:2 or more, 1:1.9 or more, 1:1.8 or more, 1:1.7 or more, 1:1.6 or more, 1:1.5 or more, 1:1.4 or more, 1:1.3 or more, 1:1.2 or more, 1:1.1 or more, 1:1 or more, 1.1:1 or more, 1.25:1 or more, 1.5:1 or more, 1.75:1 or more, 2:1 or more, 2.5:1 or more, 3:1 or more, 3.5:1 or more, 4:1 or more, 4.5:1 or more, 5:1 or more, 6:1 or more, 7:1 or more, 8:1 or more, 9:1 or more, 10:1 or more, 11:1 or more, 12:1 or more, 13:1 or more, or 14:1 or more; in some aspects, the weight ratio of (a) to (b) is 15:1 or less, such as 14:1 or less, 13:1 or less, 12:1 or less, 11:1 or less, 10:1 or less, 9:1 or less, 8:1 or less, 7:1 or less, 6:1 or less, 5:1 or less, 4.5:1 or less, 4:1 or less, 3.5:1 or less, 3:1 or less, 2.5:1 or less, 2:1 or less, 1.75:1 or less, 1.5:1 or less, 1.25:1 or less, 1.1:1 or less, 1:1 or less, 1:1.1 or less, 1:1.2 or less, 1:1.3 or less, 1:1.4 or less, 1:1.5 or less, 1:1.6 or less, 1:1.7 or less, 1:1.8 or less, 1:1.9 or less, 1:2 or less, 1:3 or less, 1:4 or less, 1:5 or less, 1:6 or less, 1:7 or less, 1:8 or less, 1:9 or less, 1:10 or less, 1:12 or less, 1:14 or less, 1:15 or less, 1:16 or less, 1:18 or less, 1:20 or less, 1:21 or less, 1:22 or less, 1:24 or less, 1:25 or less, 1:26 or less, 1:28 or less, 1:30 or less, 1:35 or less, 1:40 or less, 1:50 or less, 1:60 or less, 1:70 or less, 1:80 or less, 1:90 or less, 1:100 or less, 1:150 or less, 1:200 or less, 1:250 or less, 1:300 or less, 1:400 or less, 1:500 or less, 1:600 or less, 1:700 or less, 1:800 or less, 1:900 or less, 1:1000 or less, 1:1500 or less, 1:2000 or less, 1:2500 or less, 1:3000 or less, 1:4000 or less, 1:5000 or less, 1:6000 or less, or 1:7000 or less; or the weight ratio of (a) to (b) can range from any of the minimum ratios to any of the maximum ratios provided above, such as from 1:7500 to 15:1, from 1:6000 to 13:1, from 1:4000 to 11:1, from 1:1250 to 9:1, from 1:1500 to 1:50, from 1:20 to 8:1, from 1:8 to 2:1, or from 1:5 to 1:1.

In some aspects, the active ingredients in the compositions disclosed herein consist of (a) a pyridine carboxylate herbicide or an agriculturally acceptable N-oxide, salt, or ester thereof and (b) a PGR, an agriculturally acceptable salt or ester thereof, or mixtures thereof. In some aspects, the composition may include other components, such as safeners or adjuvants, but does not include a herbicidal active ingredient in addition to (a) and (b). In some aspects, the compositions may exclude one or more herbicidal active ingredients specified above. In some aspects, the compositions may include one or more herbicidal active ingredients in addition to (a) and (b), but may exclude one or more herbicidal ingredients specified above.

In some aspects, (a) and (b), independently, can be employed in a purity of from 90% to 100% (e.g., from 95% to 100%) according to nuclear magnetic resonance (NMR) spectroscopy.

### V. Formulations

The present disclosure also includes formulations of the compositions and methods disclosed herein.

A. Additives

The compositions and methods disclosed herein can also be mixed with or applied with an additive. In some aspects, the additive is added sequentially. In some aspects, the additive is added simultaneously. In some aspects, the additive is premixed with the pyridine carboxylate herbicide or agriculturally acceptable N-oxide, salt, or ester thereof.

1. Other Pesticides

Some aspects of the described herbicidal compositions includes adding one or more additional pesticide active ingredients to the herbicidal compositions. These pesticide active ingredients may include one or more of an herbicide, an insecticide, a fungicide, a nematocide, a miticide, a arthropodicide, a bactericide, a plant growth regulator, or combinations thereof that are compatible with the compositions of the present disclosure.

In some aspects, the additive is an additional herbicide. For example, the compositions described herein can be applied in conjunction with one or more additional herbicides to control undesirable vegetation. The composition can be formulated with the one or more additional herbicides, tank mixed with the one or more additional herbicides, or applied sequentially with the one or more additional herbicides. Exemplary additional herbicides include, but are not limited to: 4-CPA; 4-CPB; 4-CPP; 2;4-D; 2;4-D choline salt; 2,4-D salts, esters and amines; 2,4-DB; 3,4-DA; 3,4-DB; 2,4-DEB; 2,4-DEP; 2,4-DP; 3,4-DP; 2,3,6-TBA; 2,4,5-T; 2,4,5-TB; acetochlor; acifluorfen; aclonifen; acrolein; alachlor; allidochlor; alloxydim; allyl alcohol; alorac; ametridione; ametryne; amibuzin; amicarbazone; amidosulfuron; aminocyclopyrachlor; 4-aminopicolinic acid based herbicides, such as halauxifen, halauxifen-methyl, florpyrauxifen, and those described in U.S. Pat. Nos. 7,314,849 and 7,432,227 to Balko, et al.; aminopyralid; amiprofos-methyl; amitrole; ammonium sulfamate; anilofos; anisuron; asulam; atraton; atrazine; azafenidin; azimsulfuron; aziprotryne; barban; BCPC; beflubutamid; benazolin; bencarbazone; benfluralin; benfuresate; bensulide; bensulfuron; benthiocarb; bentazone; benzadox; benzfendizone; benzipram; benzobicyclon; benzofenap; benzofluor; benzoylprop; benzthiazuron; bilanafos; bicyclopyrone; bifenox; bilanafos; bispyribac; borax; bromacil; bromobonil; bromobutide; bromofenoxim; bromoxynil; brompyrazon; butachlor; butafenacil; butamifos; butenachlor; buthidazole; buthiuron; butralin; butroxydim; buturon; butylate; cacodylic acid; cafenstrole; calcium chlorate; calcium cyanamide; cambendichlor; carbasulam; carbetamide; carboxazole; chlorprocarb; carfentrazone-ethyl; CDEA; CEPC; chlomethoxyfen; chloramben; chloranocryl; chlorazifop; chlorazine; chlorobromuron; chlorbufam; chloreturon; chlorfenac; chlorfenprop; chlorflurazole; chlorflurenol; chloridazon; chlorimuron; chlomitrofen; chloropon; chlorotoluron; chloroxuron; chloroxynil; chlorpropham; chlorsulfuron; chlorthal; chlorthiamid; cinidon-ethyl; cinmethylin; cinosulfuron; cisanilide; clacyfos; clethodim; cliodinate; clodinafop-propargyl; clofop; clomazone; clomeprop; cloprop; cloproxydim; clopyralid; cloransulam-methyl; CMA; copper sulfate; CPMF; CPPC; credazine; cresol; cumyluron; cyanatryn; cyanazine; cycloate; cyclopyrimorate; cyclosulfamuron; cycloxydim; cycluron; cyhalofop-butyl; cyperquat; cyprazine; cyprazole; cypromid; daimuron; dalapon; dazomet; delachlor; desmedipham; desmetryn; di-allate; dicamba; dichlobenil; dichloralurea; dichlormate; dichlorprop; dichlorprop-P; diclofop-methyl; diclosulam; diethamquat; diethatyl; difenopenten; difenoxuron; difenzoquat; diflufenican; diflufenzopyr; dimefuron; dimepiperate; dimethachlor; dimethametryn; dimethenamid; dimethenamid-P; dimexano; dimidazon; dinitramine; dinofenate; dinoprop; dinosam; dinoseb; dinoterb; diphenamid; dipropetryn; diquat; disul; dithiopyr; diuron; DMPA; DNOC; DSMA; EBEP; eglinazine; endothal; epronaz; EPTC; erbon; esprocarb; ethalfluralin; ethametsulfuron; ethbenzamide; ethametsulfuron; ethidimuron; ethiolate; ethobenzamid; ethofumesate; ethoxyfen; ethoxysulfuron; etinofen; etnipromid; etobenzanid; EXD; fenasulam; fenoprop; fenoxaprop; fenoxaprop-P-ethyl; fenoxaprop-P-ethyl+isoxadifen-ethyl; fenoxasulfone; fenquinotrione; fenteracol; fenthiaprop; fentrazamide; fenuron; ferrous sulfate; flamprop; flamprop-M; flazasulfuron; florasulam; fluazifop; fluazifop-P-butyl; fluazolate; flucarbazone; flucetosulfuron; fluchloralin; flufenacet; flufenican; flufenpyr-ethyl; flumetsulam; flumezin; flumiclorac-pentyl; flumioxazin; flumipropyn; fluometuron; fluorodifen; fluoroglycofen; fluoromidine; fluoronitrofen; fluothiuron; flupoxam; flupropacil; flupropanate; flupyrsulfuron; fluridone; flurochloridone; fluroxypyr; fluroxypyr-meptyl; flurtamone; fluthiacet; fomesafen; foramsulfuron; fosamine; fumiclorac; furyloxyfen; glufosinate; glufosinate-ammonium; glufosinate-P-ammonium; glyphosate salts and esters; halosafen; halosulfuron; haloxydine; haloxyfop; hexachloroacetone; hexaflurate; hexazinone; imazamethabenz; imazamox; imazapic; imazapyr; imazaquin; imazethapyr; imazosulfuron; indanofan; indaziflam; iodobonil; iodomethane; iodosulfuron; iodosulfuron-ethyl-sodium; iofensulfuron; ioxynil; ipazine; ipfencarbazone; iprymidam; isocarbamid; isocil; isomethiozin; isonoruron; isopolinate; isopropalin; isoproturon; isouron; isoxaben; isoxachlortole; isoxaflutole; isoxapyrifop; karbutilate; ketospiradox; lactofen; lenacil; linuron; MAA; MAMA; MCPA esters and amines; MCPA-thioethyl; MCPB; mecoprop; mecoprop-P; medinoterb; mefenacet; mefluidide; mesoprazine; mesosulfuron; mesotrione; metam; metamifop; metamitron; metazachlor; metflurazon; methabenzthiazuron; methalpropalin; methazole; methiobencarb; methiozolin; methiuron; methometon; methoprotryne; methyl bromide; methyl isothiocyanate; methyldymron; metobenzuron; metobromuron; metolachlor; metosulam; metoxuron; metribuzin; metsulfuron; molinate; monalide; monisouron; monochloroacetic acid; monolinuron; monuron; morfamquat; MSMA; naproanilide; napropamide; napropamide-M; naptalam; neburon; nicosulfuron; nipyraclofen; nitralin; nitrofen; nitrofluorfen; norflurazon; noruron; OCH; orbencarb; ortho-dichlorobenzene; orthosulfamuron; oryzalin; oxadiargyl; oxadiazon; oxapyrazon; oxasulfuron; oxaziclomefone; oxyfluorfen; paraflufen-ethyl; parafluron; paraquat; pebulate; pelargonic acid; pendimethalin; penoxsulam; pentachlorophenol; pentanochlor; pentoxazone; perfluidone; pethoxamid; phenisopham; phenmedipham; phenmedipham-ethyl; phenobenzuron; phenylmercury acetate; picloram; picolinafen; pinoxaden; piperophos; potassium arsenite; potassium azide; potassium cyanate; pretilachlor; primisulfuron; procyazine; prodiamine; profluazol; profluralin; profoxydim; proglinazine; prohexadione-calcium; prometon; prometryne; pronamide; propachlor; propanil; propaquizafop; propazine; propham; propisochlor; propoxycarbazone; propyrisulfuron; propyzamide; prosulfalin; prosulfocarb; prosulfuron; proxan; prynachlor; pydanon; pyraclonil; pyraflufen; pyrasulfotole; pyrazogyl; pyrazone; pyrazolynate; pyrazosulfuron; pyrazoxyfen; pyribenzoxim; pyributicarb; pyriclor; pyridafol; pyridate; pyriftalid; pyriminobac; pyrimisulfan; pyrithiobac-sodium; pyroxasulfone; pyroxsulam; quinclorac; quinmerac; quinoclamine; quinonamid; quizalofop; quizalofop-P-ethyl; quizalofop-P-tefuryl; rhodethanil; rimsulfuron; saflufenacil; S-metolachlor; sebuthylazine; secbumeton; sethoxydim; siduron; simazine; simeton; simetryn; SMA; sodium arsenite; sodium azide; sodium chlorate; sulcotrione; sulfallate; sulfentrazone; sulfometuron; sulfosate; sulfosulfuron; sulfuric acid; sulglycapin; swep; TCA; tebutam; tebuthiuron; tefuryltrione; tembotrione; tepraloxydim; terbacil; terbucarb; terbuchlor; terbumeton; terbuthylazine; terbutryne; tetrafluron; thenylchlor; thiameturon; thiazafluron; thiazopyr; thidiazimin; thidiazuron; thiencarbazone; thifensulfuron; thiobencarb; tiafenacil; tiocarbazil; tioclorim; tolpyralate; topramezone; tralkoxydim; tri-allate; triafamone; triasulfuron; triaziflam; tribenuron; tribenuron; tricamba; triclopyr choline salt; triclopyr esters and amines; tridiphane; trietazine; trifloxysulfuron; trifludimoxazin; trifluralin; triflusulfuron; trifop; trifopsime; trihydroxytriazine; trimeturon; tripropindan; tritac; tritosulfuron; vemolate; xylachlor; and salts, esters, optically active isomers, and mixtures thereof.

In some aspects, the additional pesticide or an agriculturally acceptable salt or ester thereof is provided in a premixed formulation with (a), (b), or combinations thereof. In some aspects, the pyridine carboxylate herbicide or an agriculturally acceptable N-oxide, salt, or ester thereof is provided in a premixed formulation with an additional pesticide. In some aspects, the PGR, an agriculturally acceptable salt or ester thereof, or mixtures thereof is provided in a premixed formulation with an additional pesticide.

In some aspects, the compositions may include one or more herbicidal active ingredients in addition to (a). In some aspects, the compositions do not include an herbicidal active ingredient in addition to (a). In some aspects, the compositions may exclude one or more herbicidal active ingredients specified above. In some aspects, the compositions may include one or more herbicidal active ingredients in addition to (a), but may exclude one or more herbicidal ingredients specified above.

2. Adjuvants

In some aspects, the additive includes an agriculturally acceptable adjuvant. Exemplary agriculturally acceptable adjuvants include, but are not limited to, antifreeze agents, antifoam agents, compatibilizing agents, sequestering agents, neutralizing agents and buffers, corrosion inhibitors, colorants, odorants, penetration aids, wetting agents, spreading agents, dispersing agents, thickening agents, freeze point depressants, antimicrobial agents, crop oil, adhesives (for instance, for use in seed formulations), surfactants, protective colloids, emulsifiers, tackifiers, and mixtures thereof.

Exemplary agriculturally acceptable adjuvants include, but are not limited to, crop oil concentrates (e.g., 85% mineral oil+15% emulsifiers); nonylphenol ethoxylates; benzylcocoalkyldimethyl quaternary ammonium salts; blends of petroleum hydrocarbon, alkyl esters, organic acids, and anionic surfactants; C₉-C₁₁ alkylpolyglycoside; phosphate alcohol ethoxylates; natural primary alcohol (C₁₂-C₁₆) ethoxylate; di-sec-butylphenol EO-PO block copolymers; polysiloxane-methyl cap; nonylphenol ethoxylate+urea ammonium nitrates; emulsified methylated seed oils; tridecyl alcohol (synthetic) ethoxylates (e.g., 8 EO); tallow amine ethoxylates (e.g., 15 EO); and PEG(400) dioleate-99.

Exemplary surfactants (e.g., wetting agents, tackifiers, dispersants, emulsifiers) include, but are not limited to: the alkali metal salts, alkaline earth metal salts and ammonium salts of fatty acids or of aromatic sulfonic acids (e.g., lignosulfonic acids, phenolsulfonic acids, naphthalenesulfonic acids, and dibutylnaphthalenesulfonic acid); alkyl- and alkylarylsulfonates; alkyl sulfates, lauryl ether sulfates and fatty alcohol sulfates; salts of sulfated hexa-, hepta- and octadecanols; salts of fatty alcohol glycol ethers; condensates of sulfonated naphthalene and its derivatives with formaldehyde; condensates of naphthalene or of the naphthalene sulfonic acids with phenol and formaldehyde; polyoxyethylene octylphenol ether; ethoxylated isooctyl-, octyl-or nonylphenol, alkylphenyl or tributylphenyl polyglycol ether; alkyl aryl polyether alcohols; isotridecyl alcohol; fatty alcohol/ethylene oxide condensates; ethoxylated castor oil; polyoxyethylene alkyl ethers or polyoxypropylene alkyl ethers; lauryl alcohol polyglycol ether acetate; sorbitol esters; lignosulfite waste liquors and proteins; denatured proteins, polysaccharides (e.g., methylcellulose); hydrophobically modified starches; and polyvinyl alcohol, polycarboxylates, polyalkoxylates, polyvinyl amines, polyethyleneimine, polyvinylpyrrolidone, and copolymers thereof.

Exemplary thickeners include, but are not limited to, polysaccharides (e.g., xanthan gum), organic and inorganic sheet minerals, and mixtures thereof.

Exemplary antifoam agents include, but are not limited to, silicone emulsions, long-chain alcohols, fatty acids, fatty acid salts, organofluorine compounds, and mixtures thereof.

Exemplary antimicrobial agents include, but are not limited to: bactericides based on dichlorophen and benzyl alcohol hemiformal; isothiazolinone derivatives, such as alkylisothiazolinones and benzisothiazolinones; and mixtures thereof.

Exemplary antifreeze agents, include, but are not limited to ethylene glycol, propylene glycol, urea, glycerol, and mixtures thereof.

Exemplary colorants include, but are not limited to, the dyes known under the names Rhodamine B, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108, and mixtures thereof.

Exemplary adhesives include, but are not limited to, polyvinylpyrrolidone, polyvinyl acetate, polyvinyl alcohol, tylose, and mixtures thereof.

3. Safeners

In some aspects, the additive is a safener. Safeners are compounds leading to better crop plant compatibility when applied with a herbicide. In some aspects, the safener itself is herbicidally active. In some aspects, the safener acts as an antidote or antagonist in the crop plants and can protect the crop plants from damage that might otherwise occur from an applied herbicide. Exemplary safeners include, but are not limited to, AD-67 (MON 4660), benoxacor, benthiocarb, brassinolide, cloquintocet, cloquintocet-mexyl, cyometrinil, cyprosulfamide, daimuron, dichlormid, dicyclonon, dietholate, dimepiperate, disulfoton, fenchlorazole, fenchlorazole-ethyl, fenclorim, flurazole, fluxofenim, furilazole, harpin proteins, isoxadifen-ethyl, jiecaowan, jiecaoxi, mefenpyr, mefenpyr-diethyl, mephenate, naphthalic anhydride, 2,2,5-trimethyl-3-(dichloroacetyl)-1,3-oxazolidine, 4-(dichloroacetyl)-1-oxa-4-azaspiro [4.5]decane, oxabetrinil, R29148, and N-phenyl-sulfonylbenzoic acid amides, as well as thereof agriculturally acceptable salts and, provided they have a carboxyl group, their agriculturally acceptable derivatives. In some aspects, the safener can be cloquintocet or an ester or salt thereof, such as cloquintocet-mexyl. In some aspects, the safener can be mefenpyr or an ester or salt thereof, such as mefenpyr-diethyl. In some aspects, the safener is employed in rice, cereal, or maize. For example, mefenpyr or cloquintocet can be used to antagonize harmful effects of the compositions on rice, row crops, and cereals.

4. Carriers

In some aspects, the additive includes a carrier. In some aspects, the additive includes a liquid or solid carrier. In some aspects, the additive includes an organic or inorganic carrier. Exemplary liquid carriers include, but are not limited to: water; petroleum fractions or hydrocarbons such as mineral oil, aromatic solvents, paraffinic oils, and the like; vegetable oils such as soybean oil, rapeseed oil, olive oil, castor oil, sunflower seed oil, coconut oil, corn oil, cottonseed oil, linseed oil, palm oil, peanut oil, safflower oil, sesame oil, tung oil and the like; esters of the above vegetable oils; esters of monoalcohols or dihydric, trihydric, or other lower polyalcohols (4-6 hydroxy containing), such as 2-ethyl hexyl stearate, n-butyl oleate, isopropyl myristate, propylene glycol dioleate, di-octyl succinate, di-butyl adipate, di-octyl phthalate and the like; esters of mono, di and polycarboxylic acids and the like; toluene; xylene; petroleum naphtha; crop oil; acetone; methyl ethyl ketone; cyclohexanone; trichloroethylene; perchloroethylene; ethyl acetate; amyl acetate; butyl acetate; propylene glycol monomethyl ether and diethylene glycol monomethyl ether; methyl alcohol; ethyl alcohol; isopropyl alcohol; amyl alcohol; ethylene glycol; propylene glycol; glycerin; N-methyl-2-pyrrolidinone; N;N-dimethyl alkylamides; dimethyl sulfoxide; and liquid fertilizers, as well as mixtures thereof. Exemplary solid carriers include, but are not limited to: silicas, silica gels, silicates, talc, kaolin, limestone, lime, chalk, bole, loess, clay, dolomite, diatomaceous earth, calcium sulfate, magnesium sulfate, magnesium oxide, ground synthetic materials, pyrophyllite clay, attapulgus clay, kieselguhr, calcium carbonate, bentonite clay, Fuller's earth, cottonseed hulls, wheat flour, soybean flour, pumice, wood flour, walnut shell flour, lignin, ammonium sulfate, ammonium phosphate, ammonium nitrate, ureas, cereal meal, tree bark meal, wood meal and nutshell meal, cellulose powders, and mixtures thereof.

B. Physical States

In some aspects, the formulation of (a) the pyridine carboxylate herbicide or an agriculturally acceptable N-oxide, salt, or ester thereof and (b) the PGR or an agriculturally acceptable salt or ester thereof may be present in suspended, emulsified, dissolved, or solid form. Exemplary formulations include, but are not limited to, aqueous solutions, aqueous suspensions, aqueous dispersions, aqueous emulsions, aqueous microemulsions, aqueous suspo-emulsions, oil solutions, oil suspensions, oil dispersions, oil emulsions, oil microemulsions, oil suspo-emulsions, self-emulsifying formulations, pastes, powders, dusts, granules, and materials for spreading.

In some aspects, (a) and (b) are in an aqueous solution that can be diluted before use. In various aspects, (a) and (b) may be provided as a high-strength formulation such as a concentrate. In some aspects, the concentrate is stable and retains potency during storage and shipping. In various aspects, the concentrate is a clear, homogeneous liquid that is stable at temperatures of 54° C. or greater. In some aspects, the concentrate does not exhibit any precipitation of solids at temperatures of −10° C. or higher. In some aspects, the concentrate does not exhibit separation, precipitation, or crystallization of any components at low temperatures. For example, the concentrate remains a clear solution at temperatures below 0° C. (e.g., below −5° C., below −10° C., below −15° C.). In some aspects, the concentrate exhibits a viscosity of less than 50 centipoise (50 megapascals), even at temperatures as low as 5° C. In some aspects, the concentrate does not exhibit separation, precipitation, or crystallization of any components during storage for a period of 2 weeks or greater (e.g., 4 weeks, 6 weeks, 8 weeks, 3 months, 6 months, 9 months, or 12 months or greater).

In some aspects, emulsions, pastes, or oil dispersions can be prepared by homogenizing (a) and (b) in water with a wetting agent, tackifier, dispersant, or emulsifier. In some aspects, concentrates suitable for dilution with water can be prepared, comprising (a), (b), a wetting agent, a tackifier, and a dispersant or emulsifier.

In some aspects, powders, materials for spreading, or dusts can be prepared by mixing or concomitant grinding of (a) and (b) and optionally other additives with a solid carrier.

In some aspects, granules (e.g., coated granules, impregnated granules and homogeneous granules) can be prepared by binding the (a) and (b) to solid carriers.

In some aspects, the formulations comprise, by total weight of (a) and (b), from 1% to 99% of (a) and 1% to 99% of (b) (e.g., 95% of (a) and 5% of (b); 70% of (a) and 30% of (b); or 40% of (a) and 60% of (b)). In formulations designed to be employed as concentrates, the total amount of (a) and (b) can be present in a concentration of from about 0.1 to about 98 weight percent (wt. %), based on the total weight of the formulation. For example, the total amount of (a) and (b) can be present in a concentration as little as about 1 wt. %, about 2.5 wt. %, about 5 wt. %, about 7.5 wt. %, about 10 wt. %, about 15 wt. %, about 20 wt. %, about 25 wt. %, about 30 wt. %, about 35 wt. %, about 40 wt. %, about 45 wt. %, as high as about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, about 97 wt. %, or within any range defined between any two of the forgoing values, such as between about 1 wt. % to about 97 wt. %, between about 10 wt. % to about 90 wt. %, between about 20 wt. % to about 45 wt. %, and about 25 wt. % to about 50 wt. % based on the total weight of the formulation. Concentrates can be diluted with an inert carrier, such as water, prior to application. The diluted formulations applied to undesirable vegetation or the locus of undesirable vegetation can contain from 0.0006 to 8.0 wt. % of the total amount of (a) and (b) (e.g., from 0.001 to 5.0 wt. %), based on the total weight of the diluted formulation.

C. Packaging

In some aspects, the formulation can be in the form of a single package formulation including both: (a) the pyridine carboxylate herbicide or an agriculturally acceptable N-oxide, salt, or ester thereof, and (b) the PGR, an agriculturally acceptable salt or ester thereof, or mixtures thereof. In some aspects, the formulation can be in the form of a single package formulation including both (a) and (b) and further including at least one additive. In some aspects, the formulation can be in the form of a multi-package formulation, such as a two-package formulation, wherein one package contains (a) and optionally at least one additive while the other package contains (b) and optionally at least one additive. In some aspects of the two-package formulation, the formulation including (a) and optionally at least one additive and the formulation including (b) and optionally at least one additive are mixed before application and then applied simultaneously. In some aspects, the mixing is performed as a tank mix (e.g., the formulations are mixed immediately before or upon dilution with water). In some aspects, the formulation including (a) and the formulation including (b) are not mixed but are applied sequentially (in succession), for example, immediately or within 1 hour, within 2 hours, within 4 hours, within 8 hours, within 16 hours, within 24 hours, within 2 days, or within 3 days, of each other.

### VI. Methods of Use

The compositions disclosed herein can be applied in any known technique for applying herbicides. Exemplary application techniques include, but are not limited to, spraying, atomizing, dusting, spreading, or direct application into water. The method of application can vary depending on the intended purpose. In some aspects, the method of application can be chosen to ensure the finest possible distribution of the compositions disclosed herein.

In some aspects, a method of controlling undesirable vegetation which comprises contacting the vegetation or the locus thereof with or applying to the soil or water to prevent the emergence or growth of vegetation any of the compositions is disclosed herein.

The compositions disclosed herein can be applied pre-emergence (before the emergence of undesirable vegetation) or post-emergence (e.g., during or after emergence of the undesirable vegetation). In some aspects, the composition is applied post-emergence to the undesirable vegetation. In some aspects, the pyridine carboxylate herbicide and the PGR are applied simultaneously. In some aspects, the pyridine carboxylate herbicide and the PGR are applied sequentially, for example, immediately or with minimal delay, within about 10 minutes, within about 20 minutes, within about 30 minutes, within about 40 minutes, within about 1 hour, within about 2 hours, within about 4 hours, within about 8 hours, within about 16 hours, within about 24 hours, within about 2 days, or within about 3 days, of each other.

When the compositions are used in crops, the compositions can be applied after seeding and before or after the emergence of the crop plants. In some aspects, the compositions disclosed herein show good crop tolerance even when the crop has already emerged and can be applied during or after the emergence of the crop plants. In some aspects, when the compositions are used in crops, the compositions can be applied before seeding of the crop plants.

In some aspects, the compositions disclosed herein are applied to vegetation or an area adjacent the vegetation or applying to soil or water to prevent the emergence or growth of vegetation by spraying (e.g., foliar spraying). In some aspects, the spraying techniques use, for example, water as carrier and spray volume rates of from 2 liters per hectare (L/ha) to 2000 L/ha (e.g., from 10-1000 L/ha or from 50-500 L/ha). In some aspects, the compositions disclosed herein are applied by the low-volume or the ultra-low-volume method, wherein the application is in the form of micro granules. In some aspects, wherein the compositions disclosed herein are less well tolerated by certain crop plants, the compositions can be applied with the aid of the spray apparatus in such a way that they come into little contact, if any, with the leaves of the sensitive crop plants while reaching the leaves of undesirable vegetation that grows underneath or on the bare soil (e.g., post-directed or lay-by). In some aspects, the compositions disclosed herein can be applied as dry formulations (e.g., granules, powders, or dusts).

In some aspects, wherein the undesirable vegetation is treated post-emergence, the compositions disclosed herein are applied by foliar application. In some aspects, herbicidal activity is exhibited by the compounds of the mixture when they are applied directly to the plant or to the locus of the plant at any stage of growth or before planting or emergence. The effect observed can depend upon the type of undesirable vegetation to be controlled, the stage of growth of the undesirable vegetation, the application parameters of dilution and spray drop size, the particle size of solid components, the environmental conditions at the time of use, the specific compound employed, the specific adjuvants and carriers employed, the soil type, and the like, as well as the amount of chemical applied. In some aspects, these and other factors can be adjusted to promote non-selective or selective herbicidal action.

The compositions and methods disclosed herein can be used to control undesirable vegetation in a variety of applications. The compositions and methods disclosed herein can be used for controlling undesirable vegetation in areas including, but not limited to, farmland, turfgrass, pastures, grasslands, rangelands, fallow land, rights-of-way, aquatic settings, tree and vine, wildlife management areas, or rangeland. In some aspects, the undesirable vegetation is controlled in a row crop. Exemplary crops include, but are not limited to, wheat, barley, triticale, rye, teff, oats, maize, cotton, soy, sorghum, rice, millet, sugarcane and range land (e.g., pasture grasses). In some aspects, the compositions and methods disclosed herein can be used for controlling undesirable vegetation in maize, wheat, barley, rice, sorghum, millet, oats, or a combination thereof. In some aspects, the compositions and methods disclosed herein can be used for controlling undesirable vegetation in broadleaf crops. In some aspects, the compositions and methods disclosed herein can be used for controlling undesirable vegetation in canola, flax, sunflower, soy, or cotton. In some aspects, the compositions and methods disclosed herein can be used in industrial vegetation management (IVM) or for utility, pipeline, roadside, and railroad rights-of-way applications. In some aspects, the compositions and methods disclosed herein can also be used in forestry (e.g., for site preparation or for combating undesirable vegetation in plantation forests). In some aspects, the compositions and methods disclosed herein can be used to control undesirable vegetation in conservation reserve program lands (CRP), trees, vines, grasslands, and grasses grown for seeds. In some aspects, the compositions and methods disclosed herein can be used on lawns (e.g., residential, industrial, and institutional), golf courses, parks, cemeteries, athletic fields, and sod farms.

The compositions and methods disclosed herein can also be used in crop plants that are resistant to, for instance, herbicides, pathogens, or insects. In some aspects, the compositions and methods disclosed herein can be used in crop plants that are resistant to one or more herbicides because of genetic engineering or breeding. In some aspects, the compositions and methods disclosed herein can be used in crop plants that are resistant to one or more pathogens such as plant pathogenic fungi owing to genetic engineering or breeding. In some aspects, the compositions and methods disclosed herein can be used in crop plants that are resistant to attack by insects owing to genetic engineering or breeding. Exemplary resistant crops include, but are not limited to, crops that are resistant to photosystem II inhibitors, or crop plants that, owing to introduction of the gene for Bacillus thuringiensis (or Bt) toxin by genetic modification, are resistant to attack by certain insects. In some aspects, the compositions and methods described herein can be used in conjunction with dicamba, phenoxy auxins, pyridyloxy auxins, aryloxyphenoxypropionates, acetyl CoA carboxylase (ACCase) inhibitors, imidazolinones, acetolactate synthase (ALS) inhibitors, 4-hydroxyphenyl-pyruvate dioxygenase (HPPD) inhibitors, protoporphyrinogen oxidase (PPO) inhibitors, triazines, and bromoxynil to control vegetation in crops tolerant to glyphosate, glufosinate, dicamba, phenoxy auxins, pyridyloxy auxins, aryloxyphenoxypropionates, ACCase inhibitors, imidazolinones, synthetic auxin herbicide, HPPD inhibitors, PPO inhibitors, triazines, bromoxynil, or combinations thereof. In some aspects, the undesirable vegetation is controlled in glyphosate, glufosinate, dicamba, phenoxy auxins, pyridyloxy auxins, aryloxyphenoxypropionates, ACCase inhibitors, synthetic auxin herbicide, HPPD inhibitors, PPO inhibitors, triazines, and bromoxynil tolerant crops possessing single, multiple or stacked traits conferring tolerance to single or multiple chemistries or multiple modes of action. In some aspects, the undesirable vegetation can be controlled in a crop that is ACCase-tolerant, ALS-tolerant, or a combination thereof. The combination of (a) and (b) can be used in combination with one or more herbicides that are selective for the crop being treated and which complement the spectrum of weeds controlled by these compounds at the application rate employed. In some aspects, the compositions described herein and other complementary herbicides are applied at the same time, either as a combination formulation or as a tank mix, or as sequential applications. The compositions and methods may be used in controlling undesirable vegetation in crops possessing agronomic stress tolerance (including but not limited to drought, cold, heat, salt, water, nutrient, fertility, pH), pest tolerance (including but not limited to insects, fungi and pathogens), and crop improvement traits (including but not limited to yield; protein, carbohydrate, or oil content; protein, carbohydrate, or oil composition; plant stature and plant architecture).

In some aspects, the compositions disclosed herein can be used for controlling undesirable vegetation including grasses, broadleaf weeds, sedge weeds, and combinations thereof. In some aspects, the compositions disclosed herein can be used for controlling undesirable vegetation including, but not limited to, Polygonum species, Amaranthus species, Chenopodium species, Sida species, Ambrosia species, Cyperus species, Setaria species, Sorghum species, Acanthospermum species, Anthemis species, Atriplex species, Brassica species, Cirsium species, Convolvulus species, Conyza species, Cassia species, Commelina species, Datura species, Euphorbia species, Geranium species, Galinsoga species, Ipomea species, Lamium species, Lolium species, Malva species, Matricaria species, Prosopis species, Rumex species, Sisymbrium species, Solanum species, Trifolium species, Xanthium species, Veronica species, and Viola species. In some aspects, the undesired vegetation includes common chickweed (Stellaria media), velvetleaf (Abutilon theophrasti), hemp sesbania (Sesbania exaltata Cory), Anoda cristata, Bidens pilosa, Brassica kaber, shepherd's purse (Capsella bursa-pastoris), cornflower (Centaurea cyanus or Cyanus segetum), hempnettle (Galeopsis tetrahit), cleavers (Galium aparine), common sunflower (Helianthus annuus), Desmodium tortuosum, Italian ryegrass (Lolium multiflorum), kochia (Kochia scoparia), Medicago arabica, Mercurialis annua, Myosotis arvensis, common poppy (Papaver rhoeas), Raphanus raphanistrum, broad-leaf dock (Rumex obtusifolius), Russian thistle (Salsola kali), wild mustard (Sinapis arvensis), Sonchus arvensis, Thlaspi arvense, Tagetes minuta, Richardia brasiliensis, Plantago major, Plantago lanceolata, bird's-eye speedwell (Veronica persica), pigweed (Amaranthus retroflexus), winter rape (Brassica napus), lambsquarters (Chenopodium album), Canada thistle (Cirsium arvense), nutsedge (Cyperus esculentus), poinsettia (Euphorbia heterophylla), prickly lettuce (Lactuca serriola), purple deadnettle (Lamium purpureum), wild chamomile (Matricaria chamomilla), false chamomile (Matricaria inodora), field chamomile (Anthemis arvensis), common buckwheat (Fagopyrum esculentum), wild buckwheat (Polygonum convulvus), giant foxtail (Setaria faberi), green foxtail (Setaria viridis), common sorghum (Sorghum vulgare), wild pansy (Viola tricolor), or a combination thereof.

The compositions described herein can be used to control herbicide resistant or tolerant weeds. The methods employing the compositions described herein may also be employed to control herbicide resistant or tolerant weeds. Exemplary resistant or tolerant weeds include, but are not limited to, biotypes resistant or tolerant to acetolactate synthase (ALS) or acetohydroxy acid synthase (AHAS) inhibitors (e.g., imidazolinones, sulfonylureas, pyrimidinylthiobenzoates, triazolopyrimidines, sulfonylaminocarbonyltriazolinones), photosystem II inhibitors (e.g., phenylcarbamates, pyridazinones, triazines, triazinones, uracils, amides, ureas, benzothiadiazinones, nitriles, phenylpyridazines), acetyl CoA carboxylase (ACCase) inhibitors (e.g., aryloxyphenoxypropionates, cyclohexanediones, phenylpyrazolines), synthetic auxins (e.g., benzoic acids, phenoxycarboxylic acids, pyridine carboxylates, quinoline carboxylic acids), auxin transport inhibitors (e.g., phthalamates, semicarbazones), photosystem I inhibitors (e.g., bipyridyliums), 5-enolpyruvylshikimate-3-phosphate (EPSP) synthase inhibitors (e.g., glyphosate), glutamine synthetase inhibitors (e.g., glufosinate, bilanafos), microtubule assembly inhibitors (e.g., benzamides, benzoic acids, dinitroanilines, phosphoramidates, pyridines), mitosis inhibitors (e.g., carbamates), very long chain fatty acid (VLCFA) inhibitors (e.g., acetamides, chloroacetamides, oxyacetamides, tetrazolinones), fatty acid and lipid synthesis inhibitors (e.g., phosphorodithioates, thiocarbamates, benzofuranes, chlorocarbonic acids), protoporphyrinogen oxidase (PPO) inhibitors (e.g., diphenylethers, N-phenylphthalimides, oxadiazoles, oxazolidinediones, phenylpyrazoles, pyrimidindiones, thiadiazoles, triazolinones), carotenoid biosynthesis inhibitors (e.g., clomazone, amitrole, aclonifen), phytoene desaturase (PDS) inhibitors (e.g., amides, anilidex, furanones, phenoxybutan-amides, pyridiazinones, pyridines), 4-hydroxyphenyl-pyruvate-dioxygenase (HPPD) inhibitors (e.g., callistemones, isoxazoles, pyrazoles, triketones), cellulose biosynthesis inhibitors (e.g., nitriles, benzamides, quinclorac, triazolocarboxamides), herbicides with multiple modes of action such as quinclorac, and unclassified herbicides such as arylaminopropionic acids, difenzoquat, endothall, and organoarsenicals. Exemplary resistant or tolerant weeds include, but are not limited to, biotypes with resistance or tolerance to multiple herbicides, biotypes with resistance or tolerance to multiple chemical classes, biotypes with resistance or tolerance to multiple herbicide modes of action, and biotypes with multiple resistance or tolerance mechanisms (e.g., target site resistance or metabolic resistance).

By way of non-limiting illustration, examples of some aspects of the present disclosure are given below. Parts and percentages are on a per weight basis unless otherwise indicated.

### EXAMPLES

Greenhouse Trial Methodology—Evaluation of Postemergence Herbicidal Effect

Seeds of the desired test plant species were planted in a 90:10% v/v (volume/volume) mixture of PRO-MIX® BX (Premier Tech Horticulture, Quakertown, Pa., USA) and PROFILE® GREENS GRADE™ (Profile Products LLC, Buffalo Grove, Ill., USA) planting mixture, which typically has a pH of 5.2 to 6.2 and an organic matter content of at least 50 percent, in plastic pots with a surface area of 103.2 square centimeters (cm²). In some aspects, to help ensure good germination and healthy plants, a fungicide treatment and/or other chemical or physical treatment was applied. The plants were grown for 7-36 days (d) in a greenhouse with an approximate 14-hour (h) photoperiod which was maintained at about 23° C. during the day and 22° C. during the night. Nutrients and water were added on a regular basis and supplemental lighting was provided with overhead metal halide 1000-Watt lamps as necessary. The plants were employed for testing when they reached the second or third true leaf stage.

Emulsifiable concentrates of each of each pyridine carboxylate herbicide (Compound A or Compound B) were prepared at 100 grams acid equivalent per liter (g ae/L). The emulsifiable concentrates also included a safener, cloquintocet-mexyl, at 120 grams active ingredient per liter (g ai/L). An aliquot of each emulsifiable concentrate was placed in a 25 mL glass vial and diluted with an aqueous mixture of 1.25% (v/v) ACTIROB® B esterified rapeseed oil (Bayer Crop Science, Research Triangle Park, N.C., USA) or MSO® Concentrate with LECI-TECH® methylated soybean oil (Loveland Products, Loveland, Colo., USA) to obtain concentrated stock solutions at the highest application rate for each herbicide, based upon a 12 milliliter (mL) application volume at a rate of 187 liters per hectare (L/ha). The concentrated stock solutions were further diluted with an aqueous mixture of 1.25% v/v ACTIROB® B or MSO® Concentrate with LECI-TECH® to obtain stock solutions at reduced application rates for each herbicide. Spray solutions of the herbicide combinations (Compound A or Compound B plus the PGR) were prepared by adding weighed amounts or aliquots of the PGR to the stock solutions of Compound A or Compound B to form 12-mL spray solutions in two-way combinations.

The spray solutions were applied to the plant material with an overhead Mandel track sprayer equipped with 8002E nozzles calibrated to deliver 187 L/ha over an application area of 0.503 square meters (m²) at a spray height of 18 inches (43 centimeters (cm)) above the average plant canopy. Control plants were sprayed in the same manner with the solvent blank. All pyridine carboxylate herbicide (component a) application rates are given as “g ae/ha” and all PGR (component b) application rates are given as “g ai/ha.”

The treated plants and control plants were placed in a greenhouse as described above and watered by sub-irrigation to prevent wash-off of the test compounds. After 20-22 d, the condition of the test plants as compared with that of the control plants was determined visually and scored on a scale of 0 to 100 percent where 0 corresponds to no injury and 100 corresponds to complete kill.

The details of the compositions and the crops tested are specified in the following Examples.

### Example 1

Compositions comprising Compound A and chlormequat were tested to determine the efficacy of the compositions on undesirable vegetation species, including wild pansy (VIOTR, Viola tricolor), velvetleaf (ABUTH, Abutilon theophrasti), wild buckwheat (POLCO, Polygonum convolvulus), poinsettia (EPHHL, Euphorbia heterophylla), Canada thistle (CIRAR, Cirsium arvense), volunteer soybean (GLXMA, Glycine max), ivyleaf momingglory (IPOHE, Ipomoea hederacea), pigweed (AMARE, Amaranthus retroflexus), common sunflower (HELAN, Helianthus annuus), and kochia (KCHSC, Kochia scoparia), to determine the efficacy of the compositions on these undesirable vegetation species. The compositions were also tested on spring wheat (TRZAS), and the phytotoxicity of the compositions on the crop was measured.

The results are summarized in Table 1 below.

TABLE 1
Herbicidal Effects (% visual injury) of Compound
A and Chlormequat on weed and grain crops.

| | | Application rate (g/ha) | | | | |
|---|---|---|---|---|---|---|
| | | Compound A | | | | |
| | | 7.5 | 10 | 0 | 7.5 | 10 |
| | | Chlormequat | | | | |
| | | 0 | 0 | 560 | 560 | 560 |
| VIOTR | Obs | 3 | 3 | 0 | 3 | 3 |
| | Exp | — | — | — | 3 | 3 |
| | Δ | | | | 0 | 0 |
| ABUTH | Obs | 40 | 48 | 0 | 38 | 68 |
| | Exp | — | — | — | 40 | 48 |
| | Δ | | | | −3 | 20 |
| POLCO | Obs | 68 | 70 | 0 | 38 | 38 |
| | Exp | — | — | — | 68 | 70 |
| | Δ | | | | −30 | −33 |
| EPHHL | Obs | 91 | 83 | 0 | 90 | 87 |
| | Exp | — | — | — | 91 | 83 |
| | Δ | | | | −1 | 4 |
| CIRAR | Obs | 25 | 20 | 0 | 40 | 45 |
| | Exp | — | — | — | 25 | 20 |
| | Δ | | | | 15 | 25 |
| GLXMA | Obs | 100 | 99 | 10 | 100 | 99 |
| | Exp | — | — | — | 100 | 99 |
| | Δ | | | | 0 | −1 |
| IPOHE | Obs | 5 | 0 | 0 | 5 | 5 |
| | Exp | — | — | — | 5 | 0 |
| | Δ | | | | 0 | 5 |
| AMARE | Obs | 80 | 85 | 0 | 93 | 88 |
| | Exp | — | — | — | 80 | 85 |
| | Δ | | | | 13 | 3 |
| HELAN | Obs | 83 | 88 | 0 | 97 | 83 |
| | Exp | — | — | — | 83 | 88 |
| | Δ | | | | 14 | −5 |
| KCHSC | Obs | 63 | 65 | 0 | 65 | 68 |
| | Exp | — | — | — | 63 | 65 |
| | Δ | | | | 3 | 3 |
| TRZAS | Obs | 0 | 0 | 0 | 0 | 0 |
| | Exp | — | — | — | 0 | 0 |
| | Δ | | | | 0 | 0 |

g/ha = grams per hectare
VIOTR = Viola tricolor (wild pansy)
ABUTH = Abutilon theophrasti (velvetleaf)
POLCO = Polygonum convolvulus (wild buckwheat)
EPHHL = Euphorbia heterophylla (poinsettia)
CIRAR = Cirsium arvense (Canada thistle)
GLXMA = Glycine max (soybean)
IPOHE = Ipomoea hederacea (ivyleaf morningglory)
AMARE = Amaranthus retroflexus (pigweed)
HELAN = Helianthus annuus (common sunflower)
KCHSC = Kochia scoparia (kochia)
TRZAS = Triticum aestivum (spring wheat)

### Example 2

Compositions comprising Compound A and IAA (indol-3-ylacetic acid) were tested to determine the efficacy of the compositions on undesirable vegetation species, including wild pansy (VIOTR, Viola tricolor), chickweed (STEME, Stellaria media), velvetleaf (ABUTH, Abutilon theophrasti), wild buckwheat (POLCO, Polygonum convolvulus), Canada thistle (CIRAR, Cirsium arvense), spring rape (BRSNN, Brassica napus), giant foxtail (SETFA, Setaria faberi), volunteer soybean (GLXMA, Glycine max), ivyleaf morningglory (IPOHE, Ipomoea hederacea), common sunflower (HELAN, Helianthus annuus), pigweed (AMARE, Amaranthus retroflexus), and kochia (KCHSC, Kochia scoparia), to determine the efficacy of the compositions on these undesirable vegetation species. The compositions were also tested on maize (ZEAMX), spring wheat (TRZAS), and sorghum (SORVU), and the phytotoxicity of the compositions on each crop was measured.

The results are summarized in Table 2 below.

TABLE 2
Herbicidal Effects (% visual injury) of Compound
A and IAA on weed and grain crops.

| | | Application rate (g/ha) | | | | |
|---|---|---|---|---|---|---|
| | | Compound A | | | | |
| | | 7.5 | 10 | 0 | 7.5 | 10 |
| | | IAA | | | | |
| | | 0 | 0 | 140 | 140 | 140 |
| VIOTR | Obs | 38 | 15 | 0 | 20 | 10 |
| | Exp | — | — | — | 38 | 15 |
| | Δ | | | | −18 | −5 |
| STEME | Obs | 89 | 90 | 5 | 93 | 93 |
| | Exp | — | — | — | 90 | 91 |
| | Δ | | | | 3 | 2 |
| ABUTH | Obs | 68 | 80 | 0 | 75 | 65 |
| | Exp | — | — | — | 68 | 80 |
| | Δ | | | | 8 | −15 |
| POLCO | Obs | 83 | 93 | 0 | 93 | 88 |
| | Exp | — | — | — | 83 | 93 |
| | Δ | | | | 10 | −5 |
| CIRAR | Obs | 40 | 60 | 0 | 55 | 63 |
| | Exp | — | — | — | 40 | 60 |
| | Δ | | | | 15 | 3 |
| BRSNN | Obs | 65 | 65 | 0 | 65 | 65 |
| | Exp | — | — | — | 65 | 65 |
| | Δ | | | | 0 | 0 |
| SETFA | Obs | 78 | 80 | 0 | 75 | 80 |
| | Exp | — | — | — | 78 | 80 |
| | Δ | | | | −3 | 0 |
| GLXMA | Obs | 80 | 90 | 0 | 95 | 92 |
| | Exp | — | — | — | 80 | 90 |
| | Δ | | | | 15 | 2 |
| IPOHE | Obs | 20 | 25 | 0 | 40 | 43 |
| | Exp | — | — | — | 20 | 25 |
| | Δ | | | | 20 | 18 |
| HELAN | Obs | 90 | 89 | 0 | 97 | 92 |
| | Exp | — | — | — | 90 | 89 |
| | Δ | | | | 7 | 3 |
| AMARE | Obs | 88 | 88 | 0 | 95 | 90 |
| | Exp | — | — | — | 88 | 88 |
| | Δ | | | | 8 | 3 |
| KCHSC | Obs | 75 | 73 | 0 | 70 | 73 |
| | Exp | — | — | — | 75 | 73 |
| | Δ | | | | −5 | 0 |
| ZEAMX | Obs | 0 | 0 | 0 | 0 | 0 |
| | Exp | — | — | — | 0 | 0 |
| | Δ | | | | 0 | 0 |
| TRZAS | Obs | 5 | 3 | 0 | 0 | 5 |
| | Exp | — | — | — | 5 | 3 |
| | Δ | | | | −5 | 3 |
| SORVU | Obs | 0 | 0 | 0 | 8 | 0 |
| | Exp | — | — | — | 0 | 0 |
| | Δ | | | | 8 | 0 |

g/ha = grams per hectare
VIOTR = Viola tricolor (wild pansy)
STEME = Stellaria media (chickweed)
ABUTH = Abutilon theophrasti (velvetleaf)
POLCO = Polygonum convolvulus (wild buckwheat)
CIRAR = Cirsium arvense (Canada thistle)
BRSNN = Brassica napus (spring rape)
SETFA = Setaria faberi (giant foxtail)
GLXMA = Glycine max (soybean)
IPOHE = Ipomoea hederacea (ivyleaf morningglory)
HELAN = Helianthus annuus (common sunflower)
AMARE = Amaranthus retroflexus (pigweed)
KCHSC = Kochia scoparia (kochia)
ZEAMX = Zea mays (maize)
TRZAS = Triticum aestivum (spring wheat)
SORVU = Sorghum vulgare (grain sorghum)

### Example 3

Compositions comprising Compound A and IBA (indol-3-butyric acid) were tested to determine the efficacy of the compositions on undesirable vegetation species, including wild pansy (VIOTR, Viola tricolor), chickweed (STEME, Stellaria media), velvetleaf (ABUTH, Abutilon theophrasti), wild buckwheat (POLCO, Polygonum convolvulus), Canada thistle (CIRAR, Cirsium arvense), spring rape (BRSNN, Brassica napus), giant foxtail (SETFA, Setaria faberi), volunteer soybean (GLXMA, Glycine max), ivyleaf morningglory (IPOHE, Ipomoea hederacea), common sunflower (HELAN, Helianthus annuus), pigweed (AMARE, Amaranthus retroflexus), and kochia (KCHSC, Kochia scoparia), to determine the efficacy of the compositions on these undesirable vegetation species. The compositions were also tested on maize (ZEAMX) spring wheat (TRZAS), and sorghum (SORVU), and the phytotoxicity of the compositions on each crop was measured.

The results are summarized in Table 3 below.

TABLE 3
Herbicidal Effects (% visual injury) of Compound
A and IBA on weed and grain crops.

| | | Application rate (g/ha) | | | | |
|---|---|---|---|---|---|---|
| | | Compound A | | | | |
| | | 7.5 | 10 | 0 | 7.5 | 10 |
| | | IBA | | | | |
| | | 0 | 0 | 140 | 140 | 140 |
| VIOTR | Obs | 38 | 15 | 3 | 28 | 35 |
| | Exp | — | — | — | 39 | 17 |
| | Δ | | | | −12 | 18 |
| STEME | Obs | 89 | 90 | 8 | 93 | 91 |
| | Exp | — | — | — | 90 | 91 |
| | Δ | | | | 3 | 3 |
| ABUTH | Obs | 68 | 80 | 0 | 75 | 75 |
| | Exp | — | — | — | 68 | 80 |
| | Δ | | | | 8 | −5 |
| POLCO | Obs | 83 | 93 | 0 | 93 | 93 |
| | Exp | — | — | — | 83 | 93 |
| | Δ | | | | 10 | 0 |
| CIRAR | Obs | 40 | 60 | 0 | 70 | 68 |
| | Exp | — | — | — | 40 | 60 |
| | Δ | | | | 30 | 8 |
| BRSNN | Obs | 65 | 65 | 0 | 73 | 70 |
| | Exp | — | — | — | 65 | 65 |
| | Δ | | | | 8 | 5 |
| SETFA | Obs | 78 | 80 | 5 | 83 | 83 |
| | Exp | — | — | — | 79 | 81 |
| | Δ | | | | 4 | 2 |
| GLXMA | Obs | 80 | 90 | 0 | 99 | 100 |
| | Exp | — | — | — | 80 | 90 |
| | Δ | | | | 19 | 10 |
| IPOHE | Obs | 20 | 25 | 0 | 30 | 40 |
| | Exp | — | — | — | 20 | 25 |
| | Δ | | | | 10 | 15 |
| HELAN | Obs | 90 | 89 | 0 | 93 | 95 |
| | Exp | — | — | — | 90 | 89 |
| | Δ | | | | 3 | 6 |
| AMARE | Obs | 88 | 88 | 0 | 88 | 93 |
| | Exp | — | — | — | 88 | 88 |
| | Δ | | | | 0 | 5 |
| KCHSC | Obs | 75 | 73 | 0 | 78 | 75 |
| | Exp | — | — | — | 75 | 73 |
| | Δ | | | | 3 | 3 |
| ZEAMX | Obs | 0 | 0 | 0 | 5 | 0 |
| | Exp | — | — | — | 0 | 0 |
| | Δ | | | | 5 | 0 |
| TRZAS | Obs | 5 | 3 | 5 | 3 | 3 |
| | Exp | — | — | — | 10 | 7 |
| | Δ | | | | −7 | −5 |
| SORVU | Obs | 0 | 0 | 0 | 5 | 5 |
| | Exp | — | — | — | 0 | 0 |
| | Δ | | | | 5 | 5 |

g/ha = grams per hectare
VIOTR = Viola tricolor (wild pansy)
STEME = Stellaria media (chickweed)
ABUTH = Abutilon theophrasti (velvetleaf)
POLCO = Polygonum convolvulus (wild buckwheat)
CIRAR = Cirsium arvense (Canada thistle)
BRSNN = Brassica napus (spring rape)
SETFA = Setaria faberi (giant foxtail)
GLXMA = Glycine max (soybean)
IPOHE = Ipomoea hederacea (ivyleaf morningglory)
HELAN = Helianthus annuus (common sunflower)
AMARE = Amaranthus retroflexus (pigweed)
KCHSC = Kochia scoparia (kochia)
ZEAMX = Zea mays (maize)
TRZAS = Triticum aestivum (spring wheat)
SORVU = Sorghum vulgare (grain sorghum)

### Example 4

Compositions comprising Compound B and chlormequat were tested to determine the efficacy of the compositions on undesirable vegetation species, including poinsettia (EPHHL, Euphorbia heterophylla), velvetleaf (ABUTH, Abutilon theophrasti), wild buckwheat (POLCO, Polygonum convolvulus), Canada thistle (CIRAR, Cirsium arvense), spring rape (BRSNN, Brassica napus), giant foxtail (SETFA, Setaria faberi), common sunflower (HELAN, Helianthus annuus), kochia (KCHSC, Kochia scoparia), wild pansy (VIOTR, Viola tricolor), common lambsquarters (CHEAL, Chenopodium album L.), and chickweed (STEME, Stellaria media), to determine the efficacy of the compositions on these undesirable vegetation species.

The results are summarized in Table 4 below.

TABLE 4
Herbicidal Effects (% visual injury) of
Compound B and Chlormequat on weeds.

| | | Application rate (g/ha) | | | | |
|---|---|---|---|---|---|---|
| | | Compound B | | | | |
| | | 7.5 | 10 | 0 | 7.5 | 10 |
| | | Chlormequat | | | | |
| | | 0 | 0 | 560 | 560 | 560 |
| EPHHL | Obs | 83 | 99 | 25 | 99 | 98 |
| | Exp | — | — | — | 87 | 99 |
| | Δ | | | | 12 | −1 |
| ABUTH | Obs | 68 | 68 | 50 | 90 | 80 |
| | Exp | — | — | — | 84 | 84 |
| | Δ | | | | 6 | −4 |
| POLCO | Obs | 73 | 80 | 5 | 97 | 75 |
| | Exp | — | — | — | 74 | 81 |
| | Δ | | | | 23 | −6 |
| CIRAR | Obs | 45 | 45 | 0 | 65 | 75 |
| | Exp | — | — | — | 45 | 45 |
| | Δ | | | | 20 | 30 |
| BRSNN | Obs | 68 | 85 | 0 | 73 | 90 |
| | Exp | — | — | — | 68 | 85 |
| | Δ | | | | 5 | 5 |
| SETFA | Obs | 70 | 55 | 0 | 73 | 88 |
| | Exp | — | — | — | 70 | 55 |
| | Δ | | | | 3 | 33 |
| HELAN | Obs | 85 | 100 | 0 | 100 | 100 |
| | Exp | — | — | — | 85 | 100 |
| | Δ | | | | 15 | 0 |
| KCHSC | Obs | 68 | 80 | 0 | 93 | 97 |
| | Exp | — | — | — | 68 | 80 |
| | Δ | | | | 25 | 17 |
| VIOTR | Obs | 10 | 40 | 3 | 28 | 30 |
| | Exp | — | — | — | 12 | 42 |
| | Δ | | | | 15 | −12 |
| CHEAL | Obs | 85 | 90 | 0 | 99 | 90 |
| | Exp | — | — | — | 85 | 90 |
| | Δ | | | | 14 | 0 |
| STEME | Obs | 10 | 93 | 0 | 93 | 100 |
| | Exp | — | — | — | 100 | 93 |
| | Δ | | | | −8 | 8 |

g/ha = grams per hectare
EPHHL = Euphorbia heterophylla (poinsettia)
ABUTH = Abutilon theophrasti (velvetleaf)
POLCO = Polygonum convolvulus (wild buckwheat)
CIRAR = Cirsium arvense (Canada thistle)
BRSNN = Brassica napus (spring rape)
SETFA = Setaria faberi (giant foxtail)
HELAN = Helianthus annuus (common sunflower)
KCHSC = Kochia scoparia (kochia)
VIOTR = Viola tricolor (wild pansy)
CHEAL = Chenopodium album L. (common lambsquarters)
STEME = Stellaria media (chickweed)

### Example 5

Herbicidal compositions comprising Compound A and flurenol were tested on undesirable vegetation species, including kochia (KCHSC, Kochia scoparia), Canada thistle (CIRAR, Cirsium arvense), Russian thistle (SASKR, Salsola kali), purple deadnettle (LAMPU, Lamium purpureum), shepherd's purse (CAPBP, Capsella bursa-pastoris), wild pansy (VIOTR, Viola tricolor), cornflower (CENCY, Cyanus segetum), field violet (VIOAR, Viola arvensis), common chickweed (STEME, Stellaria media), scentless chamomile (MATIN, Matricaria inodora), corn chamomile (ANTAR, Anthemis arvensis), pineapple weed (MATMT, Matricaria discoidea), wild chamomile (MATCH, Matricaria chamomilla), Persian speedwell (VERPE, Veronica persica), common poppy (PAPRH, Papaver rhoeas), ivy-leaved speedwell (VERHE, Veronica hederifolia), herbicide-resistant poppy (PAPRH-RES, Papaver rhoeas), wild mustard (SINAR, Sinapis arvensis), winter rape (BRSNW, Brassica napus), and wild buckwheat (POLCO, Polygonurn convolvulus), to determine the efficacy of the herbicidal compositions on these undesirable vegetation species. The herbicidal compositions were also tested on spring wheat (TRZAS), winter wheat (TRZAW), winter barley (HORVW) and spring barley (HORVS), and the phytotoxicity of the herbicidal compositions on each crop was measured.

The results are summarized in Table 5 below.

TABLE 5
Herbicidal Effects (% visual injury) of Compound
A and Flurenol on weeds and grain crops.

| | | Application Rate (g/ha) | | | | | | |
|---|---|---|---|---|---|---|---|---|
| | | Compound A | | | | | | |
| | | 7.5 | 10 | 15 | 0 | 7.5 | 10 | 15 |
| | | Flurenol | | | | | | |
| | | 0 | 0 | 0 | 280 | 280 | 280 | 280 |
| KCHSC | Obs | 63 | 65 | 63 | 3 | 68 | 68 | 68 |
| | Exp | — | — | — | — | 63 | 66 | 63 |
| | Δ | | | | | 4 | 2 | 4 |
| CIRAR | Obs | 50 | 63 | 63 | 0 | 63 | 65 | 73 |
| | Exp | — | — | — | — | 50 | 63 | 63 |
| | Δ | | | | | 13 | 3 | 10 |
| SASKR | Obs | 50 | 60 | 63 | 0 | 68 | 70 | 68 |
| | Exp | — | — | — | — | 50 | 60 | 63 |
| | Δ | | | | | 18 | 10 | 5 |
| LAMPU | Obs | 68 | 73 | 73 | 15 | 73 | 73 | 75 |
| | Exp | — | — | — | — | 72 | 77 | 77 |
| | Δ | | | | | 0 | −4 | −2 |
| CAPBP | Obs | 45 | 55 | 55 | 0 | 65 | 70 | 78 |
| | Exp | — | — | — | — | 45 | 55 | 55 |
| | Δ | | | | | 20 | 15 | 23 |
| VIOTR | Obs | 13 | 15 | 15 | 0 | 13 | 10 | 0 |
| | Exp | — | — | — | — | 13 | 15 | 15 |
| | Δ | | | | | 0 | −5 | −15 |
| CENCY | Obs | 75 | 78 | 80 | 18 | 80 | 78 | 85 |
| | Exp | — | — | — | — | 79 | 81 | 84 |
| | Δ | | | | | 1 | −4 | 2 |
| VIOAR | Obs | 10 | 13 | 10 | 8 | 13 | 8 | 5 |
| | Exp | — | — | — | — | 17 | 19 | 17 |
| | Δ | | | | | −4 | −12 | −12 |
| STEME | Obs | 85 | 88 | 89 | 5 | 89 | 93 | 96 |
| | Exp | — | — | — | — | 86 | 88 | 90 |
| | Δ | | | | | 3 | 5 | 6 |
| MATIN | Obs | 55 | 60 | 83 | 0 | 73 | 75 | 93 |
| | Exp | — | — | — | — | 55 | 60 | 83 |
| | Δ | | | | | 18 | 15 | 10 |
| ANTAR | Obs | 68 | 70 | 88 | 10 | 75 | 84 | 83 |
| | Exp | — | — | — | — | 71 | 73 | 89 |
| | Δ | | | | | 4 | 11 | −6 |
| MATMT | Obs | 20 | 20 | 63 | 0 | 30 | 50 | 72 |
| | Exp | — | — | — | — | 20 | 20 | 63 |
| | Δ | | | | | 10 | 30 | 9 |
| MATCH | Obs | 23 | 35 | 45 | 15 | 43 | 40 | 60 |
| | Exp | — | — | — | — | 34 | 45 | 53 |
| | Δ | | | | | 8 | −5 | 7 |
| VERPE | Obs | 78 | 90 | 93 | 5 | 96 | 91 | 98 |
| | Exp | — | — | — | — | 79 | 91 | 93 |
| | Δ | | | | | 17 | 1 | 5 |
| PAPRH | Obs | 100 | 99 | 100 | 25 | 99 | 100 | 100 |
| | Exp | — | — | — | — | 100 | 99 | 100 |
| | Δ | | | | | −2 | 1 | 0 |
| VERHE | Obs | 68 | 73 | 75 | 5 | 75 | 87 | 83 |
| | Exp | — | — | — | — | 69 | 74 | 76 |
| | Δ | | | | | 6 | 13 | 6 |
| PAPRH- | Obs | 96 | 98 | 100 | 20 | 100 | 100 | 100 |
| RES | Exp | — | — | — | — | 97 | 98 | 100 |
| | Δ | | | | | 3 | 2 | 0 |
| SINAR | Obs | 88 | 91 | 91 | 10 | 95 | 96 | 97 |
| | Exp | — | — | — | — | 89 | 92 | 92 |
| | Δ | | | | | 6 | 4 | 5 |
| BRSNW | Obs | 60 | 65 | 73 | 30 | 85 | 88 | 96 |
| | Exp | — | — | — | — | 72 | 76 | 81 |
| | Δ | | | | | 13 | 12 | 15 |
| POLCO | Obs | 65 | 78 | 85 | 20 | 88 | 90 | 95 |
| | Exp | — | — | — | — | 72 | 82 | 88 |
| | Δ | | | | | 16 | 8 | 7 |
| TRZAS | Obs | 0 | 0 | 0 | 0 | 0 | 0 | 0 |
| | Exp | — | — | — | — | 0 | 0 | 0 |
| | Δ | | | | | 0 | 0 | 0 |
| TRZAW | Obs | 0 | 0 | 0 | 0 | 0 | 0 | 0 |
| | Exp | — | — | — | — | 0 | 0 | 0 |
| | Δ | | | | | 0 | 0 | 0 |
| HORVW | Obs | 0 | 0 | 0 | 0 | 0 | 0 | 0 |
| | Exp | — | — | — | — | 0 | 0 | 0 |
| | Δ | | | | | 0 | 0 | 0 |
| HORVS | Obs | 0 | 0 | 0 | 0 | 0 | 0 | 0 |
| | Exp | — | — | — | — | 0 | 0 | 0 |
| | Δ | | | | | 0 | 0 | 0 |

g/ha = grams per hectare
KCHSC = Kochia scoparia (kochia)
CIRAR = Cirsium arvense (Canada thistle)
SASKR = Salsola kali (Russian thistle)
LAMPU = Lamium purpureum (purple deadnettle)
CAPBP = Capsella bursa-pastoris (shepherd's purse)
VIOTR = Viola tricolor (wild pansy)
CENCY = Cyanus segetum (cornflower)
VIOAR = Viola arvensis (field violet)
STEME = Stellaria media (chickweed)
MATIN = Matricaria inodora (scentless chamomile)
ANTAR = Anthemis arvensis (corn chamomile)
MATMT = Matricaria discoidea (pineapple weed)
MATCH = Matricaria chamomilla (wild chamomile)
VERPE = Veronica persica (Persian speedwell)
PAPRH = Papaver rhoeas (common poppy)
VERHE = Veronica hederifolia (ivy-leaved speedwell)
PAPRH-RES = Papaver rhoeas (herbicide-resistant poppy)
SINAR = Sinapis arvensis (wild mustard)
BRSNW = Brassica napus (winter rape)
POLCO = Polygonum convolvulus (wild buckwheat)
TRZAS = Triticum aestivum (spring wheat)
TRZAW = Triticum aestivum (winter wheat)
HORVW = Hordeum vulgare (winter barley)
HORVS = Hordeum vulgare (spring barley)

### Example 6

Herbicidal compositions comprising Compound A and ethephon were tested on undesirable vegetation species, including sorghum (SORVU, Sorghum vulgare), yellow nutsedge (CYPES, Cyperus esculentus), large crabgrass (DIGSA, Digitaria sanguinalis), barnyard grass (ECHCG, Echinochloa crus-galli), sunflower (HELAN, Helianthus annuus), redroot pigweed (AMARE, Amaranthus retroflexus), kochia (KCHSC, Kochia scoparia), giant foxtail (SETFA, Setaria faberi), spring rape (BRSNN, Brassica napus), common lambsquarters (CHEAL, Chenopodium album), wild pansy (VIOTR, Viola tricolor), common chickweed (STEME, Stellaria media), Canada thistle (CIRAR, Cirsium arvense), broadleaf dock (RUMOB, Rumex obtusifolia), velvetleaf (ABUTH, Abutilon theophrasti), wild buckwheat (POLCO, Polygonum convolvulus), and wild poinsettia (EPHHL, Euphorbia heterophylla), to determine the efficacy of the herbicidal compositions on these undesirable vegetation species. The herbicidal compositions were also tested on maize/corn (ZEAMX) and rice (ORYSA), and the phytotoxicity of the herbicidal compositions on each crop was measured.

The results are summarized in Table 6 below.

TABLE 6
Herbicidal Effects (% visual injury) of Compound
A and Ethephon on weeds and grain crops.

Application Rate (g/ha)
Compound A

| | | | | |
|---|---|---|---|---|
| 7.5 | 10 | 0 | 7.5 | 10 |

Ethephon

| | | 0 | 0 | 140 | 140 | 140 |
|---|---|---|---|---|---|---|
| SORVU | Obs | 8 | 8 | 0 | 28 | 10 |
| | Exp | — | — | — | 8 | 8 |
| | Δ | | | | 20 | 3 |
| CYPES | Obs | 58 | 38 | 0 | 78 | 80 |
| | Exp | — | — | — | 58 | 38 |
| | Δ | | | | 20 | 43 |
| DIGSA | Obs | 10 | 10 | 0 | 15 | 18 |
| | Exp | — | — | — | 10 | 10 |
| | Δ | | | | 5 | 8 |
| ECHCG | Obs | 90 | 94 | 0 | 98 | 96 |
| | Exp | — | — | — | 90 | 94 |
| | Δ | | | | 8 | 3 |
| HELAN | Obs | 100 | 93 | 0 | 100 | 100 |
| | Exp | — | — | — | 100 | 93 |
| | Δ | | | | 0 | 8 |
| AMARE | Obs | 99 | 100 | 0 | 100 | 100 |
| | Exp | — | — | — | 99 | 100 |
| | Δ | | | | 2 | 0 |
| KCHSC | Obs | 70 | 65 | 0 | 78 | 82 |
| | Exp | — | — | — | 70 | 65 |
| | Δ | | | | 8 | 17 |
| SETFA | Obs | 55 | 70 | 0 | 70 | 75 |
| | Exp | — | — | — | 55 | 70 |
| | A | | | | 15 | 5 |
| BRSNN | Obs | 45 | 55 | 0 | 63 | 83 |
| | Exp | — | — | — | 45 | 55 |
| | Δ | | | | 18 | 28 |
| CHEAL | Obs | 100 | 100 | 0 | 100 | 100 |
| | Exp | — | — | — | 100 | 100 |
| | Δ | | | | 0 | 0 |
| VIOTR | Obs | 13 | 20 | 0 | 15 | 23 |
| | Exp | — | — | — | 13 | 20 |
| | Δ | | | | 3 | 3 |
| STEME | Obs | 100 | 100 | 0 | 100 | 100 |
| | Exp | — | — | — | 100 | 100 |
| | Δ | | | | 0 | 0 |
| CIRAR | Obs | 50 | 60 | 0 | 58 | 65 |
| | Exp | — | — | — | 50 | 60 |
| | Δ | | | | 8 | 5 |
| RUMOB | Obs | 8 | 18 | 0 | 15 | 25 |
| | Exp | — | — | — | 8 | 18 |
| | Δ | | | | 8 | 8 |
| ABUTH | Obs | 73 | 85 | 0 | 100 | 85 |
| | Exp | — | — | — | 73 | 85 |
| | Δ | | | | 28 | 0 |
| POLCO | Obs | 100 | 100 | 0 | 100 | 100 |
| | Exp | — | — | — | 100 | 100 |
| | Δ | | | | 0 | 0 |
| EPHHL | Obs | 100 | 100 | 0 | 100 | 100 |
| | Exp | — | — | — | 100 | 100 |
| | Δ | | | | 0 | 0 |
| ZEAMX | Obs | 0 | 5 | 0 | 3 | 13 |
| | Exp | — | — | — | 0 | 5 |
| | Δ | | | | 3 | 8 |
| ORYSA | Obs | 15 | 18 | 0 | 28 | 35 |
| | Exp | — | — | — | 15 | 18 |
| | Δ | | | | 13 | 18 |

g/ha = grams per hectare
SORVU = Sorghum vulgare (sorghum)
CYPES = Cyperus esculentus (yellow nutsedge)
DIGSA = Digitaria sanguinalis (large crabgrass)
ECHCG = Echinochloa crus-galli (common barnyardgrass)
HELAN = Helianthus anmnis (common sunflower)
AMARE = Amaranthus retroflexus (redroot pigweed)
KCHSC = Kochia scoparia (kochia)
SETFA = Setaria faberi (giant foxtail)
BRSNN = Brassica napus (spring rape)
CHEAL = Chenopodium album L. (common lambsquarters)
VIOTR = Viola tricolor (wild pansy)
STEME = Stellaria media (chickweed)
CIRAR = Cirsium arvense (Canada thistle)
RUMOB = Rumex obtusifolia (broadleaf dock)
ABUTH = Abutilon theophrasti (velvetleaf)
POLCO = Polygonum convolvulus (wild buckwheat)
EPHHL = Euphorbia heterophylla (poinsettia)
ZEAMX = Zea mays (maize/corn)
ORYSA = Oryza sativa (rice)

The compositions and methods of the appended claims are not limited in scope by the specific compositions and methods described herein, which are intended as illustrations of a few aspects of the claims and any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various aspects, the terms “consisting essentially of” and “consisting of” can be used in place of “comprising” and “including” to provide for more specific aspects and are also disclosed. Other than in the examples, or where otherwise noted, all numbers expressing quantities of ingredients, reaction conditions, and so forth used in the specification and claims are to be understood to be construed in light of the number of significant digits and ordinary rounding approaches, and not as an attempt to limit the application of the doctrine of equivalents to the scope of the claims.

1. A composition, comprising:
(a) a pyridine carboxylate herbicide defined by Formula (I): 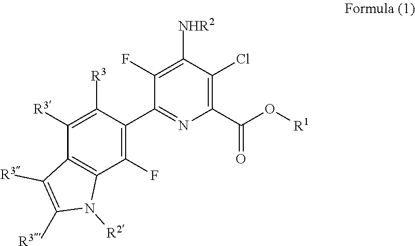
wherein:
R¹ is cyanomethyl or propargyl;
R² and R^{2′} are independently hydrogen, C₁-C₆ alkyl, formyl, alkoxycarbonyl, or acyl;
R³, R^{3′}, R^{3′}, and R^{3′″} are independently hydrogen, halogen, C₁-C₄ alkyl, C₁-C₄ haloalkyl, C₁-C₃ alkoxy, or C₁-C₃ haloalkoxy;
or an agriculturally acceptable N-oxide, salt, or ester thereof; and
(b) a plant growth regulator (PGR), an agriculturally acceptable salt or ester thereof, or mixtures thereof.

2. The composition of claim 1, wherein the pyridine carboxylate herbicide compound is cyanomethyl 4-amino-3-chloro-5-fluoro-6-(7-fluoro-1H-indol-6-yl)pyridine-2-carboxylate:

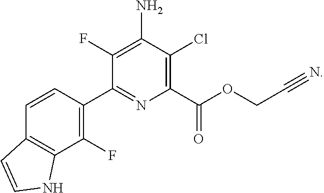 [SMILES: N#CCOC(=O)c1nc(-c2ccc3cc[nH]c3c2F)c(F)c(N)c1Cl]

3. The composition of claim 1, wherein the pyridine carboxylate herbicide compound is propargyl 4-amino-3-chloro-5-fluoro-6-(7-fluoro-1H-indol-6-yl)pyridine-2-carboxylate:

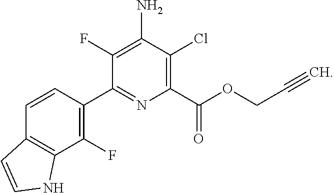 [SMILES: C#CCOC(=O)c1nc(-c2ccc3cc[nH]c3c2F)c(F)c(N)c1Cl]

4. The composition of claim 1, wherein the PGR is selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and mixtures thereof.

5. The composition of claim 1, wherein the weight ratio of (a) (in g ae/ha) to (b) (in g ai/ha) is from 1:7500 to 15:1.

6. The composition of claim 1, further comprising a safener.

7. The composition of claim 1, further comprising an additional pesticide.

8. The composition of claim 1, wherein the composition does not include a herbicidal active ingredient in addition to (a) and (b).

9. A method of controlling undesirable vegetation, comprising applying to vegetation or an area adjacent the vegetation or applying to soil or water to limit the emergence or growth of vegetation a composition, comprising:
(a) a pyridine carboxylate herbicide defined by Formula (I): 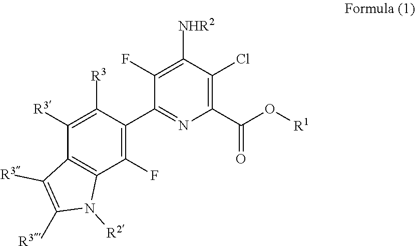
wherein
R¹ is cyanomethyl or propargyl;
R² and R^{2′} are independently hydrogen, C₁-C₆ alkyl, formyl, alkoxycarbonyl, or acyl;
R³, R^{3′}, R^{3′}, and R^{3′″} are independently hydrogen, halogen, C₁-C₄ alkyl, C₁-C₄ haloalkyl, C₁-C₃ alkoxy, or C₁-C₃ haloalkoxy;
or an agriculturally acceptable N-oxide, salt, or ester thereof; and
(b) a plant growth regulator (PGR), an agriculturally acceptable salt or ester thereof, or mixtures thereof;
wherein the pyridine carboxylate herbicide is applied in an amount of at least 0.1 g ae/ha; and
wherein the PGR is applied in an amount of at least 100 g ai/ha.

10. The method of claim 9, wherein the pyridine carboxylate herbicide compound is cyanomethyl 4-amino-3-chloro-5-fluoro-6-(7-fluoro-1H-indol-6-yl)pyridine-2-carboxylate:

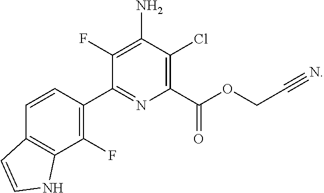 [SMILES: N#CCOC(=O)c1nc(-c2ccc3cc[nH]c3c2F)c(F)c(N)c1Cl]

11. The method of claim 9, wherein the pyridine carboxylate herbicide compound is propargyl 4-amino-3-chloro-5-fluoro-6-(7-fluoro-TH-indol-6-yl)pyridine-2-carboxylate:

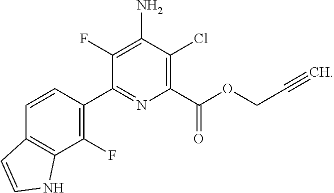 [SMILES: C#CCOC(=O)c1nc(-c2ccc3cc[nH]c3c2F)c(F)c(N)c1Cl]

12. The method of claim 9, wherein the pyridine carboxylate herbicide and the PGR are applied simultaneously.

13. The method of claim 9, wherein the pyridine carboxylate herbicide is provided in amount of 0.1 g ae/ha to 300 g ae/ha.

14. The method of claim 9, wherein the PGR is selected from the group consisting of 1,4-dimethylnapththalene, 1-methylcyclopropene, 1-napthylacetic acid, 2,6-diisopropylnaphthalene, 2-naphthyloxyacetic acid, 4-chlorophenoxyacetic acid (4-CPA), 6-benzylaminopurine, abscisic acid, amidochlor, ancymidol, aviglycine, butralin, carbaryl, chlorflurenol, chlormequat, chlorphonium chloride, chlorpropham, clofencet, cloprop, cloxyfonac, cuprous chloride, cyanamide, cyclanilide, cycloheximide, cytokinins, daminozide, decan-1-ol, dikegulac, dimethipin, dimexano, endothal, etacelasil, ethephon, ethychlozate, fenoprop, fenridazon, flumetralin, flurenol, flurprimidol, forchlorfenuron, gibberellins, glyphosine, heptamaloxyloglucan, heptopargil, hexafluoroacetone trihydrate, inabenfide, indol-3-butyric acid (IBA), indol-3-ylacetic acid (IAA), isoprothiolane, maleic hydrazide, mefluidide, mepiquat, N-acetylthiazolidine-4-carboxylic acid, naphthaleneacetamide, N-m-tolylphthalamic acid, N-phenylphthalamic acid, nitrophenolates, paclobutrazol, pelargonic acid, piproctanyl bromide, prohexadione, prohydrojasmon, propham, propyl-3-tert-butylphenoxyacetate, sintofen, tetcyclacis, thidiazuron, triacontanol, triapenthenol, trinexapac, uniconazole, agriculturally acceptable salts or esters thereof, and mixtures thereof.

15. The method of claim 9, wherein the weight ratio of (a) (in g ae/ha) to (b) (in g ai/ha) is from 1:7500 to 15:1.

16. The method of claim 9, further comprising applying a safener.

17. The method of claim 9, further comprising applying an additional pesticide.

18. The method of claim 9, wherein the composition does not include a herbicidal active ingredient in addition to (a) and (b).
